(19) United States
(12) Patent Application Publication
(10) Pub. No.: US 2023/0267166 A1
(43) Pub. Date: Aug. 24, 2023

(54) Parallel Simulation of Large-Scale Dynamical Systems Using Tensor Network

(71) Applicant: EFSolutions GbR, Barntrup (DE)

(72) Inventors: Stefano Elefante, Vienna (AT); Raffaele Iervolino, Telese Terme (IT)

(21) Appl. No.: 18/099,400

(22) Filed: Jan. 20, 2023

Related U.S. Application Data
(60) Provisional application No. 63/301,406, filed on Jan. 20, 2022.

(51) Int. Cl. G06F 17/13

(52) U.S. Cl. CPC G06F 17/13

(57) ABSTRACT

A system includes a memory storing computer-readable instructions and at least one processor to execute the instructions to perform at least one tensor network method to numerically solve at least one differential equation.

### CROSS-REFERENCE TO RELATED APPLICATION

This application is related to and claims priority to U.S. Pat. Application No. 63/301,406, filed Jan. 20, 2022, entitled “Parallel Simulation of Large-Scale Dynamical Systems Using Tensor Network,” the entire contents of which are incorporated herein by reference.

### BACKGROUND

Over the last decade, tensor networks have become used in quantum mechanics and other fields such as quantum chemistry and machine learning. Although tensor networks have been used to solve differential equations, they have not been used to investigate dynamic systems and problems associated with dynamic systems.

It is with these issues in mind, among others, that various aspects of the disclosure were conceived.

### SUMMARY

The present disclosure is directed to parallel simulation of large-scale dynamical systems using a tensor network.

In one example, a system may include a memory storing computer-readable instructions and at least one processor to perform at least one tensor network method to numerically solve at least one differential equation, build a mathematical representation of one of a physical, economic, and engineering problem using the at least one differential equation, determine a graph that defines connections between states of the problem and determine an adjacency matrix, subdivide a matrix into n sets of matrices whose elements commute with each other while at least one element of a set does not commute with at least one element of another set, implement a Suzuki Trotter decomposition using singular value decomposition to reduce data transfer among cores of the at least one processor on the n sets of matrices with a given time interval δ and a predefined p expansion order, evaluate the problem at a time T=Nδ by iteratively performing the Suzuki Trotter decomposition N times, and generate simulation results for the problem within an error of order of No(δ^{p+1}) .

In another example, a method may include performing, by at least one processor, at least one tensor network method to numerically solve at least one differential equation, building, by the at least one processor, a mathematical representation of one of a physical, economic, and engineering problem using the at least one differential equation, determining, by the at least one processor, a graph that defines connections between states of the problem and determining an adjacency matrix, subdividing, by the at least one processor, a matrix into n sets of matrices whose elements commute with each other while at least one element of a set does not commute with at least one element of another set, implementing, by the at least one processor, a Suzuki Trotter decomposition using singular value decomposition to reduce data transfer among cores of the at least one processor on the n sets of matrices with a given time interval δ and a predefined p expansion order, evaluating, by the at least one processor, the problem at a time T=Nδ by iteratively performing the Suzuki Trotter decomposition N times, and generating, by the at least one processor, simulation results for the problem within an error of order of No(δ^{p+1}).

According to an additional aspect, a non-transitory computer-readable storage medium includes instructions stored thereon that, when executed by a computing device cause the computing device to perform operations, the operations including performing at least one tensor network method to numerically solve at least one differential equation, building a mathematical representation of one of a physical, economic, and engineering problem using the at least one differential equation, determining a graph that defines connections between states of the problem and determining an adjacency matrix, subdividing a matrix into n sets of matrices whose elements commute with each other while at least one element of a set does not commute with at least one element of another set, implementing a Suzuki Trotter decomposition using singular value decomposition to reduce data transfer among cores of the at least one processor on the n sets of matrices with a given time interval δ and a predefined p expansion order, evaluating the problem at a time T=Nδ by iteratively performing the Suzuki Trotter decomposition N times, and generating simulation results for the problem within an error of order of No(δ^{p+1}).

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram of a method performed by a system according to an example of the instant disclosure.

FIG. 2 is a one dimensional lattice with one neighboring site interaction according to an example of the instant disclosure.

FIG. 3 is a one dimensional lattice with two neighboring sites interaction according to an example of the instant disclosure.

FIG. 4 shows a two-dimensional lattice with one neighboring site interaction and partitioned using square elements according to an example of the instant disclosure.

FIG. 5 shows a two-dimensional lattice with one neighboring site interaction and partitioned using triangle elements according to an example of the instant disclosure.

FIG. 6 shows a two-dimensional lattice with one neighboring site interaction and partitioned using another pattern of triangle elements according to an example of the instant disclosure.

FIG. 7 shows a three-dimensional lattice with one neighboring site interaction and partitioned using cubic elements according to an example of the instant disclosure.

FIG. 8 shows a parallel implementation for a band matrix and three different computational layers for a second order Suzuki Trotter decomposition according to an example of the instant disclosure.

FIGS. 9A and 9B show another parallel implementation for a band matrix and seven different computational layers for a fourth order Suzuki Trotter decomposition according to an example of the instant disclosure.

FIG. 10 shows a parallel implementation for any matrix A for the second order Suzuki Trotter decomposition according to an example of the instant disclosure.

FIG. 11 shows an example of connections of a full matrix characterizing four sites according to an example of the instant disclosure.

FIG. 12 shows an example of connections of a full matrix characterizing four sites according to an example of the instant disclosure.

FIG. 13 shows a mass spring damper system according to an example of the instant disclosure.

FIG. 14 shows communication between threads when the matrix A is a band matrix according to an example of the instant disclosure.

FIG. 15 shows free evolution response showing all the state variables according to an example of the instant disclosure.

FIG. 16 shows a number of singular values during the simulation greater than the threshold σ= 0.01 according to an example of the instant disclosure.

FIG. 17 shows simulation error versus elapsed time in seconds with δ =0.1 and p=4 according to an example of the instant disclosure.

FIG. 18 shows simulation error versus elapsed time in seconds with δ =0.01 and p=4 according to an example of the instant disclosure.

FIG. 19 shows a mass spring damper system with a first and a last mass connected according to an example of the instant disclosure.

FIG. 20 shows communication between threads when matrix A is not a band matrix and a Suzuki Trotter decomposition 2nd order approximant with ten masses and five threads considered according to an example of the instant disclosure.

FIG. 21 shows parallel implementation of the Suzuki Trotter decomposition second order approximant when the first and last mass are connected according to an example of the instant disclosure.

FIG. 22 shows a two-dimensional lattice model with masses and no dumping according to an example of the instant disclosure.

FIG. 23 shows a two-dimensional lattice with twelve masses connected through square elements according to an example of the instant disclosure.

FIG. 24 shows a two-dimensional lattice with twelve masses connected through triangular elements according to an example of the instant disclosure.

FIG. 25 shows a three-dimensional lattice model with twenty-seven masses connected through cube elements according to an example of the instant disclosure.

FIG. 26 shows step force according to an example of the instant disclosure.

FIG. 27 shows free evolution plus step response of the first state variable including all simulations according to an example of the instant disclosure.

FIG. 28 shows step response of the first state variable including all the simulations according to an example of the instant disclosure.

FIG. 29 shows free evolution plus sine response of the first state variable including all the simulations for ω=1 according to an example of the instant disclosure.

FIG. 30 shows a sine response of the first state variable including all the simulations for ω=1 according to an example of the instant disclosure.

FIG. 31 shows parallel implementation using three different computational layers for a second order Suzuki Trotter decomposition according to an example of the instant disclosure.

FIG. 32 shows a cantilever beam according to an example of the instant disclosure.

FIG. 33 shows a heat conductor according to an example of the instant disclosure.

FIG. 34 shows a block diagram for non-linear systems according to an example of the instant disclosure.

FIG. 35 shows a parallel implementation of a discrete time-invariant system for a band matrix A according to an example of the instant disclosure.

FIG. 36 shows a parallel implementation of a discrete time-invariant system for any matrix A according to an example of the instant disclosure.

FIG. 37 shows an example process of building a mathematical representation of one of a physical, economic, and engineering problem using at least one differential equation according to an example of the instant disclosure.

FIG. 38 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It is highly desirable to be able to simulate and analyze complex real-world systems. For example, civil engineers model the stresses that may be experienced by a structure under various conditions, in order to confirm that a structure as designed is unlikely to fail. Possible failure in a simulation allows for re-design and re-simulation to quickly improve the design to avoid eventual real-world failures. Similarly, an existing real-world structure can be simulated and analyzed so that the structure may be repaired and/or reinforced if necessary to reduce the chances of failure. Many real-world systems are too complex to be simulated with perfect accuracy. For example, a real-world structure is composed of an essentially infinite number of discrete portions, each of which may be subject to a different stress under a given force. The stresses between one point and another are related, but in a complex way that cannot easily be reduced to an equation for simulation purposes. Therefore, in practice it is necessary to build a simplified model in order to simulate a complex real-world system.

In some such models, a system is modeled as a network of a finite number of connected, distributed nodes. For example, a structure may be modeled as a mesh of connected nodes in the general shape of the structure. Since all points in the system are interconnected, an assumption can be made that values at points between nodes can be interpolated from values at the nearest nodes. Typically the greater the number of nodes used, the more accurate such an assumption is. Equations may then be developed that model characteristics at each node and their relation to each other. For example for a structure, a system of equations may be developed that estimate the stress at each node depending on initial conditions at the nodes and some input, such as a force acting on one or more nodes, and that incorporate the interconnectedness of the nodes. Commonly, these equations are linear differential equations. The development of such models and equations is well known in the art for a wide variety of engineering (civil, mechanical, aerospace, chemical, telecommunications, electrical, etc.) and other applications, as is discussed in more detail below.

Systems and methods of the present disclosure may execute a highly scalable parallel algorithm based on tensor network methods to numerically solve large systems of ordinary linear differential equations as well as the iterative resolution of one or more linear difference equations. Linear differential equations may represent mathematical models related to industrial applications and may include a number of variables. The system may utilize distributed computing devices to utilize parallel algorithms to simulate a number of dimensional systems that can be recast in a state space representation. This allows simulations to be run in the same amount of time and with the same accuracy with less computing power, or equivalently the simulations may be run faster and/or more accurately (e.g., with more nodes) with the same computing power.

The distributed parallel scheme of the present disclosure can be easily deployed on an HPC cluster, grid, as well as on cloud environments and can be summarized as follows. First, the matrix A representing the system space representation is partitioned in n smaller matrices. Each n matrix of this matrix A is assigned to a job and executed by one or more threads permitting the possibility of a fine-grained parallelism for large n. The aim of this preliminary step is to compute the matrix exponentials of the smaller matrices that are therefore calculated una tantum only at the beginning of the processing. Second, starting from a set of initial conditions X₀, any instant time T = Nδ can be reached by iteratively applying N times a p order Suzuki Trotter expansion of time step δ. To gain a more efficient parallel execution, singular value decomposition to the output matrix products can be applied during the Suzuki Trotter decomposition execution to reduce the data transfer among cores (this feature can be very useful especially for cloud platforms in which network bandwidth is a major bottleneck). Last, simulation results within an error of order No(δ^{p+1}) for many initial conditions trials are obtained.

In one example, the system may provide a numerical solution by using a tensor network related to any system model dynamics that can be recast as a linear time invariant state space representation. The system may link quantum mechanics concepts of a tensor network to systems engineering and distributed computing by providing numerical integration of linear differential equations and iterative resolution of linear difference equations. As an example, the system can be used to provide analysis based on the lumped masses method or the finite element method where there may be a plurality of masses and nodes/elements. As a result, the system can provide information associated with scenarios in scientific and engineering design by providing advanced simulations.

Although finite element (FEM) software packages such as MSC Nastran, COMSOL, and ABACUS provide numerical methods to solve large dynamic scale systems, they are not effective. In particular, these techniques utilize algorithm scalability that provides a number of drawbacks related to system simulation. The systems and methods discussed herein provide linearly scalable solutions using the lumped masses method (LMM) and are highly scalable using the finite element method (LMM).

The systems and methods described herein concern the numerical solution by using tensor network of any system model dynamics that can be recast as a linear time invariant state space representation. It links the quantum mechanics concepts of a tensor network to the branch of systems engineering and distributed computing, with reference to the numerical integration of linear differential equations, as well as the iterative resolution of linear difference equation. The methodology allows a parallel algorithm implementation to simulate high dimensional continuous and discrete time systems and has the capability to exploit not only computational resources, but also distributed infrastructures such as cluster, grid, and cloud environments.

Possible fields of applications are, in particular, the real-world system analysis based on Lumped Masses Method (LMM) or Finite Element Method (FEM), with a very large number of masses and nodes/elements respectively, without recurring to unnecessary and overly conservative simplifications.

The system holds the key feature to be almost linearly scalable for LMM and high scalable for FEM. The systems and methods provide advantages associated with opening new technological scenarios in scientific and engineering design through big system simulation.

In systems engineering, discrete and continuous time systems can be modelled through a state space representation. However, in many industrial applications, a sufficiently large number of state variables is required to gain a realistic description of the underlying phenomena. Therefore, the curse of high dimensionality can easily occur, and can limit de facto a truthful computer simulation of the overall system. The development of techniques to numerically solve large systems that can exploit powerful processing capabilities is discussed herein. The novel paradigm of parallel computing offers an effective methodology to face big system simulations. Nevertheless, to do so, it is desirable to use large multi nodes computing infrastructures but also parallel algorithms which can efficiently distribute the calculation within the processing environment.

Nowadays, there are on the market various commercial software that offer solutions to address big systems simulation on a parallel manner. However, they have the major drawback of algorithms scalability which inevitably strongly hampers the simulation of large-scale systems. To overcome the mentioned limitation, current algorithms available in literature employ the strategy to reduce system size by using model approximation methods, such as super elements usage, eigenvectors and eigenvalues reductions, as well as machine and deep learning algorithms.

The system instead offers a methodology that solves the above-mentioned scalability flaw by proposing an algorithm that is highly scalable across the processing units, thus removing the necessity to reduce the system dimensionality. In particular, the technique is very suitable to solve both LMM and FEM analysis problems characterised by many masses or nodes, respectively. Indeed, the system provides a parallel solution that is highly scalable, it can be applied in a distributed computational environment (e.g., cluster, grid, cloud) to solve systems with an enormous quantity of masses or nodes since the only limitation is represented by the number of computational units.

The methodology has, therefore, a great impact on technology because many systems’ models can be reconducted in a state space representation. A non-exhaustive list of possible fields of application include, for instance, engineering, economics, statistics, computer science, neuroscience, etc.

The novelty of the proposed system relies on exploiting methods based on a tensor network approach, also known in literature as tensor-train network or decomposition. This is a fast-evolving scientific topic that is providing solutions to problems of a large range of disciplines. Techniques based on this innovative field have become increasingly popular within the research community due to the possibility to provide efficient distributed computational approaches. Tensor network methods can be described as algorithms to break very large tensors into a mathematical equivalent network of smaller tensors. Such a flexible modelling that corresponds to an algebraic matrix decomposition offers efficient techniques to solve in a distributed manner a complex mathematical calculation.

As proof of that, during the last decade, tensor network methods have gradually become the standard in quantum mechanics to evaluate the time evolution of large and correlated quantum systems. They opened new scenarios in computational physics to simulate on a parallel manner quantum many-body systems dynamical behavior including also complex systems such as for instance spin glasses.

Researchers extended their applicability also to other fields such as quantum chemistry. There are, indeed, works that exploit tensor decomposition algorithms to train machine learning based methods to identify candidate drug-like molecules. In addition, other research studies show that tensor-train networks are also effective tools for big data processing and for developing forecasting and predictive financial models.

However, although tensor network theory has been demonstrated to be a powerful approach to numerically solve differential equations, such as the quantum mechanical Schrödinger equation, the mentioned methodology has not been yet embarked to investigate dynamical systems problems. In this regard, the disclosure proposes to extend the usage of tensor network for dynamic simulations of any high dimensional systems with a given and sufficiently general model structure.

All the current techniques to solve large state space models have their own limitations and drawbacks. Indeed, the existing commercial simulation software shows scalability weakness. A study on COMSOL version 4.2 reveals a parallel average efficiency around Eₚ = 0.8 and discussion concerning COMSOL scalability is still a topic of high interest as evidently debated in its forum. The scalability downside is mainly because proprietary software usually implements solutions based on iterative methods.

MSC Software proposes two different approaches for the distributed solution i) direct transient response, which is based on a numerical approximation of differential equations through Newton-Raphson method and its related techniques; ii) modal transient response method, which uses either eigenvalue extraction through a highly tuned Lanczos solver or the automated component mode synthesis which is an approximation to the full Lanczos eigensolution.

However, those two approaches have their own disadvantages. Direct transient response method uses a very small value for the time step to guarantee a sufficient accuracy and avoid numerical instability. Algorithms derived by the iterative Lanczos solution hold the severe drawbacks that they do not linearly scale and that they iteratively utilize the calculation of the system matrix eigenvalues. As consequence, computation is a complex and burdensome task when large scale systems are considered. As reported in NX Nastran, the number of calculations for real eigenvalues analysis (it is known that a calculations number is even higher for complex eigenvalues) is of order o(nb²E) where n is the number of equations, b is the semi-bandwidth or similar decomposition parameter and E the number of extracted eigenvalues.

Taking into consideration the computation complexity, an effective and fast time dependent response processing can be attained evaluating an approximated solution by considering only the dominant eigenvalues and their corresponding eigenvectors. Unfortunately, high order systems modes are removed and phenomena that could be of interest for an accurate systems analysis are thus neglected. This is a significant limitation in industrial applications since system size reduction excludes high frequency system dynamics, strongly hampering the possibility of a more reliable and robust technological design.

Machine learning and deep learning methods can also solve large systems but at the price of also discarding possible significant information. Indeed, these techniques rely on methods that can be recast as data compression algorithms, and they consequently neglect high order systems modes.

Vice versa, tensor network algorithms offer the possibility to design almost linearly scalable parallel solutions without the necessity of system size reduction. This remarkable feature is achieved since they break a large tensor into smaller entities providing the possibility to distribute small dimensional and, therefore, manageable matrices among the computational units. In addition, the methods can be implemented and executed on a single computing device as well as on distributed computing infrastructures such as for instance, cluster, grid, cloud, etc., laying the foundations to define a new roadmap in system simulation design for industrial applications.

The disclosure discusses a highly scalable parallel algorithm based on tensor network methods to numerically solve large systems of ordinary linear differential equations or of ordinary linear difference equations. Since the computation of the output response of a linear time invariant discrete time system can be computed through the solution of a suitable equivalent matrix exponential, as it occurs in the continuous time case, the disclosure will refer to continuous time systems only, and dedicate a specific section to the discrete time case.

Linear differential equations which represent the system mathematical models of many industrial applications are characterized by a large number of variables. The employment of the distributed computing paradigm is, therefore, a pragmatic and effective response to this challenge. Under this premise, tensor network techniques address the issue since they allow the development of parallel algorithms to simulate any high dimensional systems that can be recast in a state space representation.

The core of the methodology is based on exploiting the theoretical and mathematical analogy between the Schrödingerequation, which is linear and governs quantum mechanics, and the state space representation of linear time-invariant systems. Indeed, if the Hamiltonian operator Ĥ and the wave function Ψ(x,t) are substituted by the system matrix A and the state matrix X(t) respectively, the tensor network algorithms that are applied to provide the numerical solution of the Schrödingerequation can also be employed to solve any system in a state space representation. This is achievable since in both the multi quantum bodies problems and state space systems, the free evolution time dependent analytical and, therefore, also numerical, solution may utilize the computation of a matrix exponential.

For instance, the Time Evolution Block Decimation (TEBD) algorithm can, indeed, effectively address big system time dependent solutions. The method has been developed by computational physicists to provide the numerical solution of the Schrödingerequation, e.g., to evaluate the time evolution of multi bodies quantum systems by efficiently calculating the exponential of large matrices. The key feature of the algorithm is associated with breaking the Hamiltonian into groups of non-commutative matrices that are afterwards divided into smaller commutative matrices which can be handled by one single processing unit. The Suzuki Trotter decomposition follows to compute the time dependency in a very effective distributed manner.

The disclosure discusses, for example, using the TEBD algorithm to solve time dependent responses of any system which can be recast in a state space representation, and can include the following steps:
(1) building a mathematical representation of the physical, economic, engineering, etc., problem through differential equations;
(2) determining the graph that defines the connections between the system’s states and computing the adjacency matrix;
(3) identifying through an optimization process the sets of matrices such as all the elements within each set commute each other while at least one element of a set does not commute with one element of another set;
(4) implementing una tantum the Suzuki Trotter decomposition with a given time interval δ and a predefined p expansion order;
(5) evaluating the system response evaluation at the time T=Nδ by iteratively using N-times the result obtained in step 4;
(6) generating simulation results for the problem within an error of order of No(δ^{p+1}).

Strengths of the system can be associated with an algorithm almost linearly scalable for lumped masses and highly scalable for FEM: any big system can be simulated because the only limitation is based on the number of computational units. There is not a necessity of system model reduction, all high order modes are included, simultaneous system response computation for different initial states X(0), e.g., the algorithm computes system time evolution for a set of initial conditions X(0) in just one computational run, and simulation error of order No(δ^{p+1}), e.g., any accuracy can be reached since the error is strictly controlled by adjusting the time interval length δ or the Suzuki Trotter expansion order p.

The wave function behaviour of a quantum mechanical system is expressed by the well-known Schrödingerequation. For a given Hamiltonian operator Ĥ and wave function Ψ(x,t), the time dependent Schrödingerequation is represented by a linear partial differential equation:

$$i ħ \frac{\partial Ψ \left(x , t\right)}{\partial t} = \hat{H} Ψ \left(x , t\right) , \qquad \text{(1)}$$

where i is the imaginary unit and h is the (reduced) Planck constant.

If the Hamiltonian operator Ĥ is constant, the solution of equation (1) assumes the expression:

$$\left|Ψ \left(t\right)\right〉 = {e}^{- i \frac{\hat{H}}{ħ} t} \left|Ψ \left(0\right)\right〉 \qquad \text{(2)}$$

It is well known that in case of large dimensionality, equation (2) cannot be numerically solved especially due to the presence of the matrix exponential term

$${e}^{- i \frac{\hat{H}}{ħ} t} .$$

Analogously, for any linear time invariant continuous time system expressed through the state space representation

$$\begin{matrix}\frac{d x \left(t\right)}{d t} = A x \left(t\right) + B u \left(t\right) \\ y \left(t\right) = C x \left(t\right) + D u \left(t\right)\end{matrix} \qquad \text{(3)}$$

the computation of the free evolution x_{f}(t) of the system may require solving the following simplified model

$$\frac{d {x}_{f} \left(t\right)}{d t} = A {x}_{f} \left(t\right) \qquad \text{(4)}$$

whose solution is given by:

$${x}_{f} \left(t\right) = {e}^{A t} x \left(0\right) , ∀ t \geq 0 , \qquad \text{(5)}$$

where x(0) is a column vector containing the initial state conditions.

More in general, an initial state matrix X(0) can be considered and formed by n linearly independent column vectors, which are a vector basis whose linear combination provides all the possible initial conditions values:

$$X \left(0\right) = \left[{x}_{1} \left(0\right) , {x}_{2} \left(0\right) , … {x}_{n} \left(0\right)\right]$$

In this case, equation (5) becomes:

$${X}_{f} \left(t\right) = {e}^{A t} X \left(0\right) , ∀ t \geq 0 , \qquad \text{(6)}$$

where X_{f}(t) is a matrix, whose columns are the free evolution state vectors for the initial conditions given by the corresponding columns of the matrix X(0).

If replacing the role of | Ψ(t)〉 with X(t),

$$- i \frac{\hat{H}}{ħ}$$

with A, | Ψ(0) with X(0) the similarity between equations (2) and (6) is established.

Moreover, in both cases (2) and (6), the system computes an exponential matrix. Such a mathematical analogy has a great impact on technology because many continuous time systems are modelled as in equation (3) (a non-exhaustive list of fields of application include for instance engineering applications, economics, statistics, computer science, neuroscience, etc ...) and, consequently, analytical, and numerical methods applied to compute (2) can also be employed for equation (6).

For instance, computational physics-related methods like the time-evolving block decimation (TEBD) and density matrix renormalization group (DMRG) algorithms are currently applied on a distributed platform to numerically solve equation (2) and they can be therefore also used in (6).

Any finite dimensional linear time-invariant system (LTI) can be expressed in a matrix state space representation as follows:

$$\begin{matrix}\frac{d x \left(t\right)}{d t} = A x \left(t\right) + B u \left(t\right) \\ y \left(t\right) = C x \left(t\right) + D u \left(t\right)\end{matrix}$$

This is a system of linear differential equations whose free evolution x_{ƒ}(t) is given by:

$${x}_{f} \left(t\right) = {e}^{A t} x \left(0\right) , ∀ t \geq 0 ,$$

In many technological applications, the matrix A is extremely large, and it consequently cannot be handled by only one computational unit. In this context, the distributed computing paradigm offers a viable solution to solve the exponential of large matrices. However, other than distributed infrastructures (e.g., cluster, grid, or cloud platforms), parallel algorithms can be used. Indeed, the calculation is to be executed in a distributed manner, within a certain error and designed in a way that requires low communication among the computational units.

In this context, the TEBD algorithm, for instance, has the potential to address this high dimensional problem because it provides the numerical solution of large quantum many-body systems.

To gain insights on how the TEBD methodology works, the commutative property of multiplication does not hold for matrices as in general AB ≠ BA. For this reason, the exponential of a sum of matrices cannot be embarrassingly parallelised.

Indeed, the exponential of the sum of two matrices is different than the product of the two-matrix exponential e^{A+B} ≠ e^{A}e^{B}. The equality e^{A+B} = e^{A}e^{B} holds if and only if A and B are two matrices that have the algebraic property to commute each other AB = BA ⇔ [A, B] = 0.

The TEBD algorithm succeeds in circumventing such a mathematical restriction by exploiting the Suzuki Trotter decomposition that relies on approximating the exponential of a sum of matrices with a function whose arguments are single matrix exponential e^{A+B} ≅ f(e^{A},e^{B}) each. The core of the TEBD method is based on, firstly, subdividing the matrix A into n sets of matrices whose elements commute each other while at least one element of a set does not commute with at least one element of another set and, secondly, performing the Suzuki Trotter decomposition on these n sets.

The tensor network technique can be applied based on TEBD to determine the free evolution x_{ƒ}(t) = e^{At}x(0) of big dynamic systems. To do so, the disclosure provides a mathematical representation of the problem (physical, economic, engineering, ... etc..) through differential equations. Secondly, the adjacency matrix is evaluated by determining the graph that defines the connections between the system’s states. Then, through an optimization process, the minimum number of sets is computed such that all the elements within each set commute each other while at least one element of a set does not commute with one element of another set. Fourth, the Suzuki Trotter decomposition with time interval δ and order p is computed offline and then iteratively used to reach the instant time T=Nδ. Lastly, the final system response of a set of initial conditions X(0) is computed at the time T. The total error of the simulation will be of order No(δ^{p+1}) as the Suzuki Trotter decomposition will be iteratively employed N times. Any accuracy can be, therefore, achieved by either reducing the time interval δ or increasing the Suzuki Trotter decomposition order p.

As an example, the mathematical representation of the problem may be associated with thermal analysis of aircraft, automobiles, or another object. In addition, the mathematical representation of the problem may be associated with structural analysis or thermal structural analysis. The structural analysis or the thermal structural analysis may be associated with one or more buildings, bridges, automobiles, or other objects or structures. Even further, the mathematical representation of the problem may be related to thermofluiddynamics or aerodynamics. As an example, the problem may be related to one or more pipes for fluids such as water or oil or may be related to aerodynamics associated with an aircraft, an automobile, or a train, among others. In addition, the mathematical representation may be related to electromagnetic modelling of one or more electric or magnetic fields. As another example, the mathematical representation of the problem may be related to computational finance such as a problem related to financial derivatives (e.g., options) or other financial problems.

The system discussed herein is able to utilize one or more of high performance computing devices (HPC), grid computing devices, or cloud computing infrastructure to provide a way to simulate large state space systems. As an example, the system is able to divide each problem into one or more tasks and assign each task to one or more processing devices, or cores of processing devices, or threads of processing devices such as CPUs or GPUs to perform analysis of the problem in parallel. As a result, the tensor network associated with the system provides an almost linearly scalable solution using the lumped masses method (LMM) and is highly scalable using the finite element method (LMM). The system may eliminate system model reduction, e.g., all high order modes may be included. In addition, a user may adjust simulation error of the system. In one example, the user may adjust accuracy by modifying the time interval δ or the p order Suzuki Trotter expansion. Even further, the system provides simultaneous response computation for different initial states X(0).

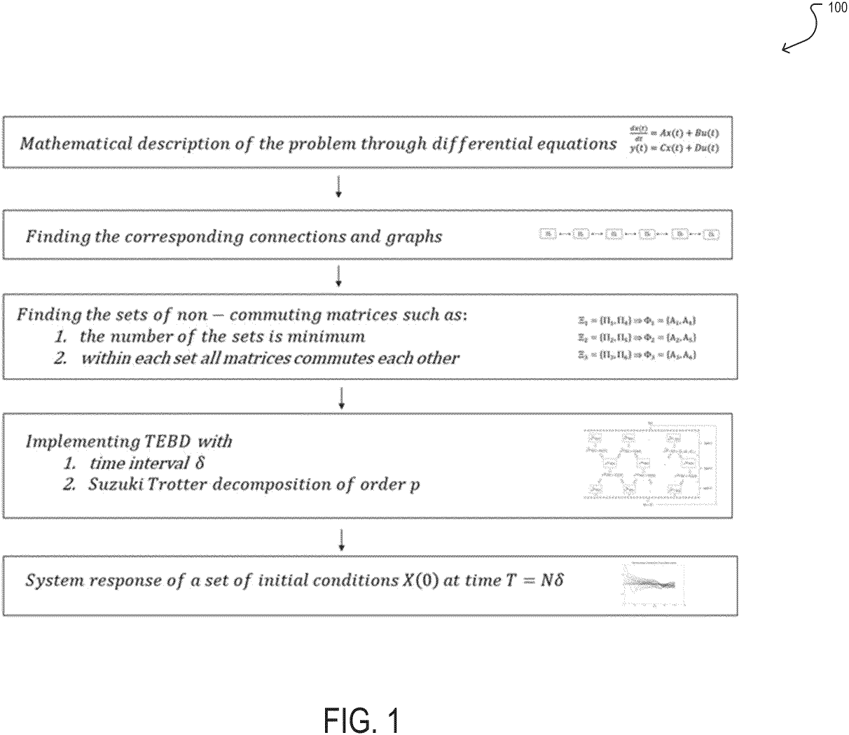

FIG. 1 shows a diagram of a method 100 performed by the system according to an example of the instant disclosure.

Next, the disclosure includes determining corresponding connections, graphs, and a minimum set of non-commuting matrices. The first example is a one-dimensional lattice.

In a one-dimensional lattice, the interactions are occurring only between neighboring sites.

In one example, the one-dimensional lattice may be made of six sites although it may include more or less than six sites.

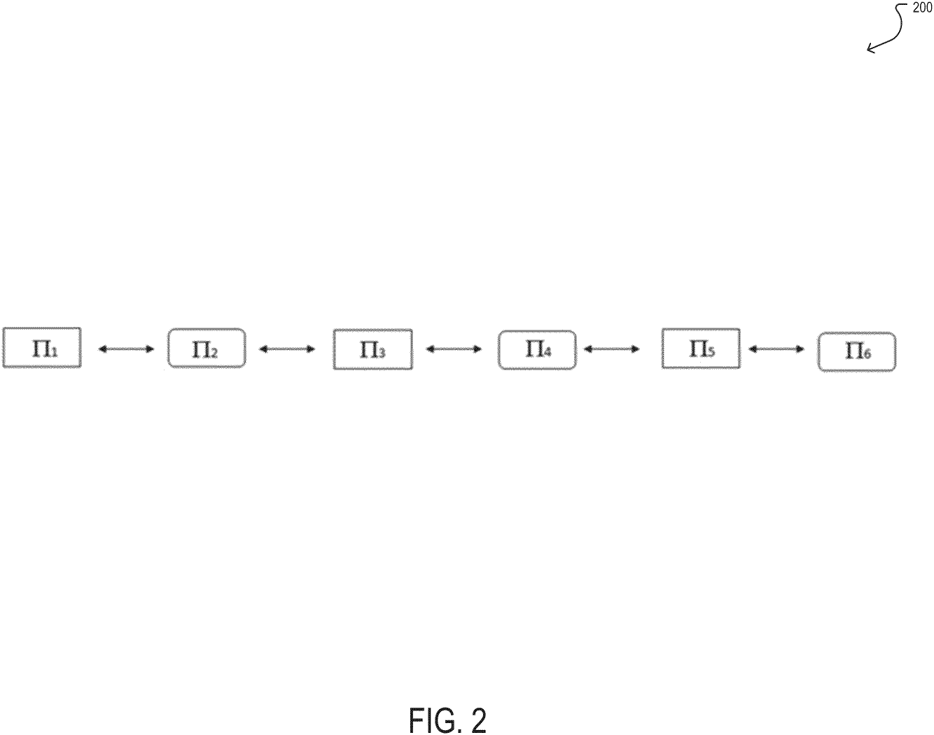

FIG. 2 shows the one-dimensional lattice 200 with one neighboring site interaction according to an example of the instant disclosure.

As provided below, G can be the adjacency matrix defined as a matrix whose element gᵢⱼ is equal to 1 if the sites Πⱼ and Πⱼ are connected (i.e., there is an edge between them) otherwise is equal to 0.

$${g}_{i j} = \left\{\begin{matrix}= 0 i f {Π}_{i} \text{and} {Π}_{j} \text{are not connected} \\ = 1 i f {Π}_{i} \text{and} {Π}_{j} \text{are connected}\end{matrix}\right)$$

The adjacency matrix G for the case in FIG. 2 is given by:

$$G = \left[\begin{matrix}0 & 1 & 0 & 0 & 0 & 0 \\ 1 & 0 & 1 & 0 & 0 & 0 \\ 0 & 1 & 0 & 1 & 0 & 0 \\ 0 & 0 & 1 & 0 & 1 & 0 \\ 0 & 0 & 0 & 1 & 0 & 1 \\ 0 & 0 & 0 & 0 & 1 & 0\end{matrix}\right]$$

The diagonal terms in the matrix G are equal to zero since there are no self-loops while instead all off-diagonal terms next to the diagonal are equal to one.

As provided below, Aᵢ can be the matrix representative of the site Πᵢ, i ∈{1,2,3,4,5,6}, e.g., the matrices Aᵢ are the algebraic formulation of the physical interpretation of the site Πᵢ. The commutation matrix C defined as a matrix whose element cᵢⱼ is equal to the commutation term [Aᵢ, Aⱼ]:

$${c}_{i j} = \left[{A}_{i} , {A}_{j}\right]$$

is given by:

$$C = \left[\begin{matrix}\left[{A}_{1} , {A}_{1}\right] & \left[{A}_{1} , {A}_{2}\right] & \left[{A}_{1} , {A}_{3}\right] & \left[{A}_{1} , {A}_{4}\right] & \left[{A}_{1} , {A}_{5}\right] & \left[{A}_{1} , {A}_{6}\right] \\ \left[{A}_{2} , {A}_{1}\right] & \left[{A}_{2} , {A}_{2}\right] & \left[{A}_{2} , {A}_{3}\right] & \left[{A}_{2} , {A}_{4}\right] & \left[{A}_{1} , {A}_{5}\right] & \left[{A}_{2} , {A}_{6}\right] \\ \left[{A}_{3} , {A}_{1}\right] & \left[{A}_{3} , {A}_{2}\right] & \left[{A}_{3} , {A}_{3}\right] & \left[{A}_{3} , {A}_{4}\right] & \left[{A}_{1} , {A}_{5}\right] & \left[{A}_{3} , {A}_{6}\right] \\ \left[{A}_{4} , {A}_{6}\right] & \left[{A}_{4} , {A}_{6}\right] & \left[{A}_{4} , {A}_{3}\right] & \left[{A}_{4} , {A}_{4}\right] & \left[{A}_{1} , {A}_{5}\right] & \left[{A}_{4} , {A}_{6}\right] \\ \left[{A}_{5} , {A}_{6}\right] & \left[{A}_{5} , {A}_{6}\right] & \left[{A}_{5} , {A}_{3}\right] & \left[{A}_{5} , {A}_{4}\right] & \left[{A}_{1} , {A}_{5}\right] & \left[{A}_{5} , {A}_{6}\right] \\ \left[{A}_{6} , {A}_{1}\right] & \left[{A}_{6} , {A}_{2}\right] & \left[{A}_{6} , {A}_{3}\right] & \left[{A}_{1} , {A}_{4}\right] & \left[{A}_{1} , {A}_{5}\right] & \left[{A}_{6} , {A}_{6}\right]\end{matrix}\right]$$

$$= \left[\begin{matrix}0 & \neq 0 & 0 & 0 & 0 & 0 \\ \neq 0 & 0 & \neq 0 & 0 & 0 & 0 \\ 0 & \neq 0 & 0 & \neq 0 & 0 & 0 \\ 0 & 0 & \neq 0 & 0 & \neq 0 & 0 \\ 0 & 0 & 0 & \neq 0 & 0 & \neq 0 \\ 0 & 0 & 0 & 0 & \neq 0 & 0\end{matrix}\right]$$

The term cᵢⱼ ≠ 0 implies that sites Πᵢ and Πⱼ are connected, i.e.

$${c}_{i j} \neq 0 ⇒ {g}_{i j} = 1 ,$$

however, the contrary is not in general true because [Aᵢ, Aⱼ] is an algebraic product and therefore it is possible that [Aᵢ, Aⱼ] = 0 even if Πᵢ and Πⱼ are connected.

For this kind of one-dimensional lattice model, it is possible to partition the interaction graph in two sets Ξ₁ and Ξ₂ whose sites do not interact. Afterwards it is possible to consider the sets Φ₁ and Φ₂ constituted by the corresponding matrices representation.

Φᵢ can be the set containing the sites which the site Πᵢ commutes with Ξ₁ can be = {Π₁}. The first site commutes with the sites in Φ₁ = {Π₁, Π₃, Π₄, Π₅, Π₆}.

Next, it can be checked if the second site can be included in Ξ₁ = {Π₁}, and the tentative set

$${Ξ}_{1}^{∗} = {Ξ}_{1} ∪ \left\{{Π}_{2}\right\} = \left\{{Π}_{1} , {Π}_{2}\right\} .$$

Taking into consideration that the 2^{nd} site commutes with sites {Π₂, Π₄, Π₅, Π₆}, it can be observed that

$${Ξ}_{1}^{∗} ∩ {Φ}_{2} = \left\{{Π}_{1}\right\} ∩ \left\{{Π}_{2} , {Π}_{4} , {Π}_{5} , {Π}_{6}\right\} = ∅ .$$

Because

$${Ξ}_{1}^{∗} ∩ {Φ}_{2} \neq {Ξ}_{1}^{∗} ,$$

it is possible to exclude the 2^{nd} site and it is still Ξ₁ = {Π₁}.

The third site is checked next. Now, the tentative set is

$${Ξ}_{1}^{∗} = {Ξ}_{1} ∪ \left\{{Π}_{3}\right\} = \left\{{Π}_{1} , {Π}_{3}\right\}$$

and Π₃ commutes with sites {Π₁, Π₃, Π₅, Π₆}.

$${Ξ}_{1}^{∗} ∩ {Φ}_{3} = \left\{{Π}_{1} , {Π}_{3}\right\} ∩ \left\{{Π}_{1} , {Π}_{3} , {Π}_{5} , {Π}_{6}\right\} = \left\{{Π}_{1} , {Π}_{3}\right\} = {Ξ}_{1}^{∗} .$$

Since

$${Ξ}_{1}^{∗} ∩ {Φ}_{3} = {Ξ}_{1}^{∗} ,$$

the 3^{rd} site is accepted, and it can update Ξ₁ = {Π₁, Π₃}. The 4^{th} site commutes with sites {Π₁, Π₂, Π₄, Π₆} and

$${Ξ}_{1}^{∗} = {Ξ}_{1} ∪ \left\{{Π}_{4}\right\} ≡ \left\{{Π}_{1} , {Π}_{3} , {Π}_{4}\right\}$$

$$\begin{matrix}{Ξ}_{1}^{∗} ∩ {Φ}_{4} = \left\{{Π}_{1} , {Π}_{3} , {Π}_{4}\right\} ∩ \left\{{Π}_{1} , {Π}_{3} , {Π}_{5} , {Π}_{6}\right\} = \left\{{Π}_{1} , {Π}_{4}\right\} \\ {Ξ}_{1}^{∗} ∩ {Φ}_{4} \neq {Ξ}_{1}^{∗} ⇒ {Π}_{4} \text{excluded} \text{.}\end{matrix}$$

Checking the 5^{th} site, it commutes with sites {Π₁, Π₂, Π₃, Π₅} and

$${Ξ}_{1}^{∗} = {Ξ}_{1} ∪ \left\{{Π}_{5}\right\} = \left\{{Π}_{1} , {Π}_{3} , {Π}_{5}\right\}$$

$$\begin{matrix}{Ξ}_{1}^{∗} ∩ {Φ}_{5} = \left\{{Π}_{1} , {Π}_{3} , {Π}_{5}\right\} ∩ \left\{{Π}_{1} , {Π}_{2} , {Π}_{3} , {Π}_{5}\right\} = \left\{{Π}_{1} , {Π}_{3} , {Π}_{5}\right\} \\ {Ξ}_{1}^{∗} ∩ {Φ}_{5} = {Ξ}_{1}^{∗} ⇒ {Π}_{5} \text{included} \text{.}\end{matrix}$$

Checking the 6^{th} site, it commutes with sites {Π₁, Π₂, Π₃, Π₄} and the tentative set is now

$${Ξ}_{1}^{∗} = {Ξ}_{1} ∪ \left\{{Π}_{6}\right\} = \left\{{Π}_{1} , {Π}_{3} , {Π}_{5} , {Π}_{6}\right\}$$

$$\begin{matrix}{Ξ}_{1}^{∗} ∩ {Φ}_{6} = \left\{{Π}_{1} , {Π}_{3} , {Π}_{5}\right\} ∩ \left\{{Π}_{1} , {Π}_{2} , {Π}_{3} , {Π}_{4} , {Π}_{6}\right\} = \left\{{Π}_{1} , {Π}_{3}\right\} \\ {Ξ}_{1}^{∗} ∩ {Φ}_{6} = {Ξ}_{1}^{∗} ⇒ {Π}_{6} \text{excluded} \text{.}\end{matrix}$$

The process can be iterated by considering again the 2^{nd} site that has been previously excluded. It is possible that Ξ₂ = {Π₂}. The 4^{th} site can be considered and checked if it can be included in Ξ₂. The 3^{rd} site can be skipped as it has already been incorporated in Ξ₁.

$$\begin{matrix}{Ξ}_{2}^{∗} ∩ {Φ}_{4} = \left\{{Π}_{2} , {Π}_{4}\right\} ∩ \left\{{Π}_{1} , {Π}_{2} , {Π}_{4} , {Π}_{6}\right\} = \left\{{Π}_{2} , {Π}_{4}\right\} \\ {Ξ}_{2}^{∗} ∩ {Φ}_{4} = {Ξ}_{2}^{∗} ⇒ {Π}_{4} \text{included}\end{matrix}$$

Skipping the 5^{th} site, that has been already considered, it can apply the same procedure for the site

$${Π}_{6} {Ξ}_{2}^{∗} ∩ {Φ}_{6} = \left\{{Π}_{2} , {Π}_{4} , {Π}_{6}\right\} ∩ \left\{{Π}_{1} , {Π}_{2} , {Π}_{3} , {Π}_{4} , {Π}_{6}\right\} = \left\{{Π}_{2} , {Π}_{4} , {Π}_{6}\right\}$$

$${Ξ}_{2}^{∗} ∩ {Φ}_{6} = {Ξ}_{2}^{∗} ⇒ {Π}_{6}$$

included

In the end:

$${Ξ}_{1} = \left\{{Π}_{1} , {Π}_{3} , {Π}_{5}\right\} ⇒ {Φ}_{1} = \left\{{A}_{1} , {A}_{3} , {A}_{5}\right\}$$

$${Ξ}_{2} = \left\{{Π}_{2} , {Π}_{4} , {Π}_{6}\right\} ⇒ {Φ}_{2} = \left\{{A}_{2} , {A}_{4} , {A}_{6}\right\}$$

Note that the solution obtained is not unique because the following groups are made of elements that are commutative each other

$${Ξ}_{1} = \left\{{Π}_{1} , {Π}_{3} , {Π}_{5}\right\} ⇒ {Φ}_{1} = \left\{{A}_{1} , {A}_{3} , {A}_{5}\right\}$$

$${Ξ}_{2} = \left\{{Π}_{2} , {Π}_{4}\right\} ⇒ {Φ}_{2} = \left\{{A}_{2} , {A}_{4}\right\}$$

$${Ξ}_{3} = \left\{{Π}_{6}\right\} ⇒ {Φ}_{3} = \left\{{A}_{6}\right\}$$

The algorithm described above is an example of a methodology about how to select commutative sets of matrices, with a non-unique result, in the sense that it may have a different solution depending on the starting conditions.

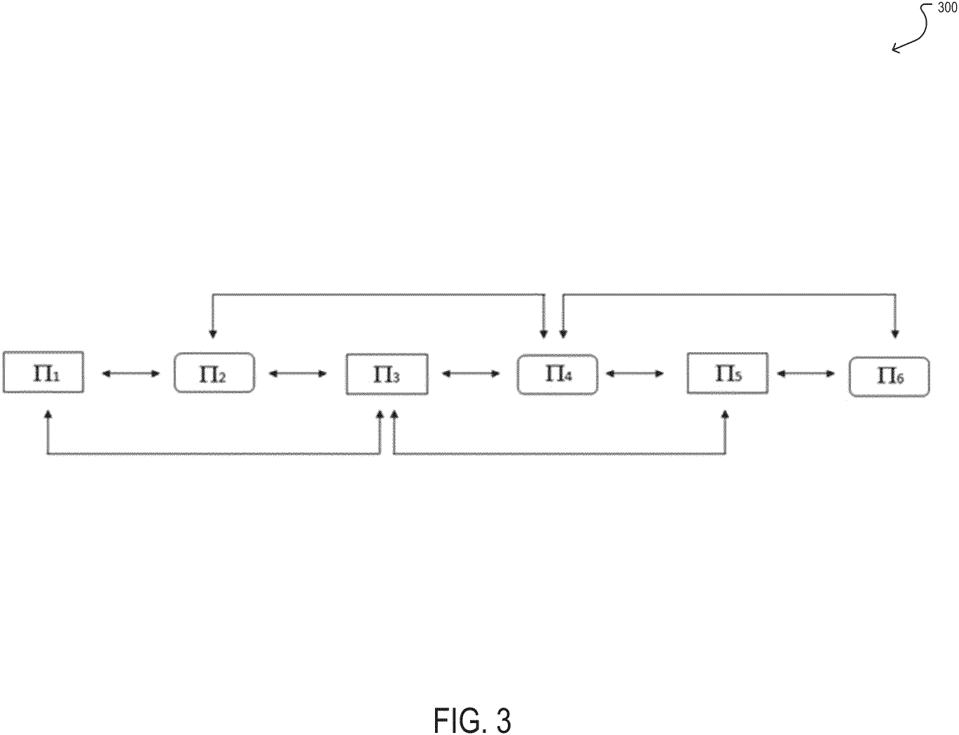

Next, a one-dimensional lattice model 300 with two neighbouring sites interaction can be considered as shown in FIG. 3.

The adjacency matrix G is therefore

$$G = \left[\begin{matrix}0 & 1 & 1 & 0 & 0 & 0 \\ 1 & 0 & 1 & 1 & 0 & 0 \\ 1 & 1 & 0 & 1 & 1 & 0 \\ 0 & 1 & 1 & 0 & 1 & 1 \\ 0 & 0 & 1 & 1 & 0 & 1 \\ 0 & 0 & 0 & 1 & 1 & 0\end{matrix}\right]$$

For this kind of one-dimensional lattice model, it is possible to partition the interaction graph in three sets Ξ₁, Ξ₂ and Ξ₃ including the sites which do not interact:

$${Ξ}_{1} = \left\{{Π}_{1} , {Π}_{4}\right\} ⇒ {Φ}_{1} = \left\{{A}_{1} , {A}_{4}\right\}$$

$${Ξ}_{2} = \left\{{Π}_{2} , {Π}_{5}\right\} ⇒ {Φ}_{2} = \left\{{A}_{2} , {A}_{5}\right\}$$

$${Ξ}_{3} = \left\{{Π}_{3} , {Π}_{6}\right\} ⇒ {Φ}_{3} = \left\{{A}_{3} , {A}_{6}\right\}$$

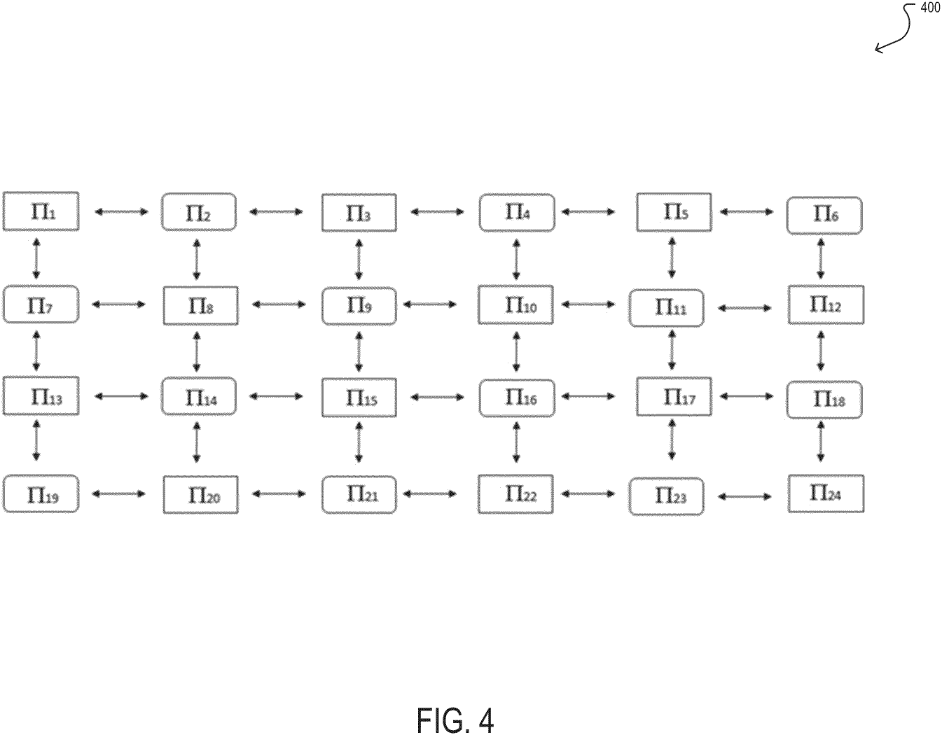

A two-dimensional lattice 400 can be partitioned using square elements representation as shown in FIG. 4.

The adjacency matrix G is:

$$G = = \left[\begin{matrix}0 & 1 & 0 & 0 & ⋯ & 0 \\ 1 & 0 & 0 & 0 & ⋯ & 0 \\ 0 & 0 & 0 & 0 & ⋯ & 0 \\ 0 & 0 & 0 & 0 & ⋯ & 0 \\ ⋮ & ⋮ & ⋮ & ⋮ & ⋱ & ⋮ \\ 1 & 0 & 0 & 0 & ⋯ & 0 \\ ⋮ & ⋮ & ⋮ & ⋮ & ⋱ & ⋮ \\ 0 & 0 & 0 & 0 & ⋯ & 0\end{matrix}\right]$$

While the commutation matrix C is given by:

$$C = \left[\begin{matrix}\left[{A}_{1} , {A}_{1}\right] & \left[{A}_{1} , {A}_{2}\right] & \left[{A}_{1} , {A}_{3}\right] & ⋯ & \left[{A}_{1} , {A}_{24}\right] \\ \left[{A}_{2} , {A}_{1}\right] & \left[{A}_{2} , {A}_{2}\right] & \left[{A}_{2} , {A}_{3}\right] & ⋯ & \left[{A}_{2} , {A}_{24}\right] \\ \left[{A}_{3} , {A}_{1}\right] & \left[{A}_{3} , {A}_{2}\right] & \left[{A}_{3} , {A}_{3}\right] & ⋯ & \left[{A}_{3} , {A}_{24}\right] \\ ⋮ & ⋮ & ⋮ & ⋱ & ⋮ \\ \left[{A}_{7} , {A}_{1}\right] & \left[{A}_{7} , {A}_{2}\right] & \left[{A}_{7} , {A}_{3}\right] & ⋯ & \left[{A}_{7} , {A}_{24}\right] \\ ⋮ & ⋮ & ⋮ & ⋱ & ⋮ \\ \left[{A}_{24} , {A}_{1}\right] & \left[{A}_{24} , {A}_{2}\right] & \left[{A}_{24} , {A}_{3}\right] & ⋯ & \left[{A}_{24} , {A}_{24}\right]\end{matrix}\right]$$

$$= \left[\begin{matrix}0 & \neq 0 & 0 & 0 & ⋯ & 0 \\ \neq 0 & 0 & 0 & 0 & ⋯ & 0 \\ 0 & 0 & 0 & 0 & ⋯ & 0 \\ 0 & 0 & 0 & 0 & ⋯ & 0 \\ ⋮ & ⋮ & ⋮ & ⋮ & ⋱ & ⋮ \\ \neq 0 & 0 & 0 & 0 & ⋯ & 0 \\ ⋮ & ⋮ & ⋮ & ⋮ & ⋱ & ⋮ \\ 0 & 0 & 0 & 0 & ⋯ & 0\end{matrix}\right]$$

The two sets Ξ₁ and Ξ₂ are in this case

$${Ξ}_{1} = \left\{{Π}_{1} , {Π}_{3} , {Π}_{5} , {Π}_{8} , {Π}_{10} , {Π}_{12} , {Π}_{13} , {Π}_{15} , {Π}_{17} , {Π}_{20} , {Π}_{22} , {Π}_{24} ,\right\}$$

$${Ξ}_{2} = \left\{{Π}_{2} , {Π}_{4} , {Π}_{6} , {Π}_{7} , {Π}_{9} , {Π}_{11} , {Π}_{14} , {Π}_{16} , {Π}_{18} , {Π}_{19} , {Π}_{21} , {Π}_{23}\right\}$$

And the sets Φ₁ and Φ₂ are in this case:

$${Φ}_{1} = \left\{{A}_{1} , {A}_{3} , {A}_{5} , {A}_{8} , {A}_{10} , {A}_{12} , {A}_{13} , {A}_{15} , {A}_{17} , {A}_{20} , {A}_{22} , {A}_{24}\right\}$$

$${Φ}_{2} = \left\{{A}_{2} , {A}_{4} , {A}_{6} , {A}_{7} , {A}_{9} , {A}_{11} , {A}_{14} , {A}_{16} , {A}_{18} , {A}_{19} , {A}_{21} , {A}_{23}\right\}$$

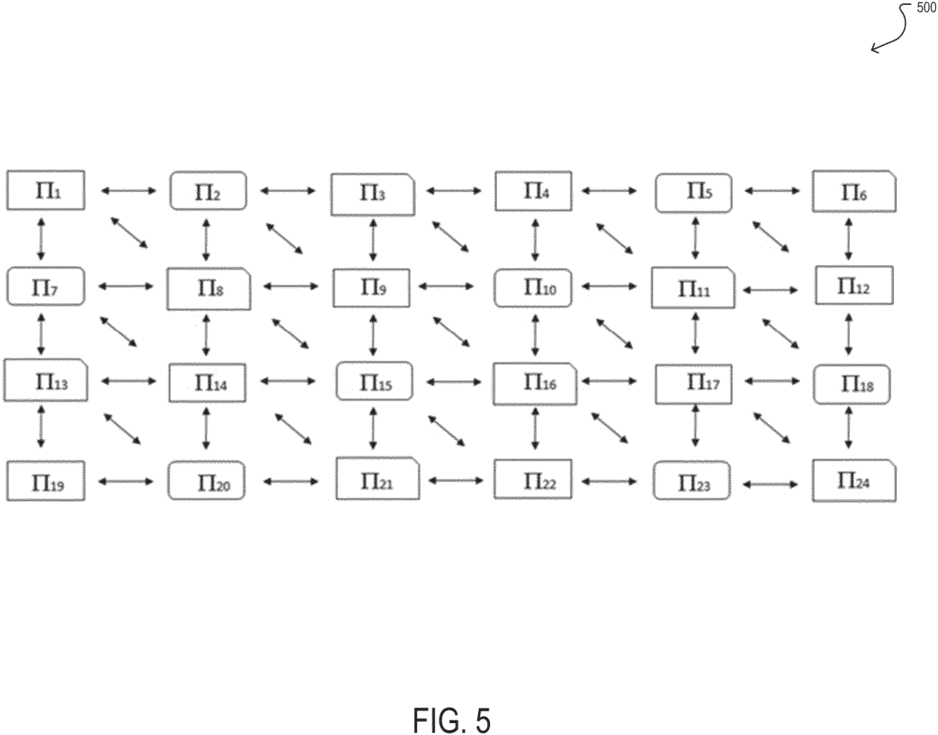

In case the mesh is constituted by triangle elements as shown in FIG. 5), three sets Ξ₁, Ξ₂ and Ξ₃ can be identified:

FIG. 5 shows a two-dimensional lattice 500 with one neighbouring sites interaction and partitioned using triangle elements.

The three sets Ξ₁, Ξ₂ and Ξ₃ are in this case

$${Ξ}_{1} = \left\{{Π}_{1} , {Π}_{4} , {Π}_{9} , {Π}_{12} , {Π}_{14} , {Π}_{17} , {Π}_{19} , {Π}_{22}\right\}$$

$${Ξ}_{2} = \left\{{Π}_{2} , {Π}_{5} , {Π}_{7} , {Π}_{10} , {Π}_{15} , {Π}_{18} , {Π}_{20} , {Π}_{18} , {Π}_{23}\right\}$$

$${Ξ}_{3} = \left\{{Π}_{3} , {Π}_{6} , {Π}_{8} , {Π}_{11} , {Π}_{13} , {Π}_{16} , {Π}_{21} , {Π}_{24}\right\}$$

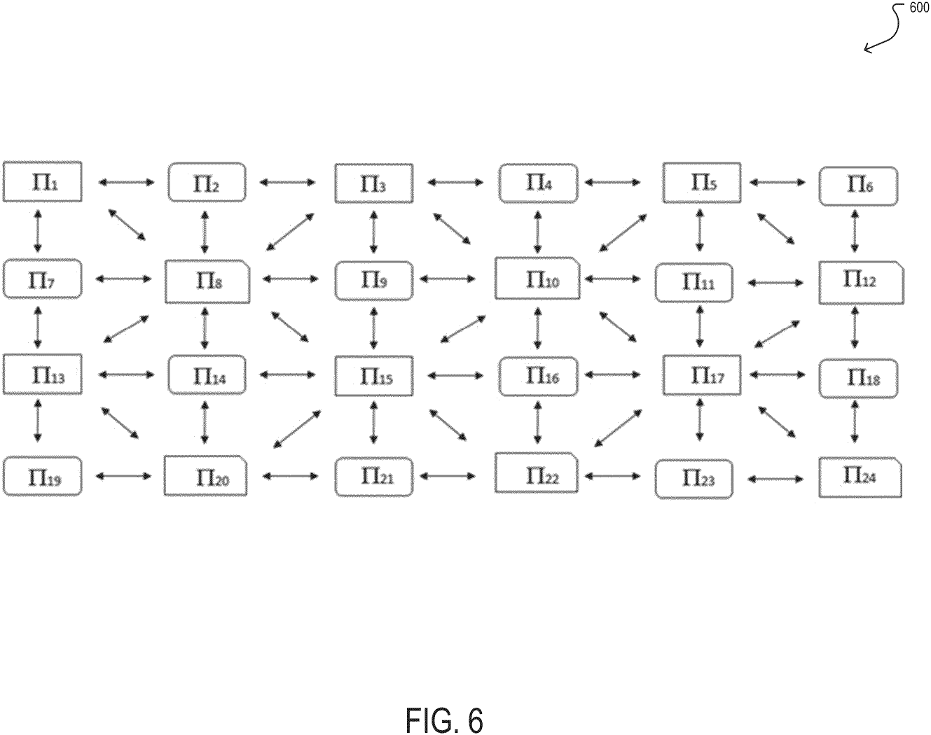

The connection within the sites of the mesh through triangles could also be different as shown in FIG. 6.

FIG. 6 shows a two-dimensional lattice 600 with one neighbouring sites interaction and partitioned using another pattern of triangle elements.

The three sets Ξ₁, Ξ₂ and Ξ₃ are in this case include the following elements:

$${Ξ}_{1} = \left\{{Π}_{1} , {Π}_{3} , {Π}_{5} , {Π}_{13} , {Π}_{15} , {Π}_{17} ,\right\}$$

$${Ξ}_{2} = \left\{{Π}_{2} , {Π}_{4} , {Π}_{6} , {Π}_{7} , {Π}_{9} , {Π}_{11} , {Π}_{14} , {Π}_{16} , {Π}_{18} , {Π}_{19} , {Π}_{21} , {Π}_{23}\right\}$$

$${Ξ}_{3} = \left\{{Π}_{8} , {Π}_{10} , {Π}_{12} , {Π}_{20} , {Π}_{22} , {Π}_{24}\right\}$$

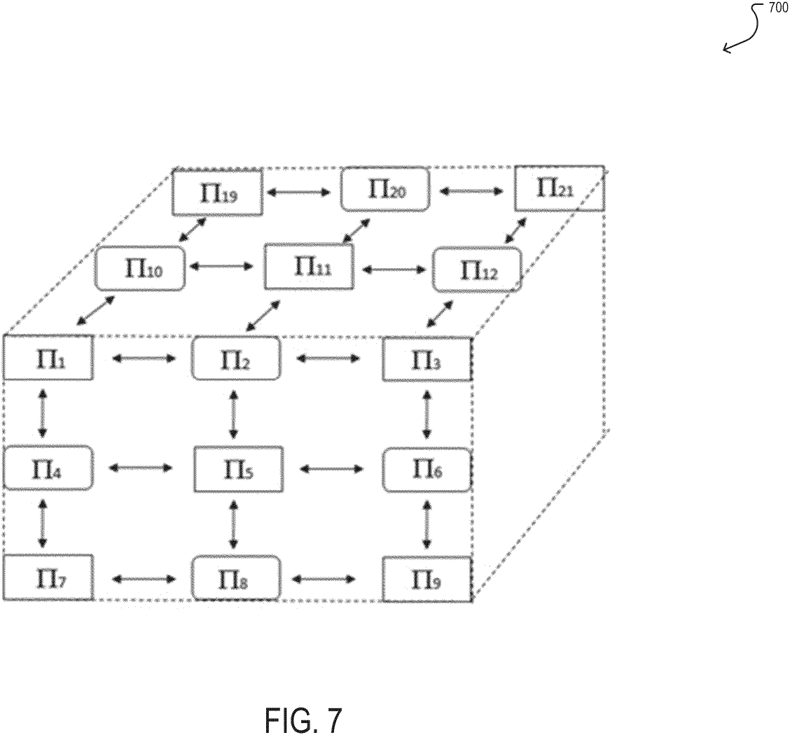

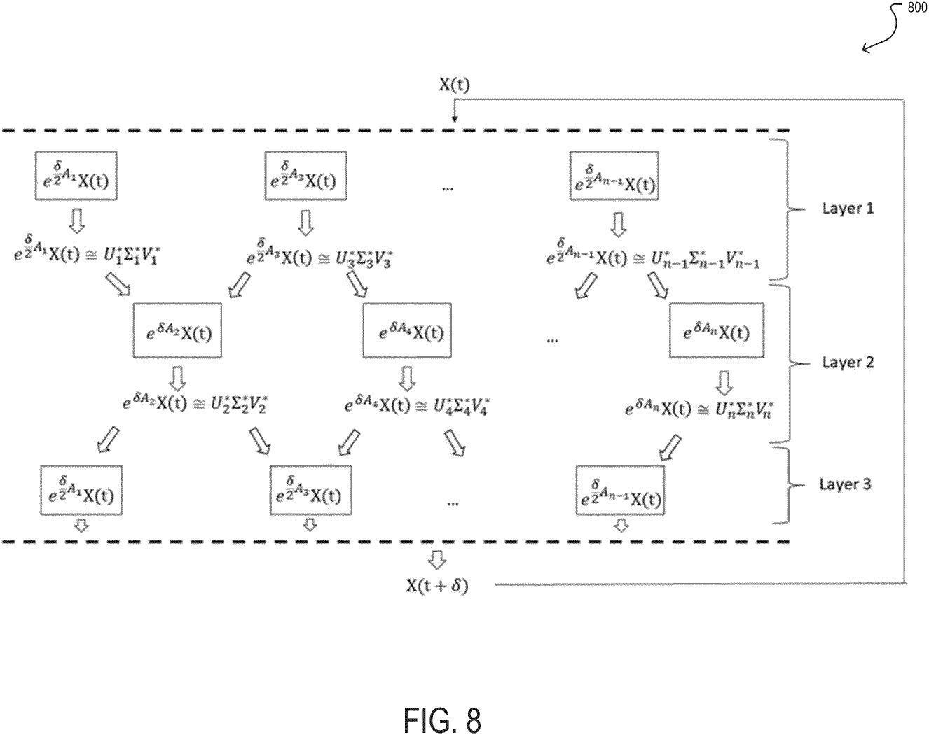

FIG. 7 shows a three-dimensional lattice 700 with cubic elements and two sets Ξ₁ and Ξ₂ . In addition, FIG. 7 shows the three-dimensional lattice 700 with one neighboring site interaction and is partitioned using cubic elements.

In this case the two sets are easily identified by simply considering the even and odd indexes:

$$\begin{matrix}{Ξ}_{1} = \left\{{Π}_{1} , {Π}_{3} , {Π}_{5} , {Π}_{7} , {Π}_{9} , {Π}_{11} , {Π}_{13} , {Π}_{15} , {Π}_{17} , {Π}_{19} , {Π}_{21} , {Π}_{23} , {Π}_{25} ,\right) \\ \left({Π}_{27} , {Π}_{29}\right\} ,\end{matrix}$$

$$\begin{matrix}{Ξ}_{2} = \left\{{Π}_{2} , {Π}_{4} , {Π}_{6} , {Π}_{8} , {Π}_{10} , {Π}_{12} , {Π}_{14} , {Π}_{16} , {Π}_{18} , {Π}_{20} , {Π}_{22} , {Π}_{24} ,\right) \\ \left({Π}_{26} , {Π}_{28}\right\} .\end{matrix}$$

The system relates to numerically solving by using a tensor network and the dynamics of any system that can be recast as a linear time invariant state space representation. In one example, a mathematical formulation is provided to build the optimal tensor network by identifying the sets Ξᵢ, i∈ℑ = {1, ...,I} (it is usually I ∈ {2,3}), containing the sites Πₖ, k∈ Kᵢ ⊆ {1, ..., n}, and the corresponding representative matrices Aₖ:

$$\begin{matrix}{Ξ}_{i} = {\left\{{Π}_{k}\right\}}_{k ∈ {K}_{i}} ⇒ {Φ}_{i} = {\left\{{A}_{k}\right\}}_{k ∈ {K}_{i}} , i ∈ ℑ , \text{with} \\ {\sum }_{k ∈ {K}_{i}} {A}_{k} + ⋯ {\sum }_{k ∈ {K}_{I}} {A}_{k} = A .\end{matrix}$$

To build the optimal tensor network, it is desirable to solve a constrained minimization problem whose solution is the optimal sets Ξᵢ, i∈ℑ = {1, ..., I} with I minimum. Minimum I

$$\begin{matrix}s u b j e c t t o : {Φ}_{i} = {\left\{{A}_{k}\right\}}_{k ∈ {K}_{i}} , i ∈ ℑ = \left\{1 , … , I\right\} \\ {\sum }_{k ∈ {K}_{1}} {A}_{k} + ⋯ {\sum }_{k ∈ {K}_{I}} {A}_{k} = A\end{matrix}$$

This optimization problem can be solved by using linear programming, integer linear and non-linear programming as well as machine learning, deep learning, and neural network algorithms, among others.

Once the number I of non-commuting sets i∈ℑ = {1, ..., I} has been computed, a Lie-Trotter-Suzuki decomposition can be performed.

A TEBD implementation in which the matrix A can be divided in only two sets Ξ₁ and Ξ₂ of non-commuting matrices is provided below. In case more sets of non-commuting matrices Ξᵢ, i∈ℑ = {1, ..., I} are considered the same rationale can be applied.

A can be a matrix such as it can be split as a sum of I addends denoted by A₁,A₂, ... A_{I}

$$A = {\sum }_{j = 1}^{I} {A}_{j} = {\sum }_{j o d d} {A}_{j} = {\sum }_{j e v e n} {A}_{j}$$

and each matrix Aⱼ in the set which has an odd index commutes with all the matrices having odd indexes and does not commute with at least one matrix having an even index. Furthermore, each matrix Aⱼ in the set of even indices matrices commutes with all the matrices having even indices and does not commute with at least one matrix having odd indices. In synthesis:

$$∃ i e v e n , j o d d s u c h a s \left[{A}_{i} , {A}_{j}\right] \neq 0$$

$$\left[{A}_{i} , {A}_{j}\right] = 0 ∀ i e v e n , ∀ j e v e n$$

$$\left[{A}_{i} , {A}_{j}\right] = 0 ∀ i o d d , ∀ j o d d$$

The Suzuki Trotter decomposition of order p can be applied on the two sets of matrices ∑ⱼ ₒ_{dd}Aⱼ and ∑ⱼ even Aⱼ, and this results in ₑ∑_{jodd}Aⱼ+∑ⱼₑᵥₑₙAⱼ ≅ _{f(e}∑_{jodd}Aⱼ, ₑ∑ⱼₑᵥₑₙAⱼ). As an example, setting p=2, the second order approximant is given by:

$$x \left(δ\right) = {e}^{A δ} = {e}^{\frac{δ}{2} {A}_{o d d}} {e}^{δ \text{} {A}_{e v e n}} {e}^{\frac{δ}{2} {A}_{o d d}} + o \left({δ}^{3}\right) ,$$

δ where the term

$${e}^{\frac{δ}{2} {A}_{o d d}}$$

can be furthermore expressed as product of the exponential of the matrices that have odd indices (this equality holds since all those matrices do commute with each other by construction):

$${e}^{\frac{δ}{2} {A}_{o d d}} = {\prod }_{j o d d} {e}^{\frac{δ}{2} {A}_{j}} .$$

By applying the same consideration to the term e^{δAeven}:

$${e}^{δ {A}_{e v e n}} = {\prod }_{j e v e n} {e}^{δ \text{} {A}_{j}} .$$

Thanks to this property, the Suzuki Trotter decomposition can be implemented in parallel.

A parallel solution for the second order approximant is provided because once the methodology has been identified, the same approach can also be applied for higher order approximants. In case of the second order approximant, the Suzuki Trotter decomposition is performed in only three different steps in the sense that there are three layers on which a parallel computation is performed. In the first step, the term

$${e}^{\frac{δ}{2} {A}_{o d d}}$$

can be calculated by distributing on different computing units each single term

$${e}^{\frac{δ}{2} {A}_{j}}$$

, ⱼ odd, of the overall product Π ⱼ _{odd}

$${e}^{\frac{δ}{2} {A}_{j}} .$$

In the second layer, the term e^{δAeven} can be calculated by multiplying each e^{δAj}, ⱼ even, with the results of the first step that will include only the terms that interact with Aⱼ once they have been compressed through singular value decompositions (SVDs). It will then follow the final layer that will compute the products between each

$${e}^{\frac{δ}{2} {A}_{j}}$$

and the corresponding SVDs compressed outputs retrieved from the second step.

Although the Suzuki Trotter decomposition can be an iterative process to calculate the system evolution, since it computes the matrix exponential for a small-time step δ<<1, the terms

$${e}^{\frac{δ}{2} {A}_{1}} , … {e}^{\frac{δ}{2} {A}_{j}} ,$$

odd, and e^{δA2},... e^{δAj}, j even, are calculated only once during the simulation since they are constant along the time evolution. This is an important feature that simplifies the calculation and makes the major computational bottleneck the SVDs evaluations. Indeed, except for the last layer, all the steps terminate by computing the SVDs of the corresponding threads output. This strategy aims at reducing the system size during the time evolving simulation process and is implemented by discarding the eigenvectors whose corresponding eigenvalues are below a given threshold. This ensures that low data transfer and communication messages will take place between layers and threads and the system size constantly decreases during the time evolution because the matrix A induces correlation among the state variables.

The TEBD algorithm can also be used to solve quantum states and, therefore, wave functions. This is achieved by ascertaining the mathematical analogy of the Schrödingerequation and the dynamical systems. The TEBD algorithm has been developed to solve the time evolution of quantum bodies and, therefore, the methodology has the task to evaluate the wave function Ψ(x,t). If the wave function is replaced at the time t=0, Ψ(0) with an initial state matrix X(0) formed by n linearly independent column vectors, representing all the possible values of initial conditions X(0) = [x₁(0), x₂ (0), ... xₙ(0)] the algorithm can solve all these trials in one computational run. In other words, instead of launching many Monte Carlo trials, the algorithm holds the capability to evaluate the entire solution set in only one computational run.

The methodology has therefore two major advantages that can be summarised as follows:
(1) singular value decompositions computed during the time evolution provide an efficient truncation technique of the large state space,
(2) all the simulation experiments corresponding to a set of Monte Carlo trials are processed in one single run.

As an example, the TEBD parallel algorithm can be used in which the second and fourth order approximant Suzuki Trotter decomposition is employed. A set of experimental trials can be computed in only one computational run.

Let

$${x}_{0}^{1} , {x}_{0}^{2} , … {x}_{0}^{q}$$

be q linearly independent column vectors that represent the initial conditions of q different simulation trials and let X be a matrix whose columns are the vectors

$${x}_{0}^{1} , {x}_{0}^{2} , … {x}_{0}^{q} .$$

A can be a band matrix or a different type of matrix.

On a given site Πᵢ a fraction, one or more threads can run for the task’s execution. As an example, that thread₁ is associated to site Π₁ and site Π₂, thread₂ to Π₃ and Π₄, and so on. However, the task assignment within the distributed computational scheme can also be different. For instance, thread₁ can be associated to only Π₁, thread₂ can be associated to Π₂ etc. or also even dynamically allocated through the processing in the sense that it can change during the processing.

In one example, I is an even number, the matrix A₁ is related to Π₁, matrix A₂ to Π₂, ... matrix A_{I} to site Π_{I} and the matrices satisfy the following properties:

A is a band matrix and can be split as a sum of A₁, A₂, ... A_{I}

$$A = {\sum }_{j = 1}^{I} {A}_{j} = {\sum }_{j o d d} {A}_{j} + {\sum }_{j e v e n} {A}_{j}$$

and each matrix Aⱼ does not commute with any adjacent matrix while it commutes with all the others:

$$\left[{A}_{j} , {A}_{j - 1}\right] \neq 0 , \left[{A}_{j} , {A}_{j + 1}\right] \neq 0 ∀ j ∈ \left\{1 , 2 , … n\right\}$$

$$\begin{matrix}… \left[{A}_{j} , {A}_{j - 3}\right] = 0 , \left[{A}_{j} , {A}_{j - 2}\right] = 0 , \left[{A}_{j} , {A}_{j + 2}\right] = 0 , \left[{A}_{j} , {A}_{j + 3}\right] = 0 , \\ … ∀ j ∈\end{matrix}$$

$$\left\{1 , 2 , … , I\right\}$$

Under the assumption of thread₁ assigned to sites Π₁ and Π₂, thread₂ to sites Π₃ and Π₄, ... thread_{n/2} to sites Π_{I-1} and Π_{I}, there can be a total of I/2 threads.

In one example, the initial time t=0 and the site Π₁ where it is assumed thread₁ executes. In the first layer thread₁ holds the subtask to evaluates the SVD of the term

$${e}^{\frac{δ}{2} {A}_{1}} X \left(0\right)$$

of the Suzuki Trotter decomposition. Considering SVD mathematical properties, there will be three matrices U₁, ∑₁, V₁ such as:

$$\begin{matrix}{e}^{\frac{δ}{2} {A}_{1}} X \left(0\right) = {U}_{1} {Σ}_{1} {V}_{1} = \left[{u}_{1} {u}_{2} … {u}_{m} … {u}_{n}\right] \\ \left[\begin{matrix}{σ}_{1} & 0 & ⋯ & 0 \\ 0 & {σ}_{2} & ⋯ & 0 \\ ⋮ & ⋮ & ⋱ & 0 \\ 0 & 0 & 0 & {σ}_{n}\end{matrix}\right] \left[\begin{matrix}{v}_{1} \\ {v}_{2} \\ ⋮ \\ {v}_{n}\end{matrix}\right] =\end{matrix}$$

$$= \left[{u}_{1} {u}_{2} … {u}_{m} … {u}_{n}\right] \left[\begin{matrix}{σ}_{1} & 0 & ⋯ & 0 & ⋯ & 0 \\ 0 & {σ}_{2} & ⋯ & 0 & ⋯ & 0 \\ ⋮ & ⋮ & ⋱ & 0 & ⋯ & 0 \\ 0 & 0 & 0 & {σ}_{m} & ⋯ & 0 \\ ⋮ & ⋮ & ⋮ & ⋮ & ⋱ & 0 \\ 0 & 0 & 0 & 0 & 0 & {σ}_{n}\end{matrix}\right] \left[\begin{matrix}{v}_{1} \\ {v}_{2} \\ ⋮ \\ {v}_{m} \\ ⋮ \\ {v}_{n}\end{matrix}\right] =$$

The matrix ∑₁ is diagonal for SVD construction, with the (ordered) singular values σ₁ ≥ σ₂ ≥ ... ≥ σₙ on its diagonal. The singular values below a given threshold, say σ̅, can be discarded to reduce the system size, e.g., if σ̅ ≥ σₘ₊₁ ≥ σₘ₊₂ ≥ ... ≥ σₙ, then:

$$≅ \left[{u}_{1} {u}_{2} … {u}_{m}\right] \left[\begin{matrix}{σ}_{1} & 0 & ⋯ & 0 \\ 0 & {σ}_{2} & ⋯ & 0 \\ ⋮ & ⋮ & ⋱ & 0 \\ 0 & 0 & 0 & {σ}_{m}\end{matrix}\right] \left[\begin{matrix}{v}_{1} \\ {v}_{2} \\ ⋮ \\ {v}_{m}\end{matrix}\right] ≅ {U}_{1}^{∗} {Σ}_{1}^{∗} {V}_{1}^{∗}$$

In the second computational layer, the site Π₂ in which only the data from the sites Π₁ and Π₃ can be conveyed as the other sites act on other positions since A is a band matrix, e.g.,

$${e}^{δ {A}_{2}} {e}^{\frac{δ}{2} {A}_{1}} X \left(0\right) {e}^{\frac{δ}{2} {A}_{3}} X \left(0\right) ≅ {e}^{δ {A}_{2}} {U}_{1}^{∗} {Σ}_{1}^{∗} {V}_{1}^{∗} {U}_{3}^{∗} {Σ}_{3}^{∗} {V}_{3}^{∗}$$

The step number three follows the same rationale, and the different computational layers showing the distributed implementation are shown in FIG. 1.

FIG. 1 shows a parallel implementation for a band matrix and three different computational layers for the second order Suzuki Trotter decomposition 800 according to an example of the instant disclosure.

In one example, the fourth order approximant (p=4), and the Suzuki Trotter decomposition relies on solving the following exponentials:

$$x \left(δ\right) = {e}^{A δ} =$$

$$\begin{matrix}= {e}^{\frac{s δ}{2} {A}_{o d d}} {e}^{s δ {A}_{e v e n}} {e}^{\frac{1 - s}{2} δ {A}_{o d d}} {e}^{\left(1 - 2 s\right) δ {A}_{e v e n}} {e}^{\frac{1 - s}{2} δ {A}_{o d d}} \\ {e}^{s δ {A}_{e v e n}} {e}^{\frac{s δ}{2} {A}_{o d d}} + o \left({δ}^{5}\right)\end{matrix}$$

$$\text{where} s = \frac{1}{2 - \sqrt[3]{2}} .$$

The methodology follows the same approach that has been employed to solve the second order approximant. The only difference is that in this case seven parallel processing layers instead of three can be used.

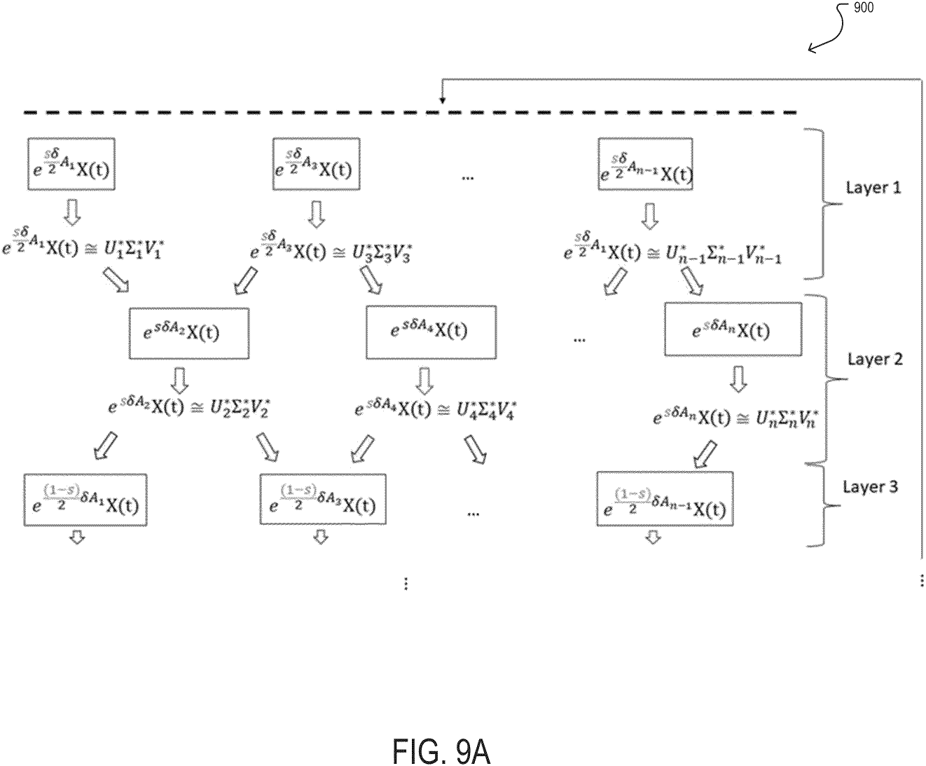

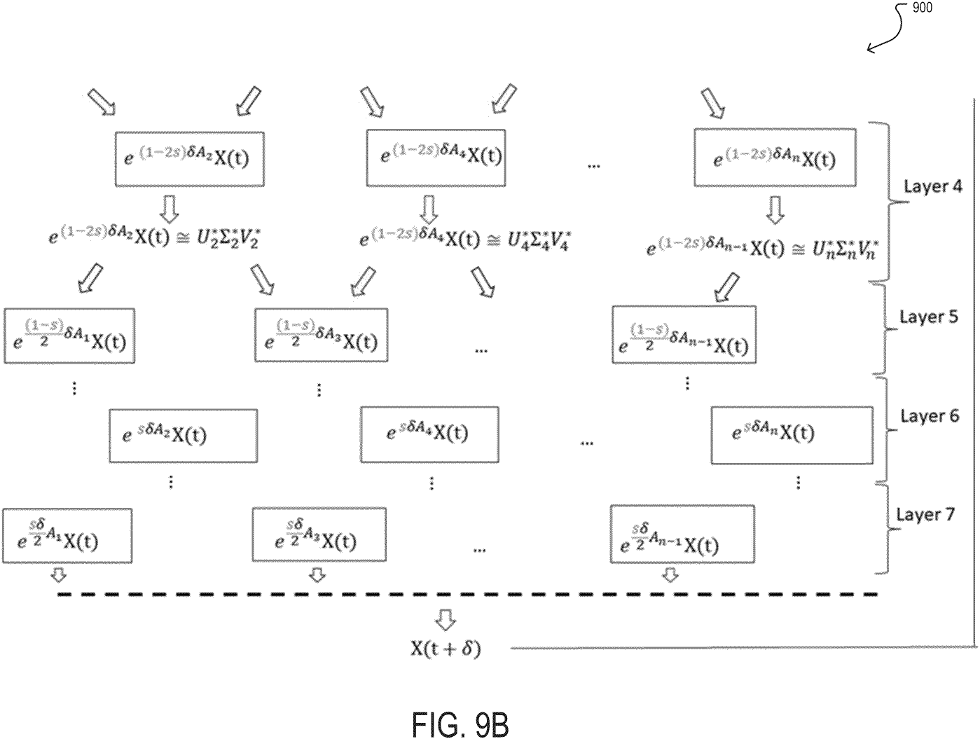

FIGS. 9A and 9B show a parallel implementation for a band matrix and seven different computational layers for the fourth order Suzuki Trotter decomposition 900 according to an example of the instant disclosure.

A does not have to be a band matrix. Rather, any matrix A can be used in the TEBD parallel implementation. However, there may be drawbacks associated with a possible increase of the number of connections between threads because data will be transferred between non-adjacent sites.

As an example, a matrix Aⱼ does not have to commute with adjacent indices matrices Aₖ, k = j±1 and A_{α} and A_{β} does not have to commute although β ≠ α±1. The hypothesis can be formally stated as: let A be a matrix that can be split as a sum of n addends denoted by A₁, A₂, ... A_{I}

$$A = {\sum }_{j = 1}^{I} {A}_{j} = {\sum }_{j o d d} {A}_{j} + {\sum }_{j e v e n} {A}_{j}$$

and Aⱼ does not commute with matrices having adjacent indices while it commutes with all the others except for the matrices having indexes a and β with a ∈ odd index, β ∈ even index

$$\left[{A}_{j} , {A}_{j - 1}\right] \neq 0 , \left[{A}_{j} , {A}_{j + 1}\right] \neq 0 , ∀ j ∈ \left\{1 , 2 , … n\right\}$$

$$\begin{matrix}… \left[{A}_{j} , {A}_{j - 3}\right] = 0 , \left[{A}_{j} , {A}_{j - 2}\right] = 0 , \left[{A}_{j} , {A}_{j + 2}\right] = 0 , \left[{A}_{j} , {A}_{j + 3}\right] = 0 , \\ … ∀ j ∈\end{matrix}$$

$$\left\{1 , 2 , … , I\right\}$$

$$\left[{A}_{α} , {A}_{β}\right] \neq 0 α ∈ o d d i n d e x , β ∈ e v e n i n d e x$$

In the first layer, thread_{a/2} holds the subtask to evaluate the SVD of the Suzuki Trotter decomposition’s term

$${e}^{\frac{δ}{2} {A}_{α}} X \left(0\right)$$

while thread_{β/2} and

$$t h r e a {d}_{\frac{β}{2} + 1}$$

the SVDs of

$${e}^{\frac{δ}{2} {A}_{β - 1}} X \left(0\right)$$

and

$${e}^{\frac{δ}{2} {A}_{β + 1}} X \left(0\right)$$

respectively.

In the second computational layer, focus is on the site Π_{β} in which data not only from the adjacent Π_{β-1} and Π_{β+1} but also from the site Π_{α}, are to be transferred to compute the following term:

$${e}^{δ {A}_{β}} {e}^{\frac{δ}{2} {A}_{β - 1}} X \left(0\right) {e}^{\frac{δ}{2} {A}_{β + 1}} X \left(0\right) {e}^{\frac{δ}{2} {A}_{α}} X \left(0\right) ≅$$

$${e}^{δ {A}_{β}} {U}_{β - 1}^{∗} {Σ}_{β - 1}^{∗} {V}_{β - 1}^{∗} {U}_{β + 1}^{∗} {Σ}_{β + 1}^{∗} {V}_{β + 1}^{∗} {U}_{α}^{∗} {Σ}_{α}^{∗} {V}_{α}^{∗}$$

The third layer is described next.

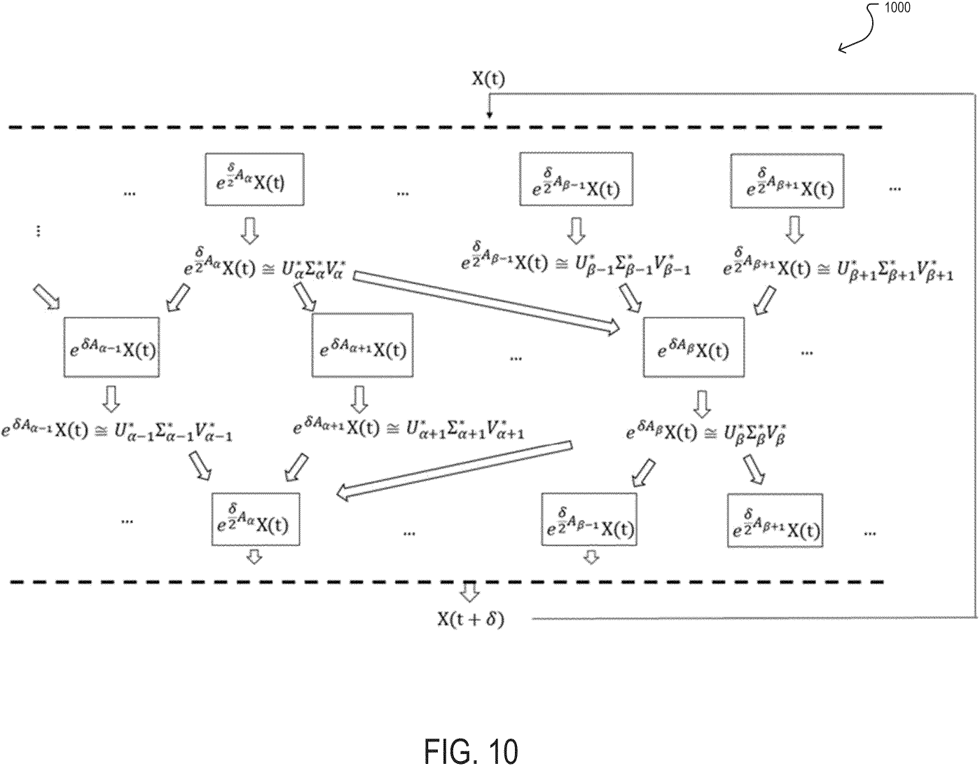

FIG. 10 shows a parallel implementation for any matrix A for the second order Suzuki Trotter decomposition 1000 according to an example of the instant disclosure.

As an example, the TEBD implementation can have A divided in any number of sets of non-commuting matrices.

In some cases, the state matrix A is a full matrix and therefore more than two sets of non-commuting matrices are to be determined.

A full matrix A

$$A = \left[\begin{matrix}{a}_{11} & {a}_{12} & ⋯ & {a}_{1 n} \\ {a}_{21} & {a}_{22} & ⋯ & {a}_{2 n} \\ ⋮ & ⋮ & ⋱ & ⋮ \\ {a}_{n 1} & {a}_{n 2} & ⋯ & {a}_{n n}\end{matrix}\right]$$

can be, for instance, partitioned in n matrices whose elements are zeros except the terms of a column:

$$\begin{matrix}{\text{A}}_{1} = \left[\begin{matrix}{\text{a}}_{\text{11}} & 0 & ⋯ & 0 \\ {\text{a}}_{\text{21}} & 0 & ⋯ & 0 \\ ⋮ & ⋮ & ⋱ & ⋮ \\ {\text{a}}_{\text{n1}} & 0 & ⋯ & 0\end{matrix}\right] , {\text{A}}_{2} = \left[\begin{matrix}0 & {\text{a}}_{\text{12}} & ⋯ & 0 \\ 0 & {\text{a}}_{\text{22}} & ⋯ & 0 \\ ⋮ & ⋮ & ⋱ & ⋮ \\ 0 & {\text{a}}_{\text{n2}} & ⋯ & 0\end{matrix}\right] \text{,} … {\text{A}}_{\text{n}} = \\ \left[\begin{matrix}0 & 0 & ⋯ & {\text{a}}_{1 \text{n}} \\ 0 & 0 & ⋯ & {\text{a}}_{\text{2n}} \\ ⋮ & ⋮ & ⋱ & ⋮ \\ 0 & 0 & ⋯ & {\text{a}}_{\text{nn}}\end{matrix}\right]\end{matrix}$$

$$\text{A =} {\sum }_{\text{i=1}}^{\text{n}} {\text{A}}_{\text{i}}$$

An approximant of e^{Ax} for a given order can be determined by using the fractal decomposition methods and other and optimal approximants can also be built by employing other techniques.

As an example, a second order approximant for only two sets A₁ and A₂ is given by:

$${S}_{2} \left(x\right) = {e}^{\frac{x}{2} {A}_{1}} {e}^{\frac{x}{2} {A}_{2}} {e}^{\frac{x}{2} {A}_{2}} {e}^{\frac{x}{2} {A}_{1}} = {e}^{\frac{x}{2} {A}_{1}} {e}^{x {A}_{2}} {e}^{\frac{x}{2} {A}_{1}}$$

For three sets A₁, A₂ and A₃ becomes

$${S}_{2} \left(x\right) = {e}^{\frac{x}{2} {A}_{1}} {e}^{\frac{x}{2} {A}_{2}} {e}^{\frac{x}{2} {A}_{3}} {e}^{\frac{x}{2} {A}_{3}} {e}^{\frac{x}{2} {A}_{2}} {e}^{\frac{x}{2} {A}_{1}} = {e}^{\frac{x}{2} {A}_{1}} {e}^{\frac{x}{2} {A}_{2}} {e}^{x {A}_{3}} {e}^{\frac{x}{2} {A}_{2}} {e}^{\frac{x}{2} {A}_{1}}$$

For any finite number of sets A₁, A₂, A₃, ... A_{I} it is possible toobtain

$${S}_{2} \left(x\right) = {e}^{\frac{x}{2} {A}_{1}} {e}^{\frac{x}{2} {A}_{2}} {e}^{\frac{x}{2} {A}_{3}} … {e}^{\frac{x}{2} {A}_{I}} {e}^{\frac{x}{2} {A}_{I}} … {e}^{\frac{x}{2} {A}_{3}} {e}^{\frac{x}{2} {A}_{2}} {e}^{\frac{x}{2} {A}_{1}} =$$

$$= {e}^{\frac{x}{2} {A}_{1}} {e}^{\frac{x}{2} {A}_{2}} {e}^{\frac{x}{2} {A}_{3}} … {e}^{x {A}_{I}} … {e}^{\frac{x}{2} {A}_{3}} {e}^{\frac{x}{2} {A}_{2}} {e}^{\frac{x}{2} {A}_{1}}$$

As an example, a four-order approximant for two matrices A₁ and A₂ is given by:

$${S}_{4} \left(x\right) = {S}_{2} \left(s x\right) {S}_{2} \left(1 - 2 s\right) {S}_{2} \left(s x\right) =$$

$$= {e}^{\frac{s x}{2} {A}_{1}} {e}^{s x {A}_{2}} {e}^{\frac{s x}{2} {A}_{1}} {e}^{\frac{\left(1 - 2 s\right) x}{2} {A}_{1}} {e}^{\left(1 - 2 s\right) x {A}_{2}} {e}^{\frac{\left(1 - 2 s\right) x}{2} {A}_{1}} {e}^{\frac{s x}{2} {A}_{1}} {e}^{s x {A}_{2}} {e}^{\frac{s x}{2} {A}_{1}} =$$

$$= {e}^{\frac{s x}{2} {A}_{1}} {e}^{s x {A}_{2}} {e}^{\frac{\left(1 - s\right) x}{2} {A}_{1}} {e}^{\left(1 - 2 s\right) x {A}_{2}} {e}^{\frac{\left(1 - s\right) x}{2} {A}_{1}} {e}^{s x {A}_{2}} {e}^{\frac{s x}{2} {A}_{1}}$$

$$\text{where} s = \frac{1}{2 - \sqrt[3]{2}} .$$

For three terms A₁, A₂ and A₃,:

$${S}_{4} \left(x\right) = {S}_{2} \left(s x\right) {S}_{2} \left(1 - 2 s\right) {S}_{2} \left(s x\right) =$$

$$\begin{matrix}= {e}^{\frac{s x}{2} {A}_{1}} {e}^{\frac{s x}{2} {A}_{2}} {e}^{s x {A}_{2}} {e}^{\frac{s x}{2} {A}_{2}} {e}^{\frac{s x}{2} {A}_{1}} {e}^{\frac{\left(1 - 2 s\right) x}{2} {A}_{1}} {e}^{\frac{\left(1 - 2 s\right) x}{2} {A}_{2}} {e}^{\left(1 - 2 s\right) x {A}_{2}} \\ {e}^{\frac{\left(1 - 2 s\right) x}{2} {A}_{2}} {e}^{\frac{\left(1 - 2 s\right) x}{2} {A}_{1}} .\end{matrix}$$

$$⋅ {e}^{\frac{s x}{2} {A}_{1}} {e}^{\frac{s x}{2} {A}_{2}} {e}^{{}^{s x {A}_{3}}} {e}^{\frac{s x}{2} {A}_{2}} {e}^{\frac{s x}{2} {A}_{1}} =$$

$$= {e}^{\frac{s x}{2} {A}_{1}} {e}^{\frac{s x}{2} {A}_{2}} {e}^{s x {A}_{3}} {e}^{\frac{s x}{2} {A}_{2}} {e}^{\frac{\left(1 - s\right) x}{2} {A}_{1}} {e}^{\frac{\left(1 - 2 s\right) x}{2} {A}_{2}} {e}^{\left(1 - 2 s\right) x {A}_{3}} ⋅$$

$$⋅ {e}^{\frac{\left(1 - 2 s\right) x}{2} {A}_{2}} {e}^{{}^{{}^{{}^{\frac{\left(1 - s\right) x}{2} {A}_{1}}}}} {e}^{\frac{s x}{2} {A}_{2}} {e}^{{}^{{}^{{}^{s x {A}_{3}}}}} {e}^{\frac{s x}{2} {A}_{2}} {e}^{{}^{{}^{\frac{s x}{2} {A}_{1}}}}$$

For an arbitrary finite number of sets A₁, A₂, A₃, ... A_{I},

$${S}_{4} \left(x\right) = {S}_{2} \left(s x\right) {S}_{2} \left(1 - 2 s\right) {S}_{2} \left(s x\right) =$$

$$\begin{matrix}= {e}^{\frac{s x}{2} {A}_{1}} {e}^{\frac{s x}{2} {A}_{2}} … {e}^{s x {A}_{I}} … {e}^{\frac{s x}{2} {A}_{2}} {e}^{\frac{s c}{2} {A}_{1}} {e}^{\frac{\left(1 - 2 s\right) x}{2} {A}_{2}} \\ {e}^{\frac{\left(1 - 2 s\right) x}{2} {A}_{2}} … {e}^{\left(1 - 2 s\right) x {A}_{i}} {…}^{.}\end{matrix}$$

$${}^{.} … {e}^{\frac{\left(1 - 2 s\right) x}{2} {A}_{2}} {e}^{{}^{{}^{{}^{{}^{\frac{\left(1 - 2 s\right) x}{2} {A}_{1}}}}}} {e}^{\frac{s x}{2} {A}_{1}} {e}^{\frac{s x}{2} {A}_{2}} … {e}^{{}^{{}^{{}^{{}^{s x {A}_{I}}}}}} … {e}^{\frac{s x}{2} {A}_{2}} {e}^{{}^{{}^{{}^{\frac{s x}{2} {A}_{1}}}}} =$$

$$= {e}^{\frac{s x}{2} {A}_{1}} {e}^{\frac{s x}{2} {A}_{2}} … {e}^{s x {A}_{I}} {e}^{\frac{s x}{2} {A}_{2}} {e}^{\frac{\left(1 - s\right) x}{2} {A}_{1}} {e}^{\frac{\left(1 - 2 s\right) x}{2} {A}_{2}} … {e}^{\left(1 - 2 s\right) x {A}_{I}} …$$

$$⋅ … {e}^{\frac{\left(1 - 2 s\right) x}{1} {A}_{2}} {e}^{{}^{{}^{{}^{\frac{\left(1 - s\right) x}{2} {A}_{1}}}}} {e}^{\frac{s x}{2} {A}_{2}} … {e}^{{}^{{}^{{}^{s x {A}_{I}}}}} … {e}^{\frac{s x}{2} {A}_{2}} {e}^{{}^{{}^{{}^{\frac{s x}{2} {A}_{1}}}}}$$

Another example of four-order approximation is given by the following expression:

$${S}_{4} \left(x\right) = {S}_{2} {\left({s}_{2} x\right)}^{2} {S}_{2} \left(\left(1 - 4 {s}_{2}\right) x\right) {S}_{2} {\left({s}_{2} x\right)}^{2} =$$

$$\begin{matrix}= {e}^{\frac{{s}_{2} x}{2} {A}_{1}} {e}^{{s}_{2} x {A}_{2}} {e}^{\frac{{s}_{2} s}{2} {A}_{1}} {e}^{\frac{{s}_{2} x}{2} {A}_{1}} {e}^{{s}_{2} x {A}_{2}} {e}^{\frac{{s}_{2} x}{2} {A}_{1}} {e}^{\frac{\left(1 - 4 {s}_{2}\right) x}{2} {A}_{1}} \\ {e}^{\left(1 - 4 {s}_{2}\right) x {A}_{2}} {e}^{\frac{\left(1 - 4 {s}_{2}\right) x}{2} {A}_{1}} ⋅\end{matrix}$$

$$⋅ {e}^{\frac{{s}_{2} x}{2} {A}_{1}} {e}^{{s}_{2} x {A}_{z}} {e}^{\frac{{s}_{2} x}{2} {A}_{1}} {e}^{\frac{{s}_{2} x}{2} {A}_{1}} {e}^{{s}_{2} x {A}_{z}} {e}^{\frac{{s}_{2} x}{2} {A}_{1}} =$$

$$= {e}^{\frac{{s}_{2} x}{2} {A}_{1}} {e}^{{s}_{2} x {A}_{2}} {e}^{{s}_{2} x {A}_{1}} {e}^{{s}_{2} x {A}_{2}} {e}^{\frac{\left(1 - 3 {s}_{2}\right) x}{2}} {e}^{\left(1 - 4 {s}_{2}\right) x {A}_{2}} {e}^{\frac{\left(1 - 3 {s}_{2}\right) x}{2} {A}_{1}} ⋅$$

$$⋅ {e}^{{s}_{2} x {A}_{2}} {e}^{{s}_{2} x {A}_{1}} {e}^{{s}_{2} x {A}_{2}} {e}^{\frac{{s}_{2} x}{2} {A}_{1}}$$

$$\text{where} {s}_{2} = \frac{1}{4 - \sqrt[3]{4}} .$$

For example, if three terms A₁, A₂ and A₃:

$${S}_{4} \left(x\right) = {S}_{2} {\left({s}_{2} x\right)}^{2} {S}_{2} \left(\left(1 - 4 {s}_{2}\right) x\right) {S}_{2} {\left({s}_{2} x\right)}^{2} =$$

$$= {e}^{\frac{{s}_{2} x}{2} {A}_{1}} {e}^{\frac{{s}_{2} x}{2} {A}_{2}} {e}^{{s}_{2} x {A}_{3}} {e}^{\frac{{s}_{2} x}{2} {A}_{2}} {e}^{\frac{{s}_{2} x}{2} {A}_{1}} {e}^{\frac{{s}_{2} x}{2} {A}_{1}} {e}^{\frac{{s}_{2} x}{2} {A}_{2}} {e}^{{s}_{2} x {A}_{3}} {e}^{\frac{{s}_{2} x}{2} {A}_{2}} {e}^{\frac{{s}_{2} x}{2} {A}_{1}} ⋅$$

$$⋅ {e}^{\frac{\left(1 - 4 {s}_{2}\right) x}{2} {A}_{1}} {e}^{\frac{\left(1 - 4 {s}_{2}\right) x}{2} {A}_{2}} {e}^{\left(1 - 4 {s}_{2}\right) x {A}_{3}} {e}^{\frac{\left(1 - 4 {s}_{2}\right) x}{2} {A}_{2}} {e}^{\frac{\left(1 - 4 {s}_{2}\right) x}{2} {A}_{1}} ⋅$$

$$⋅ {e}^{\frac{{s}_{2} x}{2} {A}_{1}} {e}^{\frac{{s}_{2} x}{2} {A}_{2}} {e}^{{s}_{2} x {A}_{3}} {e}^{\frac{{s}_{2} x}{2} {A}_{2}} {e}^{\frac{{s}_{2} x}{2} {A}_{1}} {e}^{\frac{{s}_{2} x}{2} {A}_{1}} {e}^{\frac{{s}_{2} x}{2} {A}_{2}} {e}^{{s}_{2} x {A}_{3}} {e}^{\frac{{s}_{2} x}{2} {A}_{2}} {e}^{\frac{{s}_{2} x}{2} {A}_{1}} =$$

$$\begin{matrix}= \\ \begin{matrix}{e}^{\frac{{s}_{2} x}{2} {A}_{1}} {e}^{\frac{{s}_{2} x}{2} {A}_{2}} {e}^{{s}_{2} x {A}_{3}} {e}^{\frac{{s}_{2} x}{2} {A}_{2}} {e}^{{s}_{2} x {A}_{1}} {e}^{\frac{{s}_{2} x}{2} {A}_{1}} {e}^{{s}_{2} x {A}_{3}} \\ {e}^{\frac{{s}_{2} x}{2} {A}_{2}} {e}^{\frac{\left(1 - 3 {s}_{2}\right) x}{2} {A}_{1}} {e}^{\frac{\left(1 - 4 {s}_{2}\right) x}{2} {A}_{2}} {e}^{\left(1 - 4 {s}_{2}\right) x {A}_{3}} .\end{matrix}\end{matrix}$$

$$\begin{matrix}⋅ {e}^{\frac{\left(1 - 4 {s}_{2}\right) x}{2} {A}_{2}} {e}^{\frac{\left(1 - 4 {s}_{2}\right) x}{2} {A}_{1}} {e}^{\frac{{s}_{2} x}{2} {A}_{2}} {e}^{{s}_{2} x {A}_{3}} {e}^{\frac{{s}_{2} x}{2} {A}_{2}} {e}^{{S}_{2} x {A}_{1}} {e}^{\frac{{s}_{2} x}{2} {A}_{2}} {e}^{{s}_{2} x {A}_{3}} \\ {e}^{\frac{{s}_{2} x}{2} {A}_{2}} {e}^{\frac{{s}_{2} x}{2} {A}_{1}}\end{matrix}$$

For any finite number of sets A₁, A₂, A₃, ... A_{I}

$${S}_{4} \left(x\right) = {S}_{2} {\left({s}_{2} x\right)}^{2} {S}_{2} \left(\left(1 - 4 {s}_{2}\right) x\right) {S}_{2} {\left({s}_{2} x\right)}^{2} =$$

$$\begin{matrix}= {e}^{\frac{{s}_{2} x}{2} {A}_{1}} {e}^{\frac{{s}_{2} x}{2} {A}_{2}} … {e}^{{s}_{2} x {A}_{1}} … {e}^{\frac{{s}_{2} x}{2} {A}_{2}} {e}^{\frac{{s}_{2} x}{2} {A}_{1}} {e}^{\frac{{s}_{2} x}{2} {A}_{1}} {e}^{\frac{{s}_{2} x}{2} {A}_{2}} \\ … {e}^{{s}_{2} x {A}_{I}} … {e}^{\frac{{s}_{2} x}{2} {A}_{2}} {e}^{\frac{{s}_{2} x}{2} {A}_{1}} ⋅\end{matrix}$$

$$⋅ {e}^{\frac{\left(1 - 4 {s}_{2}\right) x}{1} {A}_{1}} {e}^{\frac{\left(1 - 4 {s}_{2}\right) x}{2} {A}_{2}} … {e}^{\left(1 - 4 {s}_{2}\right) x {A}_{I}} … {e}^{\frac{\left(1 - 2 {s}_{2}\right) x}{2} {A}_{2}} {e}^{\frac{\left(1 - 4 {s}_{2}\right) x}{2} {A}_{1}} ⋅$$

$$\begin{matrix}⋅ {e}^{\frac{{s}_{2} x}{2} {A}_{1}} {e}^{\frac{{s}_{2} x}{2} {A}_{2}} … {e}^{{s}_{2} x {A}_{I}} … {e}^{\frac{{s}_{2} x}{2} {A}_{2}} {e}^{\frac{{s}_{2} x}{2} {A}_{1}} {e}^{\frac{{s}_{2} x}{2} {A}_{1}} {e}^{\frac{{s}_{2} x}{2} {A}_{2}} \\ … {e}^{{s}_{2} x {A}_{I}} … {e}^{\frac{{s}_{2} x}{2} {A}_{2}} {e}^{\frac{{s}_{2} x}{2} {A}_{1}} =\end{matrix}$$

$$= {e}^{\frac{{s}_{2} x}{2} {A}_{1}} {e}^{\frac{{s}_{2} x}{2} {A}_{2}} … {e}^{{s}_{2} x {A}_{I}} … {e}^{\frac{{s}_{2} x}{2} {A}_{2}} {e}^{{s}_{2} x {A}_{2}} {e}^{\frac{{s}_{2} x}{2} {A}_{2}} … {e}^{{s}_{2} x {A}_{I}} … {e}^{\frac{{s}_{2} x}{2} {A}_{2}} ⋅$$

$$⋅ {e}^{\frac{\left(1 - 3 {s}_{2}\right) x}{2} {A}_{1}} {e}^{\frac{\left(1 - 4 {s}_{2}\right) x}{2} {A}_{2}} … {e}^{\left(1 - 4 {s}_{2}\right) x {A}_{I}} … {e}^{\frac{\left(1 - 4 {s}_{2}\right) x}{2} {A}_{2}} {e}^{\frac{\left(1 - 3 {s}_{2}\right) x}{2} {A}_{1}} ⋅$$

$$⋅ {e}^{\frac{{s}_{2} x}{2} {A}_{2}} … {e}^{{s}_{2} x {A}_{I}} … {e}^{\frac{{s}_{2} x}{2} {A}_{2}} {e}^{{s}_{2} x {A}_{1}} {e}^{\frac{{s}_{2} x}{2} {A}_{2}} … {e}^{{s}_{2} x {A}_{I}} … {e}^{\frac{{s}_{2} x}{2} {A}_{2}} {e}^{\frac{{s}_{2} x}{2} {A}_{1}}$$

As an example, for any finite number of sets A₁, A₂, ..., A_{I}, the sixth order approximant is given by:

$${S}_{6} \left(x\right) = {S}_{4} {\left({s}_{4} x\right)}^{2} {S}_{4} \left(\left(1 - 4 {s}_{4}\right) x\right) {S}_{4} {\left({s}_{4} x\right)}^{2} =$$

$$= \left({e}^{\frac{{s}_{2} {s}_{4} x}{2} {A}_{1}}\right) {e}^{\frac{{s}_{2} {s}_{4} x}{2} {A}_{2}} … {e}^{{s}_{2} {s}_{x} x {A}_{I}} … {e}^{\frac{{s}_{2} {s}_{4} x}{2} {A}_{2}} {e}^{\frac{{s}_{2} {s}_{4} x}{2} {A}_{1}} ⋅$$

$$⋅ {e}^{\frac{{s}_{2} {s}_{4} x}{2} {A}_{1}} {e}^{\frac{{s}_{2} {s}_{4} x}{2} {A}_{2}} … {e}^{{s}_{2} {s}_{4} x {A}_{I}} … {e}^{\frac{{s}_{2} {s}_{4} x}{2} {A}_{2}} {e}^{\frac{{s}_{2} {s}_{4} x}{2} {A}_{1}} ⋅$$

$$\begin{matrix}⋅ {e}^{\frac{\left(1 - 4 {s}_{2}\right) {s}_{4} x}{2} {A}_{1}} {e}^{\frac{\left(1 - 4 {s}_{2}\right) {s}_{4} x}{2} {A}_{2}} … {e}^{\left(1 - 4 {s}_{2}\right) {s}_{4} x {A}_{I}} … \\ {e}^{\frac{\left(1 - 4 {s}_{2}\right) {s}_{4} x}{2} {A}_{2}} {e}^{\frac{\left(1 - 4 {s}_{2}\right) {s}_{4} x}{2} {A}_{1}} ⋅\end{matrix}$$

$$⋅ {e}^{\frac{{s}_{2} {s}_{4} x}{2} {A}_{1}} {e}^{\frac{{s}_{2} {s}_{4} x}{2} {A}_{2}} … {e}^{{}^{{s}_{2} {s}_{4} x {A}_{I}}} … {e}^{\frac{{s}_{2} {s}_{4} x}{2} {A}_{2}} {e}^{\frac{{s}_{2} {s}_{4} x}{2} {A}_{1}} ⋅$$

$$⋅ {\left({e}^{\frac{{s}_{2} {s}_{4} x}{2} {A}_{1}} {e}^{\frac{{s}_{2} {s}_{4} x}{2} {A}_{2}} … {e}^{{s}_{2} {s}_{4} x {A}_{I}} … {e}^{\frac{{s}_{2} {s}_{4} x}{2} {A}_{2}} {e}^{\frac{{s}_{2 {s}_{4}} x}{2} {A}_{1}}\right)}^{2} ⋅$$

$$⋅ {e}^{\frac{{s}_{2} \left(1 - 4 {s}_{4}\right) x}{2} {A}_{1}} {e}^{\frac{{s}_{2} \left(1 - 4 {s}_{4}\right) x}{2} {A}_{2}} … {e}^{{s}_{2} \left(1 - 4 {s}_{4}\right) x {A}_{I}} … {e}^{\frac{{s}_{2} \left(1 - 4 {s}_{4}\right) x}{2} {A}_{2}} {e}^{\frac{{s}_{2} \left(1 - 4 {s}_{4}\right) x}{2} {A}_{1} .}$$

$$⋅ {e}^{\frac{{s}_{2} \left(1 - 4 {s}_{4}\right) x}{2} {A}_{1}} {e}^{\frac{{s}_{2} \left(1 - 4 {s}_{4}\right) x}{2} {A}_{2}} … {e}^{{s}_{2} \left(1 - 4 {s}_{4}\right) x {A}_{I}} … {e}^{\frac{{s}_{2} \left(1 - 4 {s}_{4}\right) x}{2} {A}_{2}} {e}^{\frac{{s}_{2} \left(1 - 4 {s}_{4}\right) x}{2} {A}_{1} .}$$

$$⋅ {e}^{\frac{\left(1 - 4 {s}_{2}\right) \left(1 - 4 {s}_{4}\right) x}{2} {A}_{1}} {e}^{\frac{\left(1 - 4 {s}_{2}\right) \left(1 - 4 {s}_{4}\right) x}{2} {A}_{2}} … ⋅$$

$$⋅ … {e}^{\left(1 - 4 {s}_{2}\right) \left(1 - 4 {s}_{4}\right) x {A}_{I}} … {e}^{\frac{\left(1 - 4 {s}_{2}\right) \left(1 - 4 {s}_{4}\right) x}{2} {A}_{1}} {e}^{\frac{\left(1 - 4 {s}_{2}\right) \left(1 - 4 {s}_{4}\right) x}{2} {A}_{2} .}$$

$$⋅ {e}^{\frac{{s}_{2} \left(1 - 4 {s}_{4}\right) x}{2} {A}_{1}} {e}^{\frac{{s}_{2} \left(1 - 4 {s}_{4}\right) x}{2} {A}_{2}} … {e}^{{s}_{2} \left(1 - 4 {s}_{4}\right) x {A}_{I}} … {e}^{\frac{{s}_{2} \left(1 - 4 {s}_{4}\right) x}{2} {A}_{2}} {e}^{\frac{{s}_{2} \left(1 - 4 {s}_{4}\right) x}{2} {A}_{1} .}$$

$$⋅ {e}^{\frac{{s}_{2} \left(1 - 4 {s}_{4}\right) x}{2} {A}_{1}} {e}^{\frac{{s}_{2} \left(1 - 4 {s}_{4}\right) x}{2} {A}_{2}} … {e}^{{s}_{2} \left(1 - 4 {s}_{4}\right) x {A}_{I}} … {e}^{\frac{{s}_{2} \left(1 - 4 {s}_{4}\right) x}{2} {A}_{2}} {e}^{\frac{{s}_{2} \left(1 - 4 {s}_{4}\right) x}{2} {A}_{1} .}$$

$$⋅ \left({e}^{\frac{{s}_{2} {s}_{4} x}{2} {A}_{1}} {e}^{\frac{{s}_{2} {s}_{4} x}{2} {A}_{2}} … {e}^{{s}_{2} {s}_{4} x {A}_{I}} … {e}^{\frac{{s}_{2} {s}_{4} x}{2} {A}_{2}} {e}^{\frac{{s}_{2} {s}_{4} x}{2} {A}_{1}} ⋅\right)$$

$$⋅ {e}^{\frac{{s}_{2} {s}_{4} x}{2} {A}_{1}} {e}^{\frac{{s}_{2} {s}_{4} x}{2} {A}_{2}} … {e}^{{s}_{2} {s}_{4} x {A}_{I}} … {e}^{\frac{{s}_{2} {s}_{4} x}{2} {A}_{2}} {e}^{\frac{{s}_{2} {s}_{4} x}{2} {A}_{1}} ⋅$$

$$⋅ {e}^{\frac{\left(1 - 4 {s}_{2}\right) {s}_{4} x}{2} {A}_{1}} {e}^{\frac{\left(1 - 4 {s}_{2}\right) {s}_{4} x}{2} {A}_{2}} … {e}^{\left(1 - 4 {s}_{2}\right) {s}_{4} x {A}_{I}} … {e}^{\frac{\left(1 - 4 {s}_{2}\right) {s}_{4} x}{2} {A}_{2}} {e}^{\frac{\left(1 - 4 {s}_{2}\right) {s}_{4} x}{2} {A}_{1}} ⋅$$

$$⋅ {e}^{\frac{{s}_{2} {s}_{4} x}{2} {A}_{1}} {e}^{\frac{{s}_{2} {s}_{4} x}{2} {A}_{2}} … {e}^{{s}_{2} {s}_{4} x {A}_{I}} … {e}^{\frac{{s}_{2} {s}_{4} x}{2} {A}_{2}} {e}^{\frac{{s}_{2} {s}_{4} x}{2} {A}_{1}} .$$

$$\begin{matrix}{\left(⋅ {e}^{\frac{{s}_{2} {s}_{4} x}{2} {A}_{1}} {e}^{\frac{{s}_{2} {s}_{4} x}{2} {A}_{2}} … {e}^{{s}_{2} {s}_{4} x {A}_{I}} … {e}^{\frac{{s}_{2} {s}_{4} x}{2} {A}_{2}} {e}^{\frac{{s}_{2 {s}_{4}} x}{2} {A}_{1}}\right)}^{2} . \\ \text{with} {s}_{4} = \frac{1}{5 - \sqrt[5]{4}} .\end{matrix}$$

The eight-order approximant is given by:

$$\begin{matrix}{S}_{8} \left(x\right) = {S}_{6} {\left({s}_{6} x\right)}^{2} {S}_{6} \left(\left(1 - 4 {s}_{6}\right) x\right) {S}_{6} {\left({s}_{6} x\right)}^{2} \\ \text{with} {s}_{6} = \frac{1}{4 - \sqrt[7]{4}} .\end{matrix}$$

In one example, parallel implementation may be achieved using Suzuki Trotter expansion. The advantage concerning the parallel implementations is that the exponential approximant terms of the Suzuki Trotter expansion (e.g.

$$\left({e}^{\frac{x}{2} {A}_{1}} {e}^{\frac{x}{2} {A}_{2}} {e}^{\frac{x}{2} {A}_{3}} … {e}^{x {A}_{I}} …\right)$$

are constant with respect to the time and they can therefore be computed only once at the beginning of the processing, e.g., offline.

However, the disadvantage may be that all the sites are connected since the state matrix is full and consequently, network links between all the computing elements may be used to transfer data among sites.

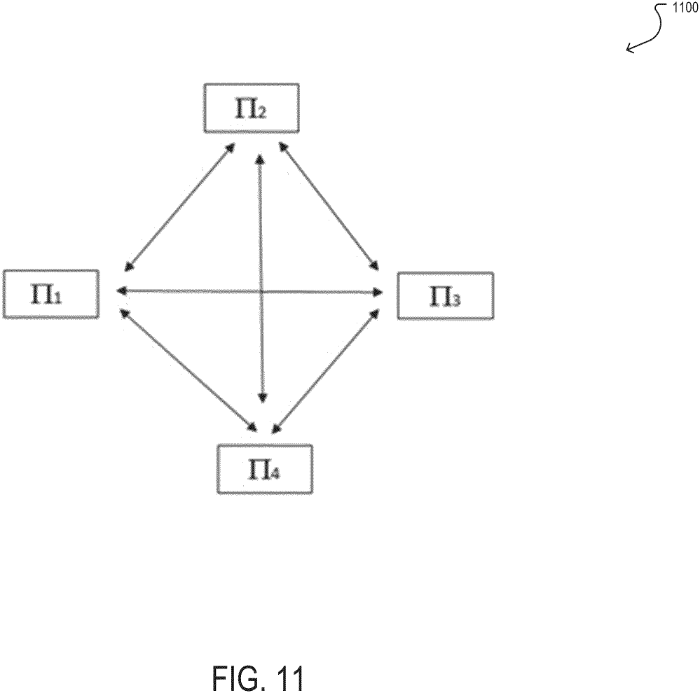

FIG. 11 shows an example of connections of a full matrix characterizing four sites 1100 according to an example of the instant disclosure.

In one example, the system may perform Suzuki Trotter expansion and use distributed algorithms for matrix exponentials. If the matrix A is very large, the calculation of the exponential approximant terms (e.g.

$$\left({e}^{\frac{x}{2} {A}_{1}} {e}^{\frac{x}{2} {A}_{2}} {e}^{\frac{x}{2} {A}_{3}} … {e}^{x {A}_{I}} …\right)$$

can be time intensive although they have to be computed only once at the beginning of the processing.

To address this issue, a hybrid methodology can be implemented to reduce the number of the exponential approximant terms and can rely on employing the Suzuki Trotter expansion together with any other algorithm that is able to compute the exponential of matrices in parallel such as the classical matrix diagonalization techniques based on eigenvectors.

For instance, a full matrix A (can be a 4×4 matrix):

$$A = \left[\begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix}\right]$$

can be partitioned in the following four-square submatrices

$${A}_{1} = \left[\begin{matrix}{a}_{11} & {a}_{12} & 0 & 0 \\ {a}_{21} & {a}_{22} & 0 & 0 \\ 0 & 0 & 0 & 0 \\ 0 & 0 & 0 & 0\end{matrix}\right] , {A}_{2} = \left[\begin{matrix}0 & 0 & {a}_{13} & {a}_{14} \\ 0 & 0 & {a}_{23} & {a}_{24} \\ 0 & 0 & 0 & 0 \\ 0 & 0 & 0 & 0\end{matrix}\right]$$

$${A}_{3} = \left[\begin{matrix}0 & 0 & 0 & 0 \\ 0 & 0 & 0 & 0 \\ {a}_{31} & {a}_{32} & 0 & 0 \\ {a}_{41} & {a}_{42} & 0 & 0\end{matrix}\right] , {A}_{4} = \left[\begin{matrix}0 & 0 & 0 & 0 \\ 0 & 0 & 0 & 0 \\ 0 & 0 & {a}_{33} & {a}_{34} \\ 0 & 0 & {a}_{43} & {a}_{44}\end{matrix}\right]$$

$$A = {\sum }_{i = 1}^{4} {A}_{i} .$$

Thus, as an example, there is a Suzuki Trotter expansion with only four terms. If a second order approximant is considered:

$${S}_{2} \left(x\right) = {e}^{\frac{x}{2} {A}_{1}} {e}^{\frac{x}{2} {A}_{2}} {e}^{\frac{x}{2} {A}_{3}} {e}^{x {A}_{4}} {e}^{\frac{x}{2} {A}_{3}} {e}^{\frac{x}{2} {A}_{2}} {e}^{\frac{x}{2} {A}_{1}}$$

Noting that

$${A}_{2}^{2} = 0 , … {A}_{2}^{n} = {A}_{2}^{n - 2} {A}_{2}^{2} = 0 ,$$

... and therefore also

$${A}_{3}^{2} = 0 , … {A}_{3}^{n} =$$

0, ..., the following equalities can be obtained:

$${e}^{\frac{x}{2} {A}_{2}} = I + \frac{x}{2} {A}_{2} + \frac{1}{2 !} {\left(\frac{x}{2} {A}_{2}\right)}^{2} + ⋯ \frac{1}{n !} {\left(\frac{x}{2} {A}_{2}\right)}^{n} + ⋯ = I + \frac{x}{2} {A}_{2}$$

$${e}^{\frac{x}{2} {A}_{3}} = I + \frac{x}{2} {A}_{3}$$

where I is the identity matrix. The expression for S₂ (x) simplifies to:

$${S}_{2} \left(x\right) = {e}^{\frac{x}{2} {A}_{1}} \left(I + \frac{x}{2} {A}_{2}\right) \left(I + \frac{x}{2} {A}_{3}\right) {e}^{x {A}_{4}} \left(I + \frac{x}{2} {A}_{3}\right) \left(I + \frac{x}{2} {A}_{2}\right) {e}^{\frac{x}{2} {A}_{1}}$$

The terms

$${e}^{\frac{x}{2} {A}_{1}}$$

and e^{xA}⁴ can be computed on a distributed manner using algorithms such as for instance the Lanczos algorithm.

As an example, an 8×8 matrix can be:

$$A = \left[\begin{matrix}{a}_{11} & {a}_{12} & {a}_{13} & {a}_{14} & ⋯ & {a}_{18} \\ {a}_{21} & {a}_{22} & {a}_{23} & {a}_{24} & ⋯ & {a}_{28} \\ {a}_{31} & {a}_{32} & {a}_{33} & {a}_{34} & ⋯ & {a}_{38} \\ {a}_{41} & {a}_{42} & {a}_{43} & {a}_{44} & ⋯ & {a}_{48} \\ ⋮ & ⋮ & ⋮ & ⋮ & ⋱ & ⋮ \\ {a}_{81} & {a}_{82} & {a}_{83} & {a}_{84} & ⋯ & {a}_{88}\end{matrix}\right]$$

And it can be partitioned in sixteen matrices:

$${A}_{11} = \left[\begin{matrix}{a}_{11} & {a}_{12} & ⋯ & 0 \\ {a}_{21} & {a}_{22} & ⋯ & 0 \\ ⋮ & ⋮ & ⋱ & ⋮ \\ 0 & 0 & ⋯ & 0\end{matrix}\right] , {A}_{12} = \left[\begin{matrix}0 & 0 & {a}_{13} & {a}_{14} & ⋯ & 0 \\ 0 & 0 & {a}_{23} & {a}_{24} & ⋯ & 0 \\ ⋮ & ⋮ & ⋮ & ⋮ & ⋱ & ⋮ \\ 0 & 0 & 0 & 0 & ⋯ & 0\end{matrix}\right] ,$$

$${A}_{13} = \left[\begin{matrix}0 & ⋯ & {a}_{15} & {a}_{16} & 0 & 0 \\ 0 & ⋯ & {a}_{25} & {a}_{26} & 0 & 0 \\ ⋮ & ⋱ & ⋮ & ⋮ & ⋮ & ⋮ \\ 0 & ⋯ & 0 & 0 & 0 & 0\end{matrix}\right] , {A}_{14} = \left[\begin{matrix}0 & ⋯ & {a}_{17} & {a}_{18} \\ 0 & ⋯ & {a}_{27} & {a}_{28} \\ ⋮ & ⋱ & ⋮ & ⋮ \\ 0 & ⋯ & 0 & 0\end{matrix}\right]$$

$${A}_{43} = \left[\begin{matrix}0 & ⋯ & 0 & 0 & 0 & 0 \\ ⋮ & ⋱ & ⋮ & ⋮ & ⋮ & ⋮ \\ 0 & ⋯ & {a}_{75} & {a}_{76} & 0 & 0 \\ 0 & ⋯ & {a}_{85} & {a}_{86} & 0 & 0\end{matrix}\right] , {A}_{44} = \left[\begin{matrix}0 & ⋯ & 0 & 0 \\ ⋮ & ⋱ & ⋮ & ⋮ \\ 0 & ⋯ & {a}_{77} & {a}_{78} \\ 0 & ⋯ & {a}_{87} & {a}_{88}\end{matrix}\right]$$

A can be equal to the sum of all the sixteen matrices Noting that:

$${A}_{i j}^{2} = 0 , … , {A}_{i j}^{n} = 0 ∀ i \neq j ,$$

The following equalities can be determined:

$${e}^{\frac{x}{2} {A}_{12}} = I + \frac{x}{2} {A}_{12}$$

$$\begin{matrix}{e}^{\frac{x}{2} {A}_{13}} = I + \frac{x}{2} {A}_{13} \\ ⋮\end{matrix}$$

$${e}^{\frac{x}{2} {A}_{i j}} = I + \frac{x}{2} {A}_{i j} ∀ i \neq j$$

The second order approximant is given by the following product

$${S}_{2} \left(x\right) = {e}^{\frac{x}{2} {A}_{11}} {e}^{\frac{x}{2} {A}_{12}} {e}^{\frac{x}{2} {A}_{13}} … {e}^{x {A}_{44}} … {e}^{\frac{x}{2} {A}_{13}} {e}^{\frac{x}{2} {A}_{12}} {e}^{\frac{x}{2} {A}_{11}} =$$

$$\begin{matrix}= {e}^{\frac{x}{2} {A}_{11}} \left(I + \frac{x}{2} {A}_{12}\right) \left(I + \frac{x}{2} {A}_{13}\right) … {e}^{x {A}_{44}} … \\ \left(I + \frac{x}{2} {A}_{13}\right) \left(I + \frac{x}{2} {A}_{12}\right) {e}^{\frac{x}{2} {A}_{11}}\end{matrix}$$

casein one example, let Bᵢⱼ a matrix of size p × k such as

$${B}_{i j} = \left[\begin{matrix}{b}_{11} & {b}_{12} & ⋯ & {b}_{1 k} \\ {b}_{21} & {b}_{22} & ⋯ & {b}_{2 k} \\ ⋮ & ⋮ & ⋱ & ⋮ \\ {b}_{p 1} & {b}_{p 2} & ⋯ & {b}_{p k}\end{matrix}\right]$$

In general, a matrix A can be partitioned in many submatrices A₁₁, A₂₁,... Aₙₘ such as

$${A}_{11} = \left[\begin{matrix}{B}_{11} & 0 & ⋯ & 0 \\ 0 & 0 & ⋯ & 0 \\ ⋮ & ⋮ & ⋱ & ⋮ \\ 0 & 0 & ⋯ & 0\end{matrix}\right] , {A}_{12} = \left[\begin{matrix}0 & {B}_{12} & ⋯ & 0 \\ 0 & 0 & ⋯ & 0 \\ ⋮ & ⋮ & ⋱ & ⋮ \\ 0 & 0 & ⋯ & 0\end{matrix}\right]$$

$${A}_{n m} = \left[\begin{matrix}0 & 0 & ⋯ & 0 \\ 0 & 0 & ⋯ & 0 \\ ⋮ & ⋮ & ⋱ & ⋮ \\ 0 & 0 & ⋯ & {B}_{n m}\end{matrix}\right] .$$

With this partition, the sum of the matrices Aᵢⱼ gives the matrix A

$$A = {\sum }_{i = 1}^{n} {\sum }_{j = 1}^{m} {A}_{i j} .$$

Analogously, the second order approximant is given by:

$${S}_{2} \left(x\right) = {e}^{\frac{x}{2} {A}_{11}} {e}^{\frac{x}{2} {A}_{12}} {e}^{\frac{x}{2} {A}_{13}} … {e}^{\frac{x}{2} {A}_{n m}} … {e}^{\frac{x}{2} {A}_{13}} {e}^{\frac{x}{2} {A}_{12}} {e}^{\frac{x}{2} {A}_{11}} =$$

$$\begin{matrix}= {e}^{\frac{x}{2} {A}_{11}} \left(I + \frac{x}{2} {A}_{12}\right) \left(I + \frac{x}{2} {A}_{13}\right) … {e}^{x {A}_{n m}} … \\ \left(I + \frac{x}{2} {A}_{13}\right) \left(I + \frac{x}{2} {A}_{12}\right) {e}^{\frac{x}{2} {A}_{11}}\end{matrix}$$

As an example, there can be n × m matrices and the matrix exponential of the Suzuki Trotter decomposition can be evaluated through parallel algorithms.

There are many different ways to partition the matrix A, and the optimal strategy will depend on the structure of the matrix A (e.g., positions of zeros) and on the architecture of the available computational platform (e.g., RAM amount, number cores and GPUs, bandwidth speed etc ...).

Concerning the time evolution of any LTI system with a dynamic matrix A (either band, not band or full matrix), the Suzuki Trotter decomposition computes the term e^{Aδ}. The algorithm can evaluate the time evolution for the period δ whose length, for convergence reasons, can be sufficiently smaller than one, i.e., δ<<1.

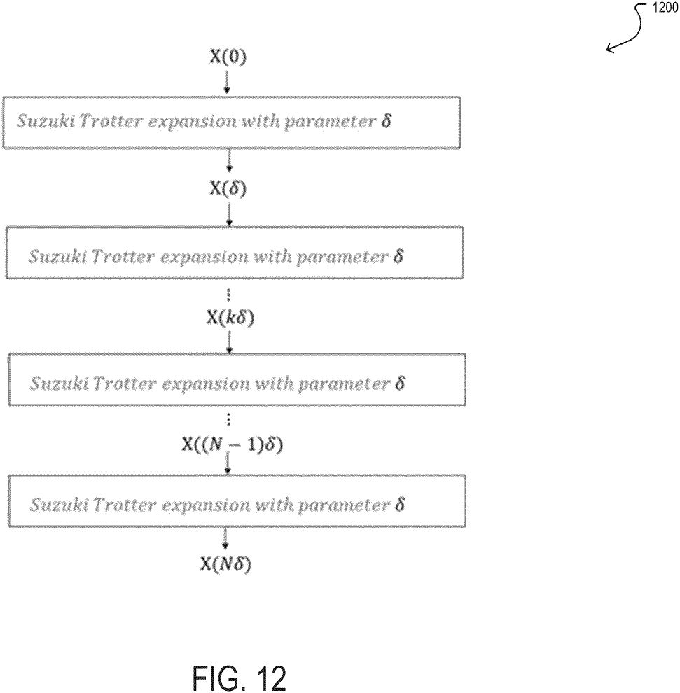

Nevertheless, this implies an iteration scheme which can be implemented many times. This workflow can be achieved by firstly splitting the overall time in N small intervals of length δ<<1. Secondly, starting from an initial state X(0) and denoting by X(kδ) the state variables at the k-th interval of length δ, the overall time evolution can be obtained by iteratively computing the value e^{Aδ}X(kδ) until reaching the final value X(Nδ) as shown in FIG. 12.

FIG. 12 shows an iterative process 1200 to evaluate system time evolution according to example of the instant disclosure.

Recalling that the Suzuki Trotter decomposition with time interval δ and order p^{th} gives an error of order o(δ^{p+1}), it is possible to compute the total simulation error.

Let e^{At} be a matrix exponential and let

$$\tilde{{e}^{A t}}$$

the matrix obtained through the p^{th} order Suzuki Trotter decomposition applied to the matrix A. For a given time step δ, it is

$${e}^{A δ} \text{=} \tilde{{e}^{A δ}} + o \left({δ}^{p + 1}\right)$$

, e.g., the Suzuki Trotter expansion gives an approximated value

$$\tilde{{e}^{A δ}}$$

for e^{Aδ}, with an approximation error of order o(δ^{p+1}).

The system free response at the time δ is then given by:

$${x}_{f} \left(δ\right) = {e}^{A δ} x \left(0\right) = \tilde{{e}^{A δ}} x \left(0\right) + o \left({δ}^{p + 1}\right) .$$

At the time 2δ and 3δ, the system free response can be computed as:

$${x}_{f} \left(2 δ\right) = {e}^{A δ} {x}_{f} \left(δ\right) = {e}^{A δ} \left(\tilde{{e}^{A δ}} x \left(0\right) + o \left({δ}^{p + 1}\right)\right) =$$

$$\left(\tilde{{e}^{A δ}} + o \left({δ}^{p + 1}\right)\right) \left(\tilde{{e}^{A δ}} x \left(0\right) + o \left({δ}^{p + 1}\right)\right) =$$

$$= \tilde{{e}^{A δ}} \tilde{{e}^{A δ}} x \left(0\right) + \tilde{{e}^{A δ}} x \left(0\right) o \left({δ}^{p + 1}\right) + o \left({δ}^{p + 1}\right) \tilde{{e}^{A δ}} x \left(0\right) + o \left({δ}^{2 p + 2}\right) =$$

$$= {\tilde{\left({e}^{A δ}\right)}}^{2} x \left(0\right) + 2 \tilde{{e}^{A δ}} x \left(0\right) o \left({δ}^{p + 1}\right) + o \left({δ}^{2 p + 2}\right) ,$$

$$\begin{matrix}{x}_{f} \left(3 δ\right) = {e}^{A δ} {x}_{f} \left(2 δ\right) = \\ {e}^{A δ} \left(\tilde{{e}^{A δ}} \tilde{{e}^{A δ}} x \left(0\right) + 2 \tilde{{e}^{A δ}} x \left(0\right) o \left({δ}^{p + 1}\right) + o \left({δ}^{2 p + 2}\right)\right) =\end{matrix}$$

$$= {\left(\tilde{{e}^{A δ}}\right)}^{3} x \left(0\right) + 3 \tilde{{e}^{A δ}} x \left(0\right) o \left({δ}^{p + 1}\right) + o \left({δ}^{2 p + 2}\right) .$$

By iteratively repeating the procedure, the final instant time can be determined T = Nδ.

$${x}_{f} \left(N δ\right) = {e}^{A t} {x}_{f} \left(\left(N - 1\right) δ\right) =$$

$$= {\tilde{\left({e}^{A δ}\right)}}^{N} x \left(0\right) + N \tilde{{e}^{A t}} x \left(0\right) o \left({δ}^{p + 1}\right) + o \left({δ}^{2 p + 2}\right) .$$

As a result, the total error of the simulation will be of order No(δ^{p+1}) since a Suzuki Trotter decomposition will be iteratively performed N times.

In other words, the algorithm can improve accuracy by either reducing the time interval δ or increasing the Suzuki Trotter decomposition order p.

If the initial state X(0) is a matrix whose columns are initial vectors of a set of many trials, the system can evaluate many Monte Carlo experiments in only one computational run.

Nevertheless, the procedure can be trivially extended in the sense that all possible trials can be evaluated in a single run by exploiting the system linearity. Indeed, if the initial state X(0) is the identity matrix

$$X \left(0\right) = {I}_{n x n} = {\left[\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix}\right]}_{n x n} = {I}_{n x n}$$

all possible combinations can be calculated by simply scaling the solutions.

Denoting by X(T) the solution at time T obtained by posing X(0) = Iₙₓₙ, the response of the system at a given set of initial conditions Y₀ are given by:

$$Y \left(T\right) = X \left(T\right) {Y}_{0}$$

In one example, the system can solve all possible combinations of initial states in one run. This can provide a great impact on technology and allows industry to design robust solutions in the sense that they are unfailing and reliable to a large set of initial conditions and forces.

In one example, the system can be used to determine the dynamics of a lumped mass spring mechanical model. In one example, the matrix A is a band matrix, or any matrix A.

In the first example, A is a band matrix. Let m₁,m₂, ..., mₗ, be l masses, let k₁. k₂, ..., kₗ₊₁ and b₁,b₂, ..., bₗ₊₁ be l+1 springs and dampers characteristic parameters, respectively. The first mass m₁ can be connected to a fixed point through the spring k₁ and damper b₁ and to the mass m₂ through k₂ and b₂. In general, the mass mⱼ is connected to the mass mⱼ₋₁ with kⱼ and damping bⱼ while to mⱼ₊₁ with kⱼ₊₁ and bⱼ₊₁, the last mass mₗ is instead connected to another fixed point through the spring kₗ₊₁ and damping bₗ₊₁.

Mass-spring-damper models are classic and widely used simulation models. Such models are well-suited for modelling any kind of objects including those with complex material properties such as nonlinearity and viscoelasticity. As well as engineering simulation, these systems have applications in computer graphics and computer animation. As one example of an engineering application, a mass-spring-damper model can be used to design vehicle seats, where it is typically desirable to limit the amount of vertical displacement and velocity an occupant experiences as the vehicle traverses the road surface and obstacles such as speed bumps. A vehicle seat has mass, its materials have a springiness (e.g., cushioning) which can be modelled as a spring. It has resistance to motion (e.g., where the seat is secured to the floor of the vehicle) which can be modelled as a damper. Other simple examples of systems that may be modelled in such a way include windows experiencing forces from wind or physical contact (e.g., mass, resistance to motion (frame), springiness of the glass), a wine glass being tapped (e.g., the wine glass has more springiness than the window, as can be heard when the glass “pings” in response to an impact), and a bridge, which has mass, springiness, and resistance to motion and experiences forces from people or vehicles passing over it.

By running such a simulation, one can determine, for example, for a given force and given spring and damping constants how the masses will move. In this way, spring and damping constants can be adjusted to avoid excessive movement when the masses experience expected forces. For example, in the design of a vehicle seat, stiffness of the seat materials might be increased if they were found to otherwise move too much in the simulation when the vehicle experiences typical forces from passing over a speed bump.

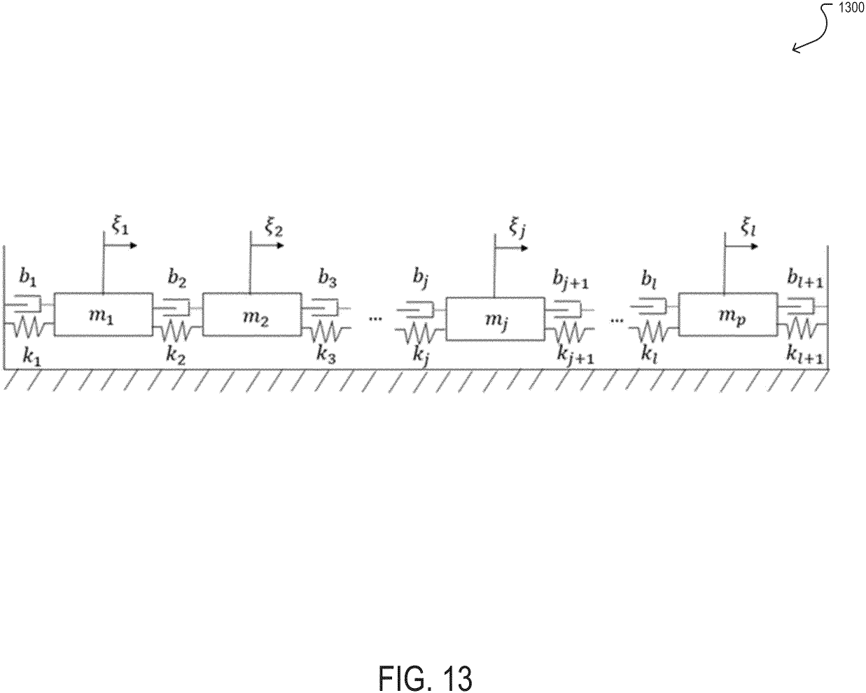

FIG. 13 shows a mass spring damper system 1300 according to an example of the instant disclosure. The system can be modelled using a system of second order differential equations as shown below:

$$\left[\begin{matrix}{m}_{1} & 0 & ⋯ & 0 \\ 0 & {m}_{2} & ⋯ & 0 \\ ⋮ & ⋮ & ⋱ & ⋮ \\ 0 & 0 & ⋯ & {m}_{l}\end{matrix}\right] \left[\begin{matrix}{\ddot{ξ}}_{1} \\ {\ddot{ξ}}_{2} \\ ⋮ \\ {\ddot{ξ}}_{l}\end{matrix}\right] + \left[\begin{matrix}{b}_{1} + {b}_{2} & 0 & ⋯ & 0 \\ 0 & {b}_{2} + {b}_{3} & ⋯ & 0 \\ ⋮ & ⋮ & ⋱ & ⋮ \\ 0 & 0 & ⋯ & {b}_{l} + {b}_{l + 1}\end{matrix}\right] \left[\begin{matrix}{\dot{ξ}}_{1} \\ {\dot{ξ}}_{2} \\ ⋮ \\ {\dot{ξ}}_{l}\end{matrix}\right]$$

$$\left[\begin{matrix}{k}_{1} + {k}_{2} & 0 & ⋯ & 0 \\ 0 & {k}_{2} + {k}_{3} & ⋯ & 0 \\ ⋮ & ⋮ & ⋱ & ⋮ \\ 0 & 0 & ⋯ & {k}_{l} + {k}_{l + 1}\end{matrix}\right] \left[\begin{matrix}{ξ}_{1} \\ {ξ}_{2} \\ ⋮ \\ {ξ}_{l}\end{matrix}\right] = \left[\begin{matrix}0 \\ 0 \\ ⋮ \\ 0\end{matrix}\right] .$$

A second order differential equation can be transformed in two first order differential equations, and the mass-spring-damper model of FIG. 13 in a system space representation can be expressed as follows:

$$\frac{d x \left(t\right)}{d t} = A x \left(t\right) \leq > \dot{x} = A x \left(t\right)$$

Denoting by:

$$\begin{matrix}{x}_{1} = {ξ}_{1} & & & \\ {x}_{2} = {\dot{ξ}}_{1} & & {\dot{x}}_{2} = {\ddot{ξ}}_{1} & \\ ⋮ & = > & ⋮ & , n = 2 l \\ {x}_{n - 1} = {ξ}_{1} & & {\dot{x}}_{n} = {\ddot{ξ}}_{l} & \\ {x}_{n} = {\dot{ξ}}_{l} & & & \end{matrix}$$

The system can be formulated through the following matrix notation:

$$\left[\begin{matrix}{\dot{x}}_{1} \\ {\dot{x}}_{2} \\ {\dot{x}}_{3} \\ {\dot{x}}_{4} \\ {\dot{x}}_{5} \\ {\dot{x}}_{6} \\ ⋮ \\ {\dot{x}}_{n - 1} \\ {\dot{x}}_{n}\end{matrix}\right] =$$

$$\begin{matrix}\left[\begin{matrix}0 & \frac{1}{{m}_{1}} & 0 & 0 & 0 & 0 & ⋯ & 0 & 0 \\ - {k}_{1} - {k}_{1} & - {b}_{1} - {b}_{2} & {k}_{2} & {σ}_{2} & 0 & 0 & ⋯ & 0 & 0 \\ 0 & 0 & 0 & \frac{1}{{m}_{2}} & 0 & 0 & ⋯ & 0 & 0 \\ {k}_{2} & {b}_{2} & {k}_{2} - {k}_{3} & - {b}_{2} - {b}_{3} & {k}_{3} & {b}_{3} & ⋯ & 0 & 0 \\ 0 & 0 & 0 & 0 & 0 & \frac{1}{{m}_{3}} & ⋯ & 0 & 0 \\ 0 & 0 & {k}_{3} & {b}_{3} & - {k}_{3} - {k}_{4} & - {b}_{3} - {b}_{4} & ⋯ & 0 & 0 \\ ⋮ & ⋮ & ⋮ & ⋮ & ⋮ & ⋮ & ⋱ & ⋮ & ⋮ \\ 0 & 0 & 0 & 0 & 0 & 0 & ⋯ & 0 & \frac{1}{{m}_{l}} \\ 0 & 0 & 0 & 0 & 0 & 0 & ⋯ & - {k}_{1} - {k}_{l + 1} & - {b}_{l} - {b}_{l + 1}\end{matrix}\right] ⋅ \\ \left[\begin{matrix}{x}_{1} \\ {x}_{2} \\ {x}_{3} \\ {x}_{4} \\ {x}_{5} \\ {x}_{6} \\ ⋮ \\ {x}_{n - 1} \\ {x}_{n}\end{matrix}\right] .\end{matrix}$$

If the matrix A is split in l matrices A₁, A₂, A₃, ...Aₗ constructed in the following manner

$${A}_{1} = \left[\begin{matrix}0 & \frac{1}{{m}_{1}} & 0 & 0 & 0 & 0 & ⋯ & 0 \\ - {k}_{1} - {k}_{2} & - {b}_{1} - {b}_{2} & {k}_{2} & {b}_{2} & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ ⋮ & ⋮ & ⋮ & ⋮ & ⋮ & ⋮ & ⋱ & ⋮ \\ 0 & 0 & 0 & 0 & 0 & 0 & 0 & 0\end{matrix}\right] ,$$

$$\begin{matrix}{A}_{2} = \left[\begin{matrix}0 & 0 & 0 & 0 & 0 & 0 & ⋯ & 0 \\ 0 & 0 & 0 & 0 & 0 & 0 & ⋯ & 0 \\ 0 & 0 & 0 & \frac{1}{{m}_{2}} & 0 & 0 & ⋯ & 0 \\ {k}_{2} & {b}_{2} & - {k}_{2} - {k}_{3} & - {b}_{2} - {b}_{3} & {k}_{3} & {b}_{3} & ⋯ & 0 \\ 0 & 0 & 0 & 0 & 0 & 0 & ⋯ & 0 \\ 0 & 0 & 0 & 0 & 0 & 0 & ⋯ & 0 \\ ⋮ & ⋮ & ⋮ & ⋮ & ⋮ & ⋮ & ⋱ & ⋮ \\ 0 & 0 & 0 & 0 & 0 & 0 & ⋯ & 0\end{matrix}\right] \\ {A}_{3} = \left[\begin{matrix}0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & \frac{1}{{m}_{3}} & ⋯ & 0 \\ 0 & 0 & {k}_{3} & {b}_{3} & - {k}_{3} - {k}_{4} & - {b}_{3} - {b}_{4} & ⋯ & 0 \\ ⋮ & ⋮ & ⋮ & ⋮ & ⋮ & ⋮ & ⋱ & ⋮ \\ 0 & 0 & 0 & 0 & 0 & 0 & ⋯ & 0\end{matrix}\right] , \\ {A}_{l} = \left[\begin{matrix}0 & 0 & ⋯ & 0 & 0 & 0 & 0 & 0 \\ 0 & 0 & ⋯ & 0 & 0 & 0 & 0 & 0 \\ 0 & 0 & ⋯ & 0 & 0 & 0 & 0 & 0 \\ 0 & 0 & ⋯ & 0 & 0 & 0 & 0 & 0 \\ 0 & 0 & ⋯ & 0 & 0 & 0 & 0 & 0 \\ ⋮ & ⋮ & ⋱ & ⋮ & ⋮ & ⋮ & ⋮ & ⋮ \\ 0 & 0 & ⋯ & 0 & 0 & 0 & 0 & \frac{1}{{m}_{l}} \\ 0 & 0 & ⋯ & 0 & {k}_{l} & {b}_{l} & - {k}_{l} - {k}_{l + 1} & - {b}_{l} - {b}_{l + 1}\end{matrix}\right]\end{matrix}$$

It can be determined not only that their sum is equal to the matrix A

$$A = {A}_{1} + {A}_{2} + {A}_{3} + ⋯ + {A}_{l} = {\sum }_{j = 1}^{l} {A}_{j} = {\sum }_{j e v e n}^{l} {A}_{j} + {\sum }_{j o d d}^{l} {A}_{j}$$

but also, that each matrix Aⱼ does not commute with its adjacent matrices Aⱼ₋₁, Aⱼ₊₁ while commuting with all the others:

$$\left[{A}_{j} , {A}_{j - 1}\right] \neq 0 , \left[{A}_{j} , {A}_{j + 1}\right] \neq 0$$

$$\begin{matrix}… \left[{A}_{j} , {A}_{j - 3}\right] = 0 , \left[{A}_{j} , {A}_{j - 2}\right] = 0 , \\ \left[{A}_{j} , {A}_{j + 2}\right] = 0 , \left[{A}_{j} , {A}_{j + 3}\right] = 0 , …\end{matrix}$$

For instance, the matrix A₁ does not commute with A₂

$$\left[{A}_{1} , {A}_{2}\right] \neq 0$$

while it commutes with all the others

$$\left[{A}_{1} , {A}_{3}\right] = 0 , \left[{A}_{1} , {A}_{4}\right] = 0 , … \left[{A}_{1} , {A}_{l}\right] = 0.$$

It follows that the Suzuki Trotter decomposition can be therefore applied on two sets of matrices having even and odd indices.

However, for computational reasons, in order to decrease the memory usage, instead of using A₁, A₂, A₃, ... Aₗ, the following smaller matrices are considered:

$$\begin{matrix}{A}_{1}^{*} = \left[\begin{matrix}0 & \frac{1}{{m}_{1}} & 0 & 0 \\ - {k}_{1} - {k}_{2} & - {b}_{1} - {b}_{2} & {k}_{2} & {b}_{2}\end{matrix}\right] \\ {A}_{2}^{*} = \left[\begin{matrix}0 & 0 & 0 & \frac{1}{{m}_{2}} & 0 & 0 \\ {k}_{2} & {b}_{2} & - {k}_{2} - {k}_{3} & - {b}_{2} - {b}_{3} & {k}_{3} & {b}_{3}\end{matrix}\right] \\ {A}_{j}^{*} = \left[\begin{matrix}0 & 0 & 0 & \frac{1}{{m}_{\text{j}}} & 0 & 0 \\ {k}_{\text{j}} & {b}_{\text{j}} & - {k}_{\text{j}} - {k}_{\text{j+1}} & - {b}_{\text{j}} - {b}_{\text{j+1}} & {k}_{\text{j+1}} & {b}_{\text{j+1}}\end{matrix}\right] \\ {A}_{l}^{*} = \left[\begin{matrix}0 & 0 & 0 & \frac{1}{{m}_{l}} \\ {k}_{l} & {b}_{l} & - {k}_{l} - {k}_{l + 1} & - {b}_{l} - {b}_{l + 1}\end{matrix}\right]\end{matrix}$$

The parallel version of the algorithm can be implemented by computing the Suzuki Trotter decomposition on the matrices

$${A}_{1}^{*} , {A}_{2}^{*} , … {A}_{l}^{*} .$$

The description of the parallel coding is provided herein.

The simulation can be performed over the time interval [0, T]. In this instance, it is possible to divide the overall interval in smaller time steps of length δ, and each single time interval will, therefore, begin at the time instants 0, δ, 2δ, .., nδ, ..., T - δ.

A second order Suzuki Trotter decomposition approximant can be divided in three different parallel processing layers. Let

$$t h r e a {d}_{i}^{j}$$

be the value of the thread i at the layer j of the Suzuki Trotter decomposition.

The time evolution of the system at time δ with initial conditions X(0) can be computed by distributing over the threads the calculation. The first thread at the layer one will process a part of the overall computation and is given by:

$$t h r e a {t}_{1}^{1} = {e}^{\frac{δ}{2} {A}_{1}^{*}} X \left(0\right) = {U}_{1} {Σ}_{1} {V}_{1} ≅ {U}_{1}^{*} {Σ}_{1}^{*} {V}_{1}^{*}$$

The second thread at the layer one will be:

$$t h r e a {d}_{2}^{1} = {e}^{\frac{δ}{2} {A}_{3}^{∗}} X \left(0\right) = {U}_{3} {Σ}_{3} {V}_{3} ≅ {U}_{3}^{∗} {Σ}_{3}^{∗} {V}_{32}^{∗}$$

At the layer two, the following is calculated

$${K}_{1} = {\left[\begin{matrix}\begin{matrix}{\left[{U}_{1}^{∗} {Σ}_{1}^{∗} {V}_{1}^{∗}\right]}_{2 x 6} & {0}_{2 x 2}\end{matrix} \\ {0}_{6 x 8}\end{matrix}\right]}_{8 x 8} = {\left[\begin{matrix}\begin{matrix}{\left[t h r e a {d}_{1}^{1}\right]}_{2 x 6} & {0}_{2 x 2}\end{matrix} \\ {0}_{6 x 8}\end{matrix}\right]}_{8 x 8}$$

$$\begin{matrix}{K}_{3} = {\left[\begin{matrix}{0}_{2 x 8} \\ \begin{matrix}{0}_{2 x 2} & {\left[{U}_{3}^{∗} {Σ}_{3}^{∗} {V}_{3}^{∗}\right]}_{2 x 6}\end{matrix}\end{matrix}\right]}_{8 x 8} = {\left[\begin{matrix}{0}_{2 x 8} \\ \begin{matrix}{0}_{2 x 2} & {\left[t h r e a {d}_{2}^{1}\right]}_{2 x 6}\end{matrix}\end{matrix}\right]}_{8 x 8} \\ {K}_{2} = {\left[\begin{matrix}{0}_{2 x 8} \\ \begin{matrix}{\left[{e}^{δ {A}_{2}^{∗}}\right]}_{2 x 6} & {0}_{2 x 2}\end{matrix} \\ {0}_{2 x 8}\end{matrix}\right]}_{8 x 8} \\ t h r e a {d}_{1}^{2} = {e}^{{K}_{2}} {K}_{1} {K}_{3} = {U}_{2} {Σ}_{2} {V}_{2} ≅ {U}_{2}^{∗} {Σ}_{2}^{∗} {V}_{2}^{∗}\end{matrix}$$

At the layer three of the Suzuki Trotter decomposition, the following is calculated:

$$\begin{matrix}{W}_{1} = {\left[\begin{matrix}\begin{matrix}{\left[{e}^{\frac{δ}{2} δ {A}_{1}^{∗}}\right]}_{2 x 6} & {0}_{2 x 2}\end{matrix} \\ {0}_{6 x 8}\end{matrix}\right]}_{8 x 8} \\ {W}_{2} = {\left[\begin{matrix}{0}_{2 x 8} \\ \begin{matrix}{\left[{U}_{2}^{∗} {Σ}_{2}^{∗} {V}_{2}^{∗}\right]}_{2 x 6} & {0}_{2 x 2}\end{matrix} \\ {0}_{2 x 8}\end{matrix}\right]}_{8 x 8} = {\left[\begin{matrix}{0}_{2 x 8} \\ \begin{matrix}{\left[t h r e a {d}_{1}^{2}\right]}_{2 x 6} & {0}_{2 x 2}\end{matrix} \\ {0}_{2 x 8}\end{matrix}\right]}_{8 x 8} \\ t h r e a {d}_{1}^{3} = {e}^{{W}_{1}} {W}_{2}\end{matrix}$$

The values at the different threads

$$t h r e a {d}_{1}^{3} , t h r e a {d}_{2}^{3} … t h r e a {d}_{p}^{3}$$

provide a distributed solution at the time X(δ). The communication scheme concerns only adjacent threads delivering the possibility to implement a high scalable tool.

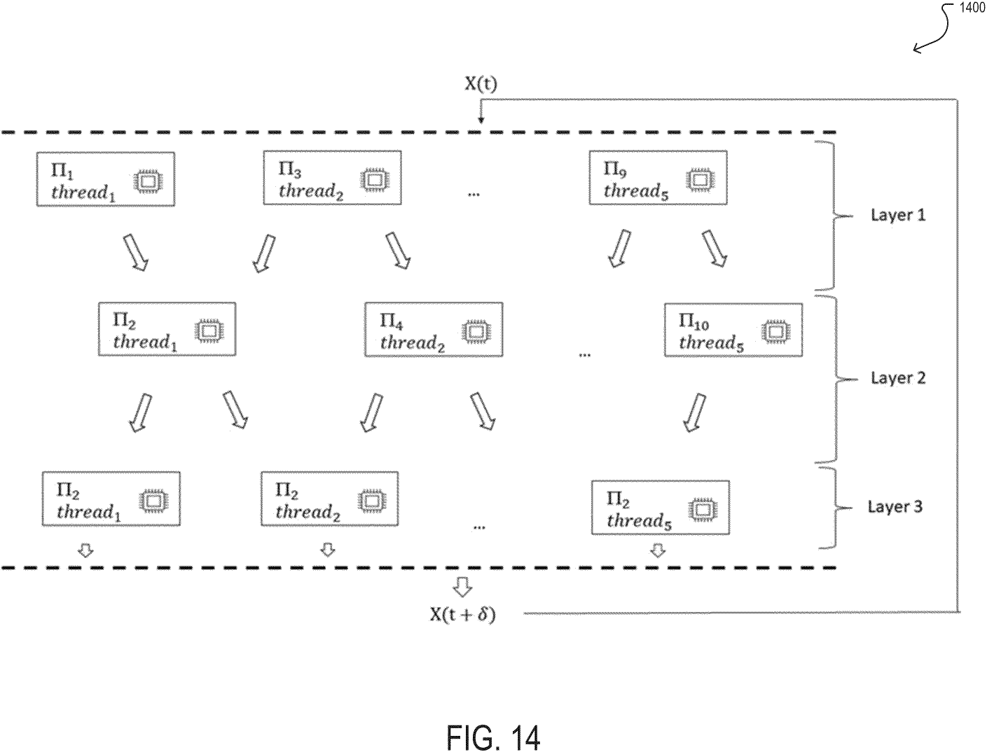

FIG. 14 shows communication 1400 between threads when A is a band matrix according to an example of the instant disclosure.

In one example, it is possible to evaluate the time evolution at the time instant 2δ, by repeating the Suzuki Trotter decomposition by entering as initial condition the value X(δ) computed at the time δ. The initial conditions at the final time Nδ is therefore the value X((N - 1)δ) calculated at the previous step (N - 1)δ as shown in Figure.

As already discussed, the methodology offers the possibility to evaluate many Monte Carlo trials in only one computational run. Considering the linearity of the system, if the matrix of initial condition X(0) is the identity matrix, all possible combinations can be calculated afterwards:

$$X \left(0\right) = {\left[\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix}\right]}_{n x n} = {I}_{n x n}$$

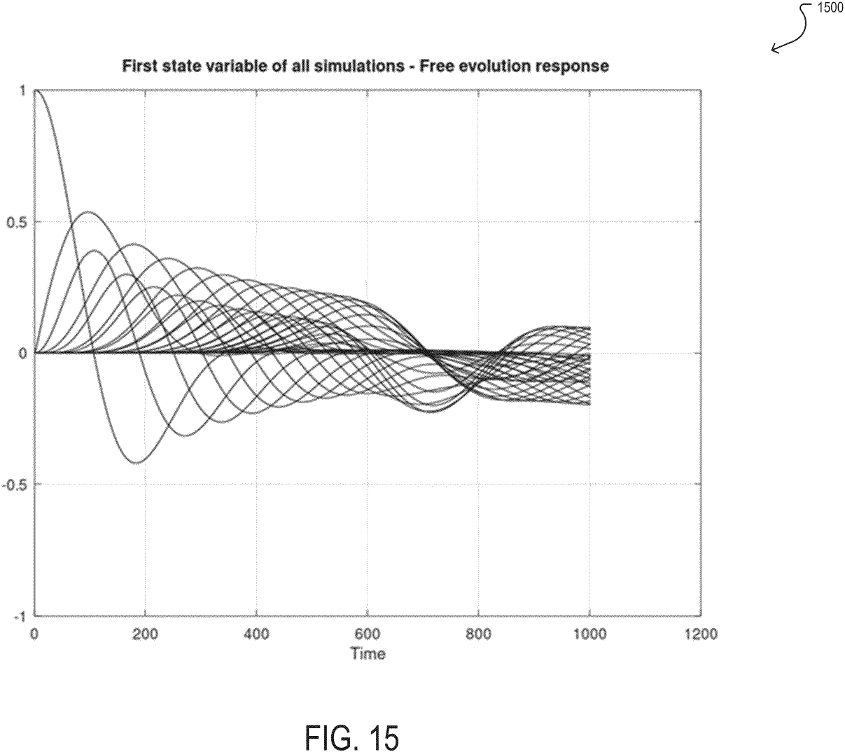

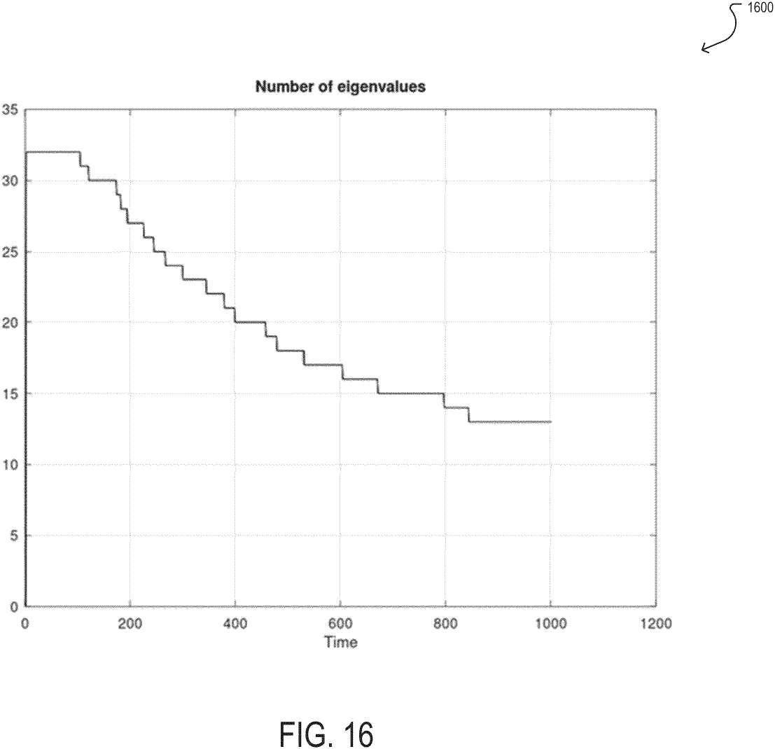

FIG. 15 shows the outcome of the simulation considering as initial matrix X(0) = Iₙₓₙ the identity matrix according to example of the instant disclosure. Any set of initial conditions can be now easily computed by exploiting system linearity. FIG. 16 shows how the number of the considered singular values along the simulation decreases, e.g., the matrix A induces correlation between the state variables and therefore the number of singular values greater than a given threshold decreases according to example of the instant disclosure.

FIG. 15 shows free evolution response showing of all the state variables 1500 according to an example of the instant disclosure.

FIG. 16 shows a number of the singular values during the simulation greater than the threshold σ̅ = 0.01 1600 according to an example of the instant disclosure.

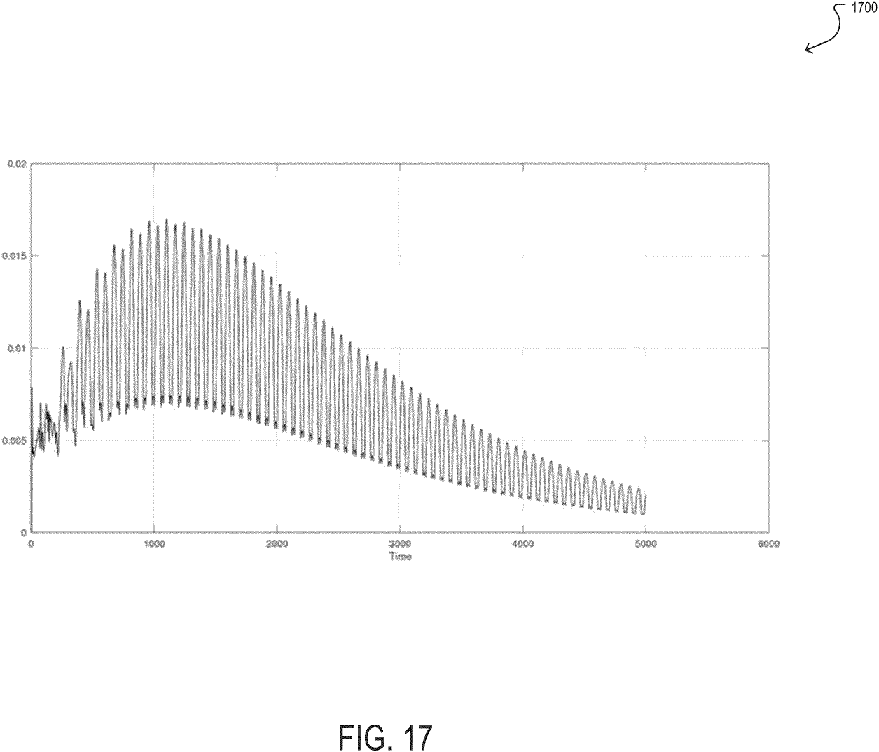

The simulation error can be strictly controlled by changing the time interval δ and the Suzuki Trotter decomposition p order. FIG. 17 shows an example of the simulation error with respect to the time, where a time step δ = 0.1 is chosen and a p = 4 order Suzuki Trotter decomposition is implemented.

The maximum simulation error is No(δ^{p+1}) and therefore:

$$e r r o r = N {δ}^{4 + 1} = 5000 ⋅ {0.1}^{5} = 5 ⋅ {10}^{- 2}$$

FIG. 17 shows an example of simulation error versus elapsed time in seconds with δ = 0.1 and p=4 1700 according to an example of the instant disclosure.

Keeping the 4^{th} order approximant of the Suzuki Trotter decomposition and reducing by one order of magnitude the time interval it is possible to gain a reduction of the simulation error of p=4 order of magnitudes as shown in Figure.

$$e r r o r = N {δ}^{4 + 1} = 50000 ∗ {0.01}^{5} = 5 ⋅ {10}^{- 6}$$

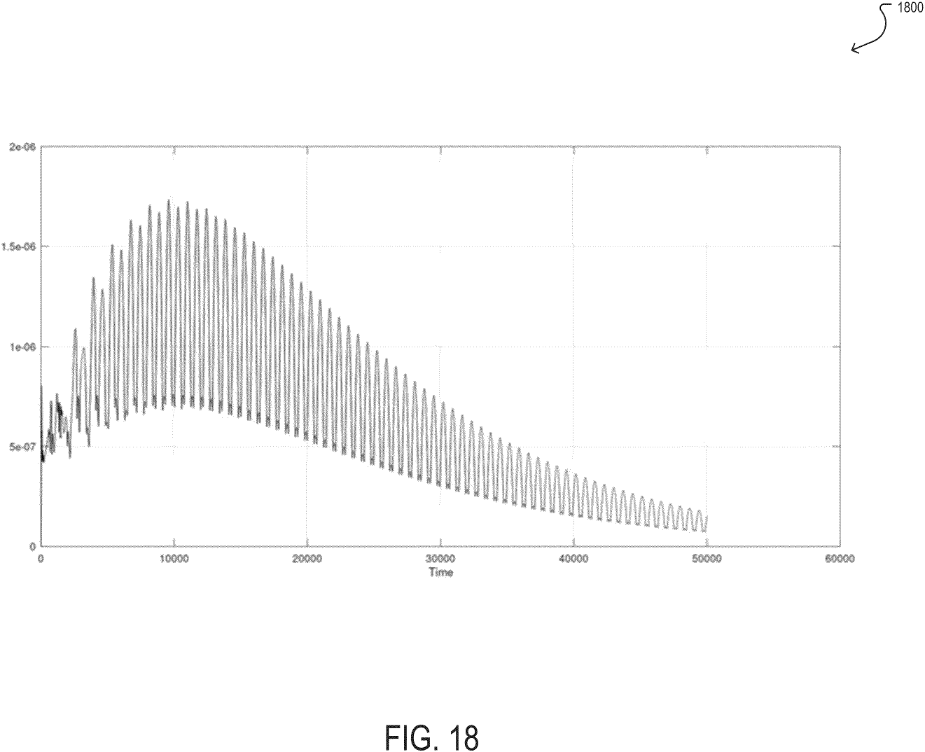

FIG. 18 shows an example of simulation error versus elapsed time in seconds with δ = 0.01 and p=4 1800 according to an example of the instant disclosure.

As an example, there can be a numerical example of a lumped mass spring mechanical model.

For instance, there can be a system with four masses.

$$\begin{matrix}\left[\begin{matrix}{m}_{1} & 0 & 0 & 0 \\ 0 & {m}_{2} & 0 & 0 \\ 0 & 0 & {m}_{3} & 0 \\ 0 & 0 & 0 & {m}_{4}\end{matrix}\right] \left[\begin{matrix}{\ddot{ξ}}_{1} \\ {\ddot{ξ}}_{2} \\ ⋮ \\ {\ddot{ξ}}_{l}\end{matrix}\right] + \left[\begin{matrix}{b}_{1} + {b}_{2} & 0 & 0 & 0 \\ 0 & {b}_{2} + {b}_{3} & 0 & 0 \\ 0 & 0 & {b}_{3} + {b}_{4} & 0 \\ 0 & 0 & 0 & {b}_{4} + {b}_{5}\end{matrix}\right] \\ \left[\begin{matrix}{\dot{ξ}}_{1} \\ {\dot{ξ}}_{2} \\ ⋮ \\ {\dot{ξ}}_{l}\end{matrix}\right] +\end{matrix}$$

$$\left[\begin{matrix}{k}_{1} + {k}_{2} & 0 & 0 & 0 \\ 0 & {k}_{2} + {k}_{3} & 0 & 0 \\ 0 & 0 & {k}_{3} + {k}_{4} & 0 \\ 0 & 0 & 0 & {k}_{4} + {k}_{5}\end{matrix}\right] \left[\begin{matrix}{ξ}_{1} \\ {ξ}_{2} \\ {ξ}_{3} \\ {ξ}_{4}\end{matrix}\right] = \left[\begin{matrix}0 \\ 0 \\ 0 \\ 0\end{matrix}\right] .$$

$$M \ddot{\text{ξ}} \text{+} B \dot{\text{ξ}} \text{+Κξ=0}$$

As a further example:

$$\begin{matrix}M = \left[\begin{matrix}{m}_{1} & 0 & 0 & 0 \\ 0 & {m}_{2} & 0 & 0 \\ 0 & 0 & {m}_{3} & 0 \\ 0 & 0 & 0 & {m}_{4}\end{matrix}\right] = \left[\begin{matrix}1 & 0 & 0 & 0 \\ 0 & 2 & 0 & 0 \\ 0 & 0 & 3 & 0 \\ 0 & 0 & 0 & 4\end{matrix}\right] \\ B = \left[\begin{matrix}{b}_{1} + {b}_{2} & 0 & 0 & 0 \\ 0 & {b}_{2} + {b}_{3} & 0 & 0 \\ 0 & 0 & {b}_{3} + {b}_{4} & 0 \\ 0 & 0 & 0 & {b}_{4} + {b}_{5}\end{matrix}\right] =\end{matrix}$$

$$\left[\begin{matrix}.01 + .02 & 0 & 0 & 0 \\ 0 & .02 + .03 & 0 & 0 \\ 0 & 0 & .03 + .04 & 0 \\ 0 & 0 & 0 & .04 + .05\end{matrix}\right]$$

$$K = \left[\begin{matrix}{k}_{1} + {k}_{2} & 0 & 0 & 0 \\ 0 & {k}_{2} + {k}_{3} & 0 & 0 \\ 0 & 0 & {k}_{3} + {k}_{4} & 0 \\ 0 & 0 & 0 & {k}_{4} + {k}_{5}\end{matrix}\right] =$$

$$\left[\begin{matrix}.1 + .2 & 0 & 0 & 0 \\ 0 & .2 + .3 & 0 & 0 \\ 0 & 0 & .3 + .4 & 0 \\ 0 & 0 & 0 & .4 + .5\end{matrix}\right]$$

The state matrix formulation becomes:

$$\left[\begin{matrix}{\dot{x}}_{1} \\ {\dot{x}}_{2} \\ {\dot{x}}_{3} \\ {\dot{x}}_{4} \\ {\dot{x}}_{5} \\ {\dot{x}}_{6} \\ {\dot{x}}_{7} \\ {\dot{x}}_{8}\end{matrix}\right] =$$

$$\left[\begin{matrix}0 & \frac{1}{{m}_{1}} & 0 & 0 & 0 & 0 & 0 & 0 \\ - {k}_{1} - {k}_{2} & - {b}_{1} - {b}_{2} & {k}_{2} & {σ}_{2} & 0 & 0 & 0 & 0 \\ 0 & 0 & 0 & \frac{1}{{m}_{2}} & 0 & 0 & 0 & 0 \\ {k}_{2} & {b}_{2} & - {k}_{2} - {k}_{3} & - {b}_{2} - {b}_{3} & {k}_{3} & {b}_{3} & 0 & 0 \\ 0 & 0 & 0 & 0 & 0 & \frac{1}{{m}_{3}} & 0 & 0 \\ 0 & 0 & {k}_{3} & {b}_{3} & - {k}_{3} - {k}_{4} & - {b}_{3} - {b}_{4} & 0 & 0 \\ 0 & 0 & 0 & 0 & 0 & 0 & 0 & \frac{1}{{m}_{4}} \\ 0 & 0 & 0 & 0 & 0 & 0 & - {k}_{4} - {k}_{4} & - {b}_{4} - {b}_{5}\end{matrix}\right] \left[\begin{matrix}{x}_{1} \\ {x}_{2} \\ {x}_{3} \\ {x}_{4} \\ {x}_{5} \\ {x}_{6} \\ {x}_{7} \\ {x}_{8}\end{matrix}\right]$$

And therefore:

$$\left[\begin{matrix}{\dot{x}}_{1} \\ {\dot{x}}_{2} \\ {\dot{x}}_{3} \\ {\dot{x}}_{4} \\ {\dot{x}}_{5} \\ {\dot{x}}_{6} \\ {\dot{x}}_{7} \\ {\dot{x}}_{8}\end{matrix}\right] = \left[\begin{matrix}0 & 1 & 0 & 0 & 0 & 0 & 0 & 0 \\ - .3 & - .03 & .2 & .02 & 0 & 0 & 0 & 0 \\ 0 & 0 & 0 & \frac{1}{2} & 0 & 0 & 0 & 0 \\ .2 & .02 & - .5 & - .05 & .3 & .03 & 0 & 0 \\ 0 & 0 & 0 & 0 & 0 & \frac{1}{3} & 0 & 0 \\ 0 & 0 & .3 & .03 & - .7 & - .07 & .4 & .04 \\ 0 & 0 & 0 & 0 & 0 & 0 & 0 & \frac{1}{4} \\ 0 & 0 & 0 & 0 & .4 & .04 & - .9 & - .09\end{matrix}\right] \left[\begin{matrix}{x}_{1} \\ {x}_{2} \\ {x}_{3} \\ {x}_{4} \\ {x}_{5} \\ {x}_{6} \\ {x}_{7} \\ {x}_{8}\end{matrix}\right] .$$

It is possible to consider the following four matrices:

$${A}_{1} = \left[\begin{matrix}0 & 1 & 0 & 0 & 0 & 0 & 0 & 0 \\ - .3 & - .03 & .2 & .02 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}\right]$$

$$\begin{matrix}{A}_{2} = \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & \frac{1}{2} & 0 & 0 & 0 & 0 \\ .2 & .02 & - .5 & - .05 & .3 & .03 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}\right] \\ {A}_{3} = \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & \frac{1}{3} & 0 & 0 \\ 0 & 0 & .3 & .03 & - .7 & - .07 & .4 & .04 \\ 0 & 0 & 0 & 0 & 0 & 0 & 0 & 0 \\ 0 & 0 & 0 & 0 & 0 & 0 & 0 & 0\end{matrix}\right] \\ {A}_{4} = \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & \frac{1}{4} \\ 0 & 0 & 0 & 0 & .4 & .04 & - .9 & - .09\end{matrix}\right]\end{matrix}$$

As a result:

$$\begin{matrix}A = {A}_{1} + {A}_{2} + {A}_{3} + {A}_{4} \\ C = \left[\begin{matrix}\left[{A}_{1} , {A}_{1}\right] & \left[{A}_{1} , {A}_{2}\right] & \left[{A}_{1} , {A}_{3}\right] & \left[{A}_{1} , {A}_{4}\right] \\ \left[{A}_{2} , {A}_{1}\right] & \left[{A}_{2} , {A}_{2}\right] & \left[{A}_{2} , {A}_{3}\right] & \left[{A}_{2} , {A}_{4}\right] \\ \left[{A}_{3} , {A}_{1}\right] & \left[{A}_{3} , {A}_{2}\right] & \left[{A}_{3} , {A}_{3}\right] & \left[{A}_{3} , {A}_{4}\right] \\ \left[{A}_{4} , {A}_{6}\right] & \left[{A}_{4} , {A}_{6}\right] & \left[{A}_{4} , {A}_{3}\right] & \left[{A}_{4} , {A}_{4}\right]\end{matrix}\right] = \\ = \left[\begin{matrix}0 & \neq 0 & 0 & 0 \\ \neq 0 & 0 & \neq 0 & 0 \\ 0 & \neq 0 & 0 & \neq 0 \\ 0 & 0 & \neq 0 & 0\end{matrix}\right]\end{matrix}$$

The following two non-commuting sets are identified:

$${\text{Ξ}}_{1} = \left\{{\text{Π}}_{1} , {\text{Π}}_{3}\right\} ⇒ {\text{Φ}}_{1} = \left\{{A}_{1} , {A}_{3} ,\right\}$$

$${\text{Ξ}}_{2} = \left\{{\text{Π}}_{2} , {\text{Π}}_{4}\right\} ⇒ {\text{Φ}}_{2} = \left\{{A}_{2} , {A}_{4} ,\right\}$$

It is possible to apply the second order Suzuki Trotter decomposition.

$${e}^{A δ} = {e}^{\frac{δ}{2} {A}_{o d d}} {e}^{δ {A}_{e v e n}} {e}^{\frac{δ}{2} {A}_{o d d}} + o \left({δ}^{3}\right)$$

In addition, as an example, δ = 0.1.

$${e}^{0.1 A} = {e}^{\frac{0.1}{2} \left({A}_{1} + {A}_{3}\right)} {e}^{0.1 \left({A}_{2} + {A}_{4}\right)} {e}^{\frac{0.1}{2} \left({A}_{1} + {A}_{3}\right)} + o \left({.1}^{3}\right)$$

$$\begin{matrix}{e}^{0.1 A} = e x p \\ \left(0.1 \left[\begin{matrix}0 & 1 & 0 & 0 & 0 & 0 & 0 & 0 \\ - .3 & - .03 & .2 & .02 & 0 & 0 & 0 & 0 \\ 0 & 0 & 0 & \frac{1}{2} & 0 & 0 & 0 & 0 \\ .2 & .02 & - .5 & - .05 & .3 & .03 & 0 & 0 \\ 0 & 0 & 0 & 0 & 0 & \frac{1}{3} & 0 & 0 \\ 0 & 0 & .3 & .03 & - .7 & - .07 & .4 & .04 \\ 0 & 0 & 0 & 0 & 0 & 0 & 0 & \frac{1}{4} \\ 0 & 0 & 0 & 0 & .4 & .04 & - .9 & - .09\end{matrix}\right]\right) \approx \end{matrix}$$

$$\approx e x p \left(\frac{0.1}{2} \left[\begin{matrix}0 & 1 & 0 & 0 & 0 & 0 & 0 & 0 \\ - .3 & - .03 & .2 & .02 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & \frac{1}{3} & 0 & 0 \\ 0 & 0 & .3 & .03 & - .7 & - .07 & .4 & .04 \\ 0 & 0 & 0 & 0 & 0 & 0 & 0 & 0 \\ 0 & 0 & 0 & 0 & 0 & 0 & 0 & 0\end{matrix}\right]\right) .$$

$$⋅ e x p \left(0.1 \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & \frac{1}{2} & 0 & 0 & 0 & 0 \\ .2 & .02 & - .5 & - .05 & .3 & .03 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & \frac{1}{4} \\ 0 & 0 & 0 & 0 & .4 & .04 & - .9 & - .09\end{matrix}\right]\right) .$$

$$⋅ e x p \left(\frac{0.1}{2} \left[\begin{matrix}0 & 1 & 0 & 0 & 0 & 0 & 0 & 0 \\ - .3 & - .03 & .2 & .02 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & \frac{1}{3} & 0 & 0 \\ 0 & 0 & .3 & .03 & - .7 & - .07 & .4 & .04 \\ 0 & 0 & 0 & 0 & 0 & 0 & 0 & 0 \\ 0 & 0 & 0 & 0 & 0 & 0 & 0 & 0\end{matrix}\right]\right) =$$

$$= \left[\begin{matrix}0.9985 & 0.0998 & 0.0010 & 0.0001 & 0 & 0 & 0 & 0 \\ - 0.0299 & 0.9955 & 0.0199 & 0.0025 & 0 & 0 & 0 & 0 \\ 0.0005 & 0.0001 & 0.9988 & 0.04990 & 0.007 & 0.0001 & 0 & 0 \\ 0.0199 & 0.0030 & - 0.0498 & 0.9938 & 0.0298 & 0.0035 & 0.0001 & 0 \\ 0 & 0 & 0.0005 & 0.0001 & 0.9988 & 0.0332 & 0.0007 & 0.0001 \\ 0 & 0 & 0.0298 & 0.0037 & - 0.0698 & 0.9919 & 0.0400 & 0.0045 \\ 0 & 0 & 0 & 0 & - 0.0005 & - 0.0001 & 1.0011 & 0.0251 \\ 0 & 0 & - 0.0001 & 0 & - 0.0400 & - 0.0047 & 0.0904 & 1.0102\end{matrix}\right]$$

Such a computation can be implemented on a distributed platform.

As initial condition x(0):

$$x \left(0\right) = \left[\begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix}\right]$$

If there are two threads thread₁, and thread₂, the first step in which thread₁ computes

$${e}^{\frac{0.1}{2} {A}_{1}} x \left(0\right) = e x p \left(\frac{0.1}{2} \left[\begin{matrix}0 & 1 & 0 & 0 \\ - .3 & - .03 & .2 & .02 \\ 0 & 0 & 0 & 0 \\ 0 & 0 & 0 & 0 \\ 0 & 0 & 0 & 0\end{matrix}\right]\right) \left[\begin{matrix}1 & 0 & 0 & 0 \\ 0 & 1 & 0 & 0 \\ 0 & 0 & 1 & 0 \\ 0 & 0 & 0 & 1\end{matrix}\right] =$$

$$= \left[\begin{matrix}0.9996 & 0.0500 & 0.0002 & 0 \\ - 0.0150 & 0.9981 & 0.0100 & 0.0010 \\ 0 & 0 & 1 & 0 \\ 0 & 0 & 0 & 1\end{matrix}\right]$$

thread₂ computes

$${e}^{\frac{0.1}{2} {A}_{3}} x \left(0\right) =$$

$$e x p \left(\frac{0.1}{2} \left[\begin{matrix}0 & 0 & 0 & 0 & 0 & 0 \\ 0 & 0 & 0 & 0 & 0 & 0 \\ 0 & 0 & 0 & \frac{1}{3} & 0 & 0 \\ .3 & .03 & - .7 & - .07 & .4 & .04 \\ 0 & 0 & 0 & 0 & 0 & 0 \\ 0 & 0 & 0 & 0 & 0 & 0\end{matrix}\right]\right) \left[\begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix}\right] =$$

$$= \left[\begin{matrix}1 & 0 & 0 & 0 & 0 & 0 \\ 0 & 1 & 0 & 0 & 0 & 0 \\ 0.0001 & 0 & 0.9997 & 0.0166 & 0.0002 & 0 \\ 0.0150 & 0.0015 & - 0.0349 & 0.9962 & 0.0200 & 0.0020 \\ 0 & 0 & 0 & 0 & 1 & 0 \\ 0 & 0 & 0 & 0 & 0 & 0\end{matrix}\right]$$

In the second step it is possible to obtain thread₁ computes

$${e}^{0.1 {A}_{2}} {e}^{\frac{0.1}{2} \left({\text{A}}_{1} + {\text{A}}_{3}\right)} x \left(0\right) = exp \left(0.1 \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & \frac{1}{2} & 0 & 0 & 0 & 0 \\ .2 & 0.02 & - .5 & - .05 & .3 & .03 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}\right]\right)$$

$$\left[\begin{matrix}0.9996 & 0.0500 & 0.0002 & 0 & 0 & 0 & 0 & 0 \\ - 0.0150 & 0.9981 & 0.0100 & 0.0010 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0.0001 & 0 & 0.9997 & 0.0166 & 0.0002 & 0 \\ 0 & 0 & 0.0015 & 0.0015 & - 0.0349 & 0.9962 & 0.0200 & 0.0020 \\ 0 & 0 & 0 & 0 & 0 & 0 & 0 & 0 \\ 0 & 0 & 0 & 0 & 0 & 0 & 0 & 0\end{matrix}\right]$$

$$= \left[\begin{matrix}0.9996 & 0.0500 & 0.0002 & 0 & 0 & 0 & 0 & 0 \\ - 0.0150 & 0.9981 & 0.0100 & 0.0010 & 0 & 0 & 0 & 0 \\ 0.0005 & 0.0001 & 0.9988 & 0.0499 & 0.0007 & 0.0001 & 0 & 0 \\ 0.0199 & 0.0030 & - 0.0498 & 0.9938 & 0.0298 & 0.0035 & 0.0001 & 0 \\ 0 & 0 & 0.0001 & 0 & 0.9997 & 0.0166 & 0.0002 & 0 \\ 0 & 0 & 0.0150 & 0.0015 & - 0.0349 & 0.9962 & 0.0200 & 0.0020 \\ 0 & 0 & 0 & 0 & 0 & 0 & 1 & 0 \\ 0 & 0 & 0 & 0 & 0 & 0 & 0 & 1\end{matrix}\right]$$

thread₂ computes

$${e}^{0.1 \left({A}_{2} + {A}_{4}\right)} {e}^{\frac{0.1}{2} {A}_{3}} x \left(0\right) =$$

$$exp \left(0.1 \left[\begin{matrix}0 & 0 & 0 & 0 & 0 & 0 & 0 & 0 \\ 0 & 0 & 0 & 0 & 0 & 0 & 0 & 0 \\ 0 & 0 & \frac{1}{2} & 0 & 0 & 0 & 0 & 0 \\ .2 & .02 & - .5 & - .05 & .3 & .03 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & \frac{1}{4} \\ 0 & 0 & 0 & 0 & .4 & .04 & - .9 & - .09\end{matrix}\right]\right)$$

$$\left[\begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0.0001 & 0 & 0.9997 & 0.0166 & 0.0002 & 0 \\ 0 & 0 & 0.0150 & 0.0015 & - 0.0349 & 0.9962 & 0.0200 & 0.0020 \\ 0 & 0 & 0 & 0 & 0 & 0 & 1 & 0 \\ 0 & 0 & 0 & 0 & 0 & 0 & 0 & 1\end{matrix}\right] =$$

$$\begin{matrix}= \\ \left[\begin{matrix}1 & 0 & 0 & 0 & 0 & 0 & 0 & 0 \\ 0 & 1 & 0 & 0 & 0 & 0 & 0 & 0 \\ 0.0005 & 0 & 0.9988 & 0.0499 & 0.0007 & 0.0001 & 0 & 0 \\ 0.0199 & 0.0020 & - 0.0498 & 0.9938 & 0.0298 & 0.0035 & 0.0001 & 0 \\ 0 & 0 & 0.0001 & 0 & 0.9997 & 0.0166 & 0.0002 & 0 \\ 0 & 0 & 0.0150 & 0.0015 & - 0.0349 & 0.9962 & 0.0200 & 0 \\ 0 & 0 & 0 & 0 & - 0.0005 & - 0.0001 & 1.0011 & 0.0251 \\ 0 & 0 & - 0.0001 & 0 & - 0.0400 & - 0.0047 & 0.0904 & 1.0102\end{matrix}\right]\end{matrix}$$

In the third and last step thread₁ computes

$${e}^{\frac{0.1}{2} \left({A}_{2} + {A}_{3}\right)} {e}^{0.1 {A}_{2}} {e}^{\frac{0.1}{2} \left({A}_{2} + {A}_{3}\right)} x \left(0\right) =$$

$$\left[\begin{matrix}0.9996 & 0.0500 & 0.0002 & 0 & 0 & 0 & 0 & 0 \\ - 0.0150 & 0.9981 & 0.0100 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0.0001 & 0 & 0.9997 & 0.0166 & 0.0002 & 0 \\ 0 & 0 & 0.0015 & 0.0015 & - 0.0349 & 0.9962 & 0.0200 & 0.0020 \\ 0 & 0 & 0 & 0 & 0 & 0 & 0 & 0 \\ 0 & 0 & 0 & 0 & 0 & 0 & 0 & 0\end{matrix}\right]$$

$$\left[\begin{matrix}0.9996 & 0.0500 & 0.0002 & 0 & 0 & 0 & 0 & 0 \\ - 0.0150 & 0.9981 & 0.0100 & 0.0010 & 0 & 0 & 0 & 0 \\ 0.0005 & 0.0001 & 0.9988 & 0.0499 & 0.0007 & 0.0001 & 0 & 0 \\ 0.0199 & 0.0030 & - 0.0498 & 0.9938 & 0.0298 & 0.0035 & 0.0001 & 0 \\ 0 & 0 & 0.0001 & 0 & 0.9997 & 0.0166 & 0.0002 & 0 \\ 0 & 0 & 0.0150 & 0.0015 & - 0.0349 & 0.9962 & 0.0200 & 0.0020 \\ 0 & 0 & 0 & 0 & 0 & 0 & 1 & 0 \\ 0 & 0 & 0 & 0 & 0 & 0 & 0 & 1\end{matrix}\right]$$

$$\left[\begin{matrix}0.9985 & 0.0998 & 0.0010 & 0.0001 & 0 & 0 & 0 & 0 \\ - 0.0299 & 0.9955 & 0.0199 & 0.0025 & 0 & 0 & 0 & 0 \\ 0.0005 & 0.0001 & 0.9988 & 0.0499 & 0.0007 & 0.0001 & 0 & 0 \\ 0.0199 & 0.0030 & - 0.0498 & 0.9938 & 0.0298 & 0.0035 & 0.0001 & 0 \\ 0 & 0 & 0.0005 & 0.0001 & 0.9988 & 0.0332 & 0.0007 & 0.0001 \\ 0 & 0 & 0.0298 & 0.0037 & - 0.0697 & 0.9919 & 0.0398 & 0.0040 \\ 0 & 0 & 0 & 0 & 0 & 0 & 1 & 0 \\ 0 & 0 & 0 & 0 & 0 & 0 & 0 & 1\end{matrix}\right]$$

thread₂ computes

$${e}^{\frac{0.1}{2} {A}_{3}} {e}^{0.1 \left({A}_{2} + {A}_{4}\right)} {e}^{\frac{0.1}{2} {A}_{3}} x \left(0\right) =$$

$$= \left[\begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0.0001 & 0 & 0.9997 & 0.0166 & 0.0002 & 0 \\ 0 & 0 & 0.0150 & 0.0015 & - 0.0349 & 0.9962 & 0.0200 & 0.0020 \\ 0 & 0 & 0 & 0 & 0 & 0 & 1 & 0 \\ 0 & 0 & 0 & 0 & 0 & 0 & 0 & 1\end{matrix}\right]$$

$$\begin{matrix}\left[\begin{matrix}1 & 0 & 0 & 0 & 0 & 0 & 0 & 0 \\ 0 & 1 & 0 & 0 & 0 & 0 & 0 & 0 \\ 0.0005 & 0 & 0.9988 & 0.0499 & 0.0007 & 0.0001 & 0 & 0 \\ 0.0199 & 0.0020 & - 0.0498 & 0.9938 & 0.0298 & 0.0035 & 0.0001 & 0 \\ 0 & 0 & 0.0001 & 0 & 0.9997 & 0.0166 & 0.0002 & 0 \\ 0 & 0 & 0.0150 & 0.0015 & - 0.0349 & 0.9962 & 0.0200 & 0.0020 \\ 0 & 0 & 0 & 0 & - 0.0005 & - 0.0001 & 1.0011 & 0.0251 \\ 0 & 0 & - 0.0001 & 0 & - 0.0400 & - 0.0047 & 0.0904 & 1.0102\end{matrix}\right] \\ =\end{matrix}$$

$$\left[\begin{matrix}1 & 0 & 0 & 0 & 0 & 0 & 0 & 0 \\ 0 & 1 & 0 & 0 & 0 & 0 & 0 & 0 \\ 0.0005 & 0 & 0.9988 & 0.0499 & 0.0007 & 0.0001 & 0 & 0 \\ 0.0199 & 0.0020 & - 0.0498 & 0.9938 & 0.0298 & 0.0035 & 0.0001 & 0 \\ 0 & 0 & 0.0005 & 0.0001 & 0.9988 & 0.0332 & 0.0007 & 0.0001 \\ 0 & 0 & 0.0298 & 0.0037 & - 0.0698 & 0.09919 & 0.0400 & 0.0045 \\ 0 & 0 & 0 & 0 & - 0.0005 & - 0.0001 & 1.0011 & 0.0251 \\ 0 & 0 & - 0.0001 & 0 & - 0.0400 & - 0.0047 & 0.0904 & 1.0102\end{matrix}\right]$$

The solution is distributed among the threads, indeed the first four rows of thread₁ provides the solution for the first four state variables [x₁,x₂,x₃,x₄] while the last four rows of thread₂ gives the solution for the last four state variables [x₅,x₆,x₇,x₈]

$$x \left(0.1\right) = \left\{\begin{matrix}{e}^{\frac{0.1}{2} \left({A}_{1} + {A}_{3}\right)} {e}^{0.1 {A}_{2}} {e}^{\frac{0.1}{2} \left({A}_{1} + {A}_{3}\right)} x \left(0\right) f o r \left[{x}_{1} , {x}_{2} , {x}_{3} , {x}_{4}\right] \\ {e}^{\frac{0.1}{2} {A}_{3}} {e}^{0.1 \left({A}_{2} + {A}_{4}\right)} {e}^{\frac{0.1}{2} {A}_{3}} x \left(0\right) f o r \left[{x}_{5} , {x}_{6} , {x}_{7} , {x}_{8}\right]\end{matrix}\right)$$

Note that the

$${e}^{\frac{0.1}{2} \left({A}_{1} + {A}_{3}\right)} {e}^{0.1 {A}_{2}} {e}^{\frac{0.1}{2} \left({A}_{1} + {A}_{3}\right)}$$

and

$${e}^{\frac{0.1}{2} {A}_{3}} {e}^{0.1 \left({A}_{2} + {A}_{4}\right)} {e}^{\frac{0.1}{2} {A}_{3}}$$

have been computed and therefore it is possible to proceed in computing the next time instant by multiplying those matrices for the previous states.

The solution at the time instant x(2 δ) = x(0.2) is given by

$$x \left(0.2\right) = \left\{\begin{matrix}{e}^{\frac{0.1}{2} \left({A}_{1} + {A}_{3}\right)} {e}^{0.1 {A}_{2}} {e}^{\frac{0.1}{2} \left({A}_{1} + {A}_{3}\right)} x \left(0.1\right) f o r \left[{x}_{1} , {x}_{2} , {x}_{3} , {x}_{4}\right] \\ {e}^{\frac{0.1}{2} {A}_{3}} {e}^{0.1 \left({A}_{2} + {A}_{4}\right)} {e}^{\frac{0.1}{2} {A}_{3}} x \left(0.1\right) f o r \left[{x}_{5} , {x}_{6} , {x}_{7} , {x}_{8}\right]\end{matrix}\right)$$

And so on

$$x \left(0.3\right) = \left\{\begin{matrix}{e}^{\frac{0.1}{2} \left({A}_{1} + {A}_{3}\right)} {e}^{0.1 {A}_{2}} {e}^{\frac{0.1}{2} \left({A}_{1} + {A}_{3}\right)} x \left(0.2\right) f o r \left[{x}_{1} , {x}_{2} , {x}_{3} , {x}_{4}\right] \\ {e}^{\frac{0.1}{2} {A}_{3}} {e}^{0.1 \left({A}_{2} + {A}_{4}\right)} {e}^{\frac{0.1}{2} {A}_{3}} x \left(0.2\right) f o r \left[{x}_{5} , {x}_{6} , {x}_{7} , {x}_{8}\right]\end{matrix}\right)$$

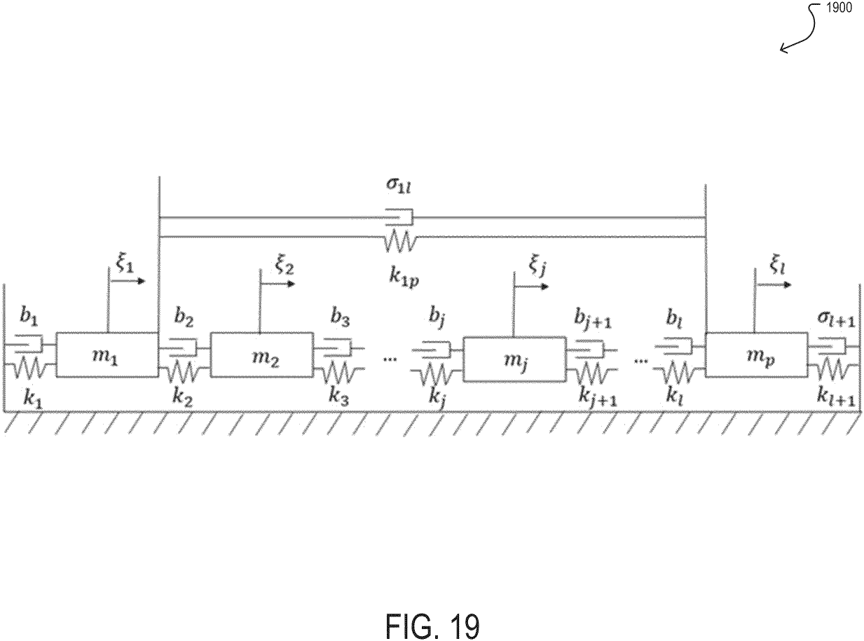

Let m₁, m₂, ..., mₗ, be 2l masses. The system is equal to the model shown above with the only difference that the first mass is connected to the second mass but also with the last mass that has an even index as shown, for example, in FIG. 19.

FIG. 19 shows an example of a mass-spring-damper system with a first and last mass connected according to an example of the instant disclosure.

$$\left[\begin{matrix}{x}_{1} \\ {\dot{x}}_{2} \\ {\dot{x}}_{3} \\ {\dot{x}}_{4} \\ {\dot{x}}_{5} \\ {\dot{x}}_{6} \\ ⋮ \\ {\dot{x}}_{n - 1} \\ {\dot{x}}_{n}\end{matrix}\right] =$$

$$\left[\begin{matrix}0 & \frac{1}{{m}_{1}} & 0 & 0 & 0 & 0 & ⋯ & 0 & 0 \\ - {k}_{1} - {k}_{2} - {k}_{1 l} & - {b}_{1} - {b}_{2} & {k}_{2} & {b}_{2} & 0 & 0 & ⋯ & 0 & 0 \\ 0 & 0 & 0 & \frac{1}{{m}_{2}} & 0 & 0 & ⋯ & 0 & 0 \\ {k}_{2} & {b}_{2} & - {k}_{2} - {k}_{3} & - {b}_{2} - {b}_{3} & {k}_{3} & {b}_{3} & ⋯ & 0 & 0 \\ 0 & 0 & 0 & 0 & 0 & \frac{1}{{m}_{3}} & ⋯ & 0 & 0 \\ 0 & 0 & {k}_{3} & {σ}_{3} & - {k}_{3} - {k}_{4} & - {b}_{3} - {b}_{4} & ⋯ & 0 & 0 \\ ⋮ & ⋮ & ⋮ & ⋮ & ⋮ & ⋮ & ⋱ & ⋮ & ⋮ \\ 0 & 0 & 0 & 0 & 0 & 0 & ⋯ & 0 & 0 \\ {k}_{1 l} & {b}_{1 l} & 0 & 0 & 0 & 0 & ⋯ & - {k}_{1 l} - {k}_{1} - {k}_{l + 1} & - {b}_{1 l} - {b}_{l} - {b}_{l + 1}\end{matrix}\right]$$

$$\left[\begin{matrix}{x}_{1} \\ {x}_{2} \\ {x}_{2} \\ {x}_{3} \\ {x}_{4} \\ {x}_{5} \\ {x}_{6} \\ ⋮ \\ {x}_{n - 1} \\ {x}_{n}\end{matrix}\right]$$

If the matrix A is split in l matrices A₁, A₂, A₃, ... Aₗ constructed in the following manner:

$${A}_{1} = \left[\begin{matrix}0 & \frac{1}{{m}_{1}} & 0 & 0 & 0 & ⋯ & 0 & 0 \\ - {k}_{1} - {k}_{2} - {k}_{1 l} & - {b}_{1} - {b}_{2} - {b}_{1 l} & {k}_{2} & {b}_{2} & 0 & ⋯ & {k}_{1 l} & {b}_{1 l} \\ 0 & 0 & 0 & 0 & 0 & ⋯ & 0 & 0 \\ 0 & 0 & 0 & 0 & 0 & ⋯ & 0 & 0 \\ 0 & 0 & 0 & 0 & 0 & ⋯ & 0 & 0 \\ ⋮ & ⋮ & ⋮ & ⋮ & ⋮ & ⋱ & ⋮ & ⋮ \\ 0 & 0 & 0 & 0 & 0 & 0 & 0 & 0 \\ 0 & 0 & 0 & 0 & 0 & 0 & 0 & 0\end{matrix}\right] ,$$

$${A}_{2} = \left[\begin{matrix}0 & 0 & 0 & 0 & 0 & 0 & ⋯ & 0 \\ 0 & 0 & 0 & 0 & 0 & 0 & ⋯ & 0 \\ 0 & 0 & 0 & \frac{1}{{m}_{2}} & 0 & 0 & ⋯ & 0 \\ {k}_{2} & {b}_{2} & - {k}_{2} - {k}_{3} & - {b}_{2} - {b}_{3} & {k}_{3} & {b}_{3} & ⋯ & 0 \\ 0 & 0 & 0 & 0 & 0 & 0 & ⋯ & 0 \\ 0 & 0 & 0 & 0 & 0 & 0 & ⋯ & 0 \\ ⋮ & ⋮ & ⋮ & ⋮ & ⋮ & ⋮ & ⋱ & ⋮ \\ 0 & 0 & 0 & 0 & 0 & 0 & ⋯ & 0\end{matrix}\right] ,$$

$${A}_{3} = \left[\begin{matrix}0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & 0 & ⋯ & 0 \\ 0 & 0 & 0 & 0 & 0 & \frac{1}{{m}_{3}} & ⋯ & 0 \\ 0 & 0 & {k}_{3} & {b}_{3} & - {k}_{3} - {k}_{4} & {b}_{3} - {b}_{4} & ⋯ & 0 \\ ⋮ & ⋮ & ⋮ & ⋮ & ⋮ & ⋮ & ⋱ & ⋮ \\ 0 & 0 & 0 & 0 & 0 & 0 & ⋯ & 0\end{matrix}\right] , ⋯$$

$${A}_{l} = \left[\begin{matrix}0 & 0 & ⋯ & 0 & 0 & 0 & 0 & 0 \\ 0 & 0 & ⋯ & 0 & 0 & 0 & 0 & 0 \\ 0 & 0 & ⋯ & 0 & 0 & 0 & 0 & 0 \\ 0 & 0 & ⋯ & 0 & 0 & 0 & 0 & 0 \\ 0 & 0 & ⋯ & 0 & 0 & 0 & 0 & 0 \\ ⋮ & ⋮ & ⋱ & ⋮ & ⋮ & ⋮ & ⋮ & ⋮ \\ 0 & 0 & ⋯ & 0 & 0 & 0 & 0 & \frac{1}{{m}_{l}} \\ {k}_{1 l} & {b}_{1 l} & ⋯ & 0 & {k}_{l} & {b}_{l} & - {k}_{l} - {k}_{l + 1} & - {b}_{l} - {b}_{l + 1}\end{matrix}\right]$$

Their sum is equal to the matrix A:

$$A = {A}_{1} + {A}_{2} + {A}_{3} + ⋯ + {A}_{l} {\sum }_{j = 1}^{l} {A}_{j} = {\sum }_{j e v e n}^{l} {A}_{j} + {\sum }_{j o d d}^{l} {A}_{j}$$

And the matrices with odd indexes do not commute with the matrices having even indexes but all the matrices with odd indices commute each other as well as all the even matrices:

$$\left[{A}_{j ,} {A}_{j - 1}\right] \neq 0 , \left[{A}_{j} , {A}_{j + 1}\right] \neq 0 ∀ j$$

$$\left[{A}_{1} , {A}_{l}\right] \neq 0$$

$$\left[{A}_{j} , {A}_{k}\right] = 0 ∀ j o d d , ∀ k o d d$$

$$\left[{A}_{j} , {A}_{k}\right] = 0 ∀ j e v e n , ∀ k e v e n$$

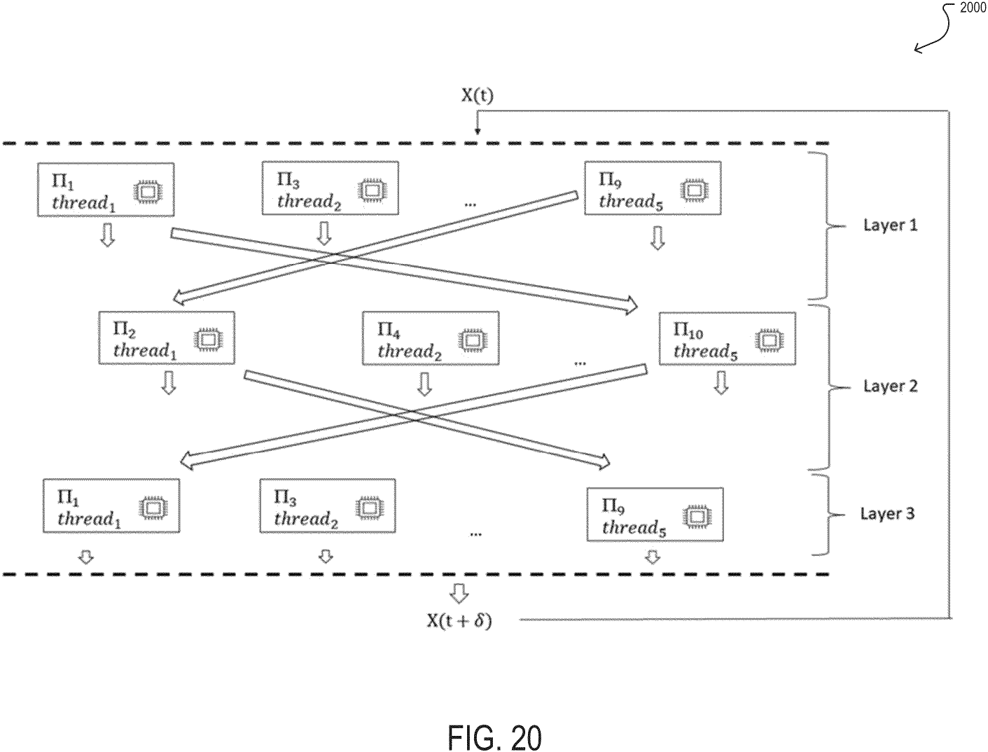

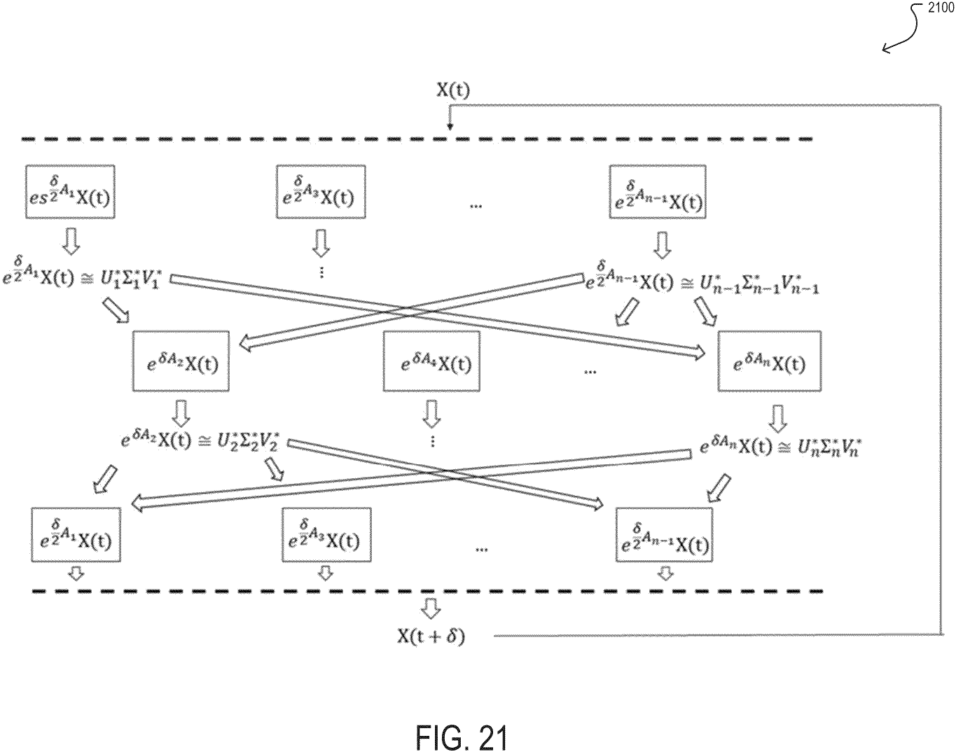

The parallel implementation of this example may use communication not only between adjacent threads but also between the first and last thread as shown in FIG. 20 and FIG. 21.

FIG. 20 shows communication 2000 between threads when A is not a band matrix and a Suzuki Trotter decomposition 2^{nd} order approximant according to an example of the instant disclosure. Ten masses and five threads are considered.

FIG. 21 shows parallel implementation of the Suzuki Trotter decomposition 2^{nd} order approximant when the first and last mass are connected 2100 according to an example of the instant disclosure.

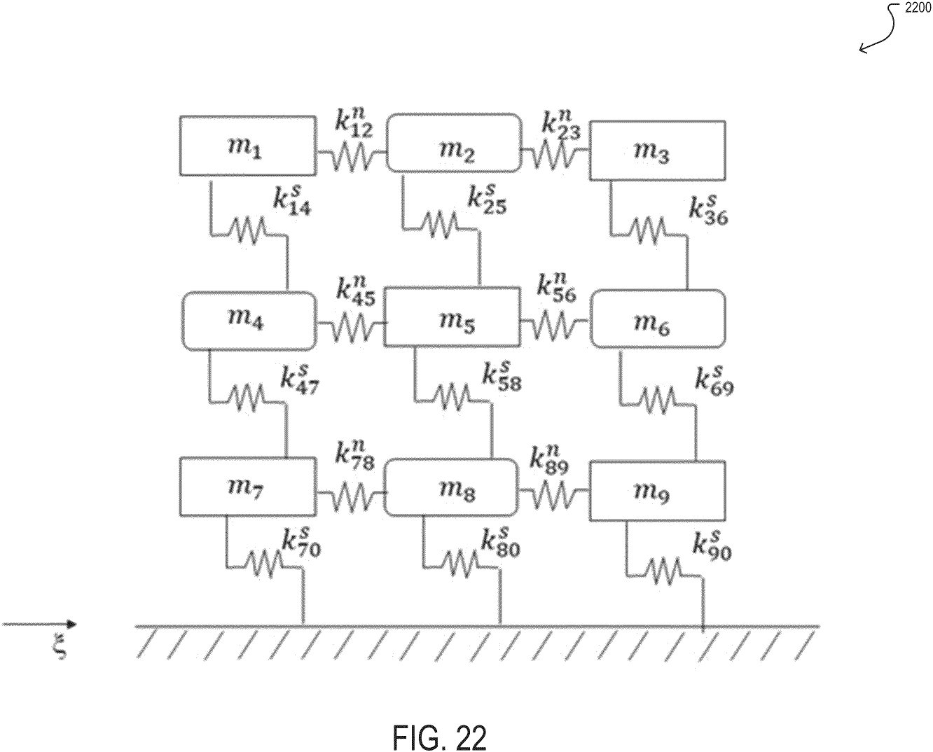

As an example, a system on a surface may have nine masses and there is no dumping. Furthermore, the masses form a mesh whose basic elements are square as shown in FIG. 22.

FIG. 22 shows an example of a two-dimensional lattice model with nine masses and no dumping 2200 according to an example of the instant disclosure.

Every mass with an even index can be connected to a mass with an odd index and vice versa. The system can be mathematically formulated as a system of nine second order differential equations:

$$\left[\begin{matrix}{m}_{1} & 0 & ⋯ & 0 \\ 0 & {m}_{2} & ⋯ & 0 \\ ⋮ & ⋮ & ⋱ & ⋮ \\ 0 & 0 & ⋯ & {m}_{9}\end{matrix}\right] \left[\begin{matrix}{\ddot{ξ}}_{1} \\ {\ddot{ξ}}_{2} \\ ⋮ \\ {\ddot{ξ}}_{9}\end{matrix}\right] +$$

$$\left[\begin{matrix}{k}_{12}^{n} + {k}_{14}^{s} & 0 & ⋯ & 0 \\ 0 & {k}_{12}^{n} + {k}_{23}^{n} + {k}_{25}^{s} & ⋯ & 0 \\ ⋮ & ⋮ & ⋱ & ⋮ \\ 0 & 0 & ⋯ & {k}_{89}^{n} + {k}_{69}^{s} + {k}_{90}^{s}\end{matrix}\right] \left[\begin{matrix}{ξ}_{1} \\ {ξ}_{2} \\ ⋮ \\ {ξ}_{p}\end{matrix}\right] = \left[\begin{matrix}0 \\ 0 \\ ⋮ \\ 0\end{matrix}\right]$$

In a state space representation, it becomes a system of eighteen first order differential equations and therefore:

$$\left[\begin{matrix}{\dot{x}}_{1} \\ {\dot{x}}_{2} \\ {\dot{x}}_{3} \\ {\dot{x}}_{4} \\ {\dot{x}}_{5} \\ {\dot{x}}_{6} \\ {\dot{x}}_{7} \\ {\dot{x}}_{8} \\ {\dot{x}}_{9} \\ ⋮ \\ {\dot{x}}_{18}\end{matrix}\right] =$$

$$\left[\begin{matrix}0 & \frac{1}{{m}_{1}} & 0 & 0 & 0 & 0 & 0 & 0 & 0 & 0 & ⋯ & 0 \\ - {k}_{12}^{n} - {k}_{14}^{s} & 0 & {k}_{12}^{n} & 0 & 0 & 0 & {k}_{14}^{s} & 0 & 0 & 0 & ⋯ & 0 \\ 0 & 0 & 0 & \frac{1}{{m}_{2}} & 0 & 0 & 0 & 0 & 0 & 0 & ⋯ & 0 \\ {k}_{12}^{n} & 0 & - {k}_{12}^{n} - {k}_{23}^{n} - {k}_{25}^{s} & 0 & {k}_{23}^{n} & 0 & 0 & 0 & {k}_{25}^{s} & 0 & ⋯ & 0 \\ 0 & 0 & 0 & 0 & 0 & \frac{1}{{m}_{3}} & 0 & 0 & 0 & 0 & ⋯ & 0 \\ 0 & 0 & {k}_{23}^{n} & 0 & - {k}_{23}^{n} - {k}_{36}^{s} & 0 & 0 & 0 & 0 & 0 & ⋯ & 0 \\ 0 & 0 & 0 & 0 & 0 & 0 & 0 & \frac{1}{{m}_{4}} & 0 & 0 & ⋯ & 0 \\ {k}_{14}^{s} & 0 & 0 & 0 & 0 & 0 & - {k}_{45}^{n} - {k}_{14}^{s} - {k}_{47}^{s} & 0 & 0 & 0 & ⋯ & 0 \\ 0 & 0 & 0 & 0 & 0 & 0 & 0 & 0 & 0 & \frac{1}{{m}_{5}} & ⋯ & 0 \\ ⋮ & ⋮ & ⋮ & ⋮ & ⋮ & ⋮ & ⋮ & ⋮ & ⋮ & ⋮ & ⋱ & ⋮ \\ 0 & 0 & 0 & 0 & 0 & 0 & 0 & 0 & 0 & 0 & ⋯ & \frac{1}{{m}_{9}} \\ 0 & 0 & 0 & 0 & 0 & 0 & 0 & 0 & 0 & 0 & ⋯ & 0\end{matrix}\right] \left[\begin{matrix}{x}_{1} \\ {x}_{2} \\ {x}_{3} \\ {x}_{4} \\ {x}_{5} \\ {x}_{6} \\ {x}_{7} \\ {x}_{8} \\ {x}_{9} \\ ⋮ \\ {x}_{18}\end{matrix}\right]$$

If the matrix A is split in nine matrices A₁, A₂, A₃, ... A₉ which are constructed in the following manner

$${A}_{1} = \left[\begin{matrix}0 & \frac{1}{{m}_{1}} & 0 & 0 & 0 & 0 & 0 & 0 & 0 & 0 & ⋯ & 0 \\ - {k}_{12}^{n} - {k}_{14}^{s} & 0 & {k}_{12}^{n} & 0 & 0 & 0 & {k}_{14}^{s} & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ ⋮ & ⋮ & ⋮ & ⋮ & ⋮ & ⋮ & ⋮ & ⋮ & ⋮ & ⋮ & ⋱ & ⋮ \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0\end{matrix}\right]$$

$$\begin{matrix}{A}_{2} = \\ \left[\begin{matrix}0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & \frac{1}{{m}_{2}} & 0 & 0 & 0 & 0 & 0 & 0 & ⋯ & 0 \\ {k}_{12}^{n} & 0 & - {k}_{12}^{n} - {k}_{23}^{n} - {k}_{25}^{s} & 0 & {k}_{23}^{n} & 0 & 0 & 0 & {k}_{25}^{s} & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0 \\ ⋮ & ⋮ & ⋮ & ⋮ & ⋮ & ⋮ & ⋮ & ⋮ & ⋮ & ⋮ & ⋱ & ⋮ \\ 0 & 0 & 0 & 0 & 0 & 0 & 0 & 0 & 0 & 0 & ⋯ & 0 \\ 0 & 0 & 0 & 0 & 0 & 0 & 0 & 0 & 0 & 0 & ⋯ & 0\end{matrix}\right]\end{matrix}$$

$${A}_{9} = \left[\begin{matrix}0 & ⋯ & 0 & ⋯ & 0 & 0 & 0 & 0 \\ 0 & ⋯ & 0 & ⋯ & 0 & 0 & 0 & 0 \\ 0 & ⋯ & 0 & ⋯ & 0 & 0 & 0 & 0 \\ 0 & ⋯ & 0 & ⋯ & 0 & 0 & 0 & 0 \\ 0 & ⋯ & 0 & ⋯ & 0 & 0 & 0 & 0 \\ ⋮ & ⋮ & 0 & ⋮ & ⋮ & ⋮ & ⋮ & ⋮ \\ 0 & ⋯ & 0 & ⋯ & 0 & 0 & 0 & \frac{1}{{m}_{9}} \\ 0 & ⋯ & {k}_{69}^{s} & ⋯ & {k}_{89}^{n} & 0 & - {k}_{89}^{n} - {k}_{69}^{s} - {k}_{90}^{s} & 0\end{matrix}\right]$$

Their sum can be equal to the matrix A.

$$A = {A}_{1} + {A}_{2} + {A}_{3} + ⋯ + {A}_{9} = {\sum }_{j = 1}^{9} {A}_{j} = {\sum }_{j e v e n}^{9} {A}_{j} + {\sum }_{j o d d}^{9} {A}_{j}$$

Furthermore, any matrix with an odd index does not commute with at least one matrix having an even index but all the matrices with odd indices may commute each other as well as all the even indexes matrices:

$$\begin{matrix}∃ \text{i} \text{} ∈ e v e n , j ∈ o d d & s u c h a s & \left[{A}_{i} , {A}_{j}\right] \neq 0\end{matrix}$$

$$\begin{matrix}\left[{A}_{i} , {A}_{j}\right] = 0 & ∀ i e v e n , ∀ j e v e n\end{matrix}$$

$$\begin{matrix}\left[{A}_{i} , {A}_{j}\right] = 0 & ∀ i o d d , ∀ j o d d\end{matrix}$$

These properties are a consequence that every mass with an odd index is connected to a mass with an even index and vice versa. For instance, noting that m₁ is connected to m₂ and m4:

$$\left[{A}_{1} , {A}_{2}\right] \neq 0 , \left[{A}_{1} , {A}_{3}\right] = 0 , \left[{A}_{1} , {A}_{4}\right] \neq 0 , \left[{A}_{1} , {A}_{5}\right] = 0 , … \left[{A}_{1} , {A}_{9}\right] = 0$$

It is possible to build a commutation matrix C such as the element C(i,j) is equal to:

$$\begin{matrix}\begin{matrix}C \left(i , j\right) = 0 ⇔ \left[{A}_{i} , {A}_{j}\right] = 0 \\ C \left(i , j\right) = 1 ⇔ \left[{A}_{i} , {A}_{j}\right] \neq 0\end{matrix} & ∀ \left(i , j\right) ∈ {\left\{1 , 2 , 3 , 4 , 5 , 6 , 7 , 8 , 9\right\}}^{2}\end{matrix}$$

The matrix C is therefore:

$$C = \left[\begin{matrix}0 & 1 & 0 & 1 & 0 & 0 & 0 & 0 & 0 \\ 1 & 0 & 1 & 0 & 1 & 0 & 0 & 0 & 0 \\ 0 & 1 & 0 & 0 & 0 & 1 & 0 & 0 & 0 \\ 1 & 0 & 0 & 0 & 1 & 0 & 1 & 0 & 0 \\ 0 & 1 & 0 & 1 & 0 & 1 & 0 & 1 & 0 \\ 0 & 0 & 1 & 0 & 1 & 0 & 0 & 0 & 1 \\ 0 & 0 & 0 & 1 & 0 & 0 & 0 & 1 & 0 \\ 0 & 0 & 0 & 0 & 1 & 0 & 1 & 0 & 1 \\ 0 & 0 & 0 & 0 & 0 & 1 & 0 & 1 & 0\end{matrix}\right]$$

The two sets Ξ₁ and Ξ₂ of non-commuting terms are therefore made of the matrices constituted by the following elements:

$${\text{Ξ}}_{1} ≡ \left\{{A}_{1} , {A}_{3} , {A}_{5} , {A}_{7} , {A}_{9}\right\}$$

$${\text{Ξ}}_{2} ≡ \left\{{A}_{2} , {A}_{4} , {A}_{6} , {A}_{8}\right\}$$

The model can be extended by considering twelve masses as shown, for example, in Figure.

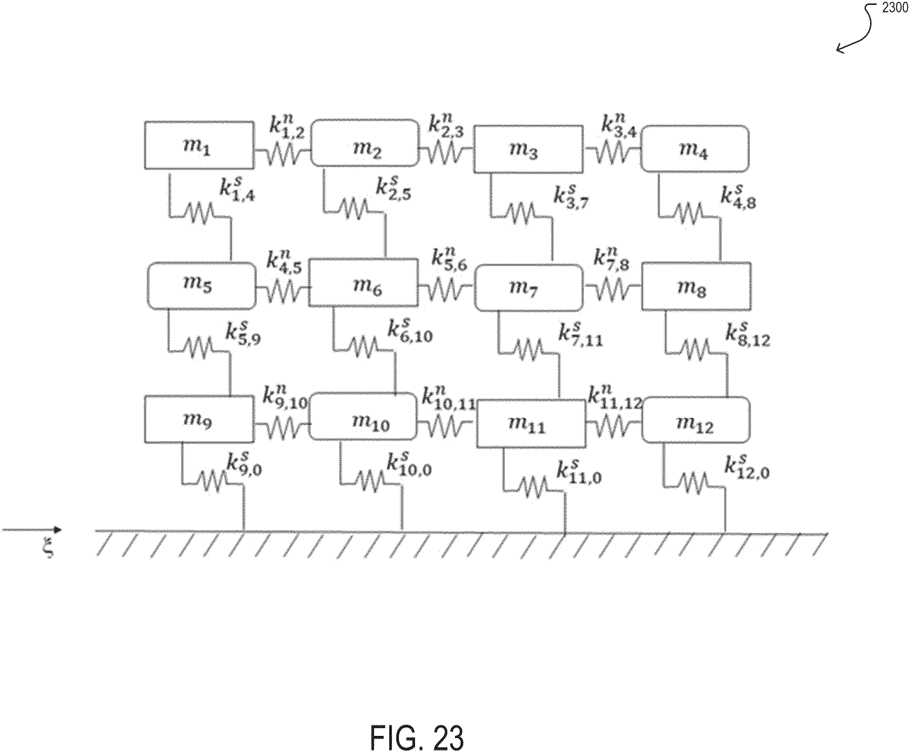

FIG. 23 shows an example of a two-dimensional lattice with twelve masses connected through square elements 2300 according to an example of the instant disclosure.

In this case even and odd indexes do not define the sets, for instance [A₁, A₅] ≠ 0. A possibility of two non-commuting sets Ξ₁ and Ξ₂ is the following:

$${\text{Ξ}}_{1} ≡ \left\{{A}_{1} , {A}_{3} , {A}_{6} , {A}_{8} , {A}_{9} , {A}_{11}\right\}$$

$${\text{Ξ}}_{2} ≡ \left\{{A}_{2} , {A}_{4} , {A}_{5} , {A}_{7} , {A}_{10} , {A}_{12}\right\}$$

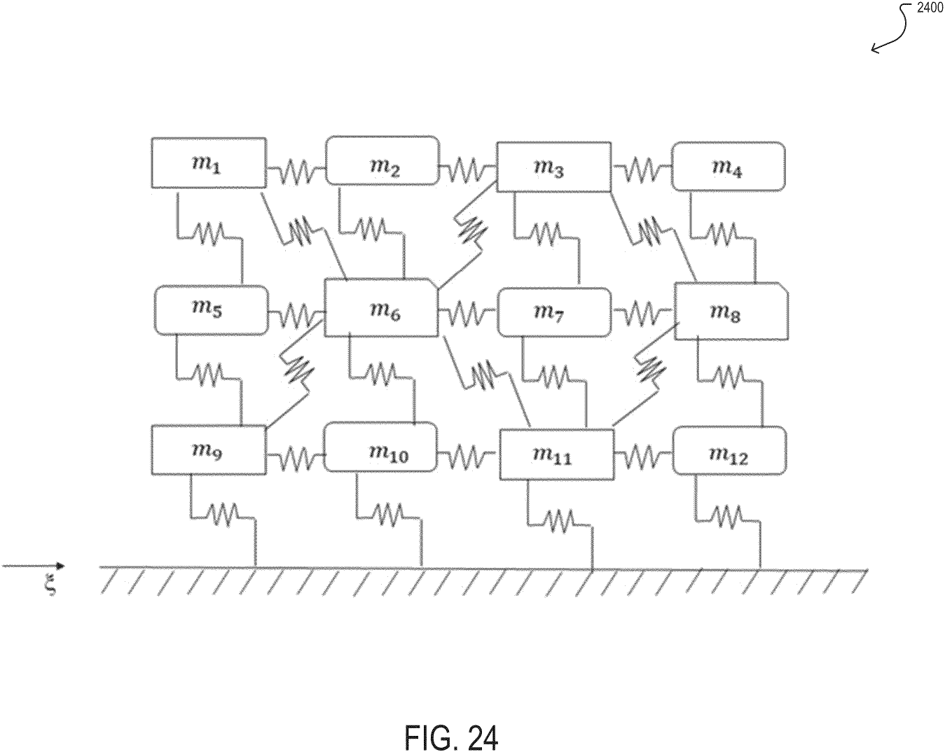

Masses connected through triangles are shown in FIG. 24. In this instance, there may be at least three sets of non-commuting terms.

FIG. 24 shows an example of two-dimensional lattice with twelve masses connected through triangular elements 2400 according to an example of the instant disclosure.

For instance, a possibility of three non-commuting sets Ξ₁,Ξ₂ and Ξ₃ are those constituted by the following elements

$${\text{Ξ}}_{1} ≡ \left\{{A}_{1} , {A}_{3} , {A}_{9} , {A}_{11}\right\} ,$$

$${\text{Ξ}}_{2} ≡ \left\{{A}_{2} , {A}_{4} , {A}_{5} , {A}_{7} , {A}_{10} , {A}_{12}\right\} ,$$

$${\text{Ξ}}_{3} = \left\{{A}_{6} , {A}_{8}\right\} .$$

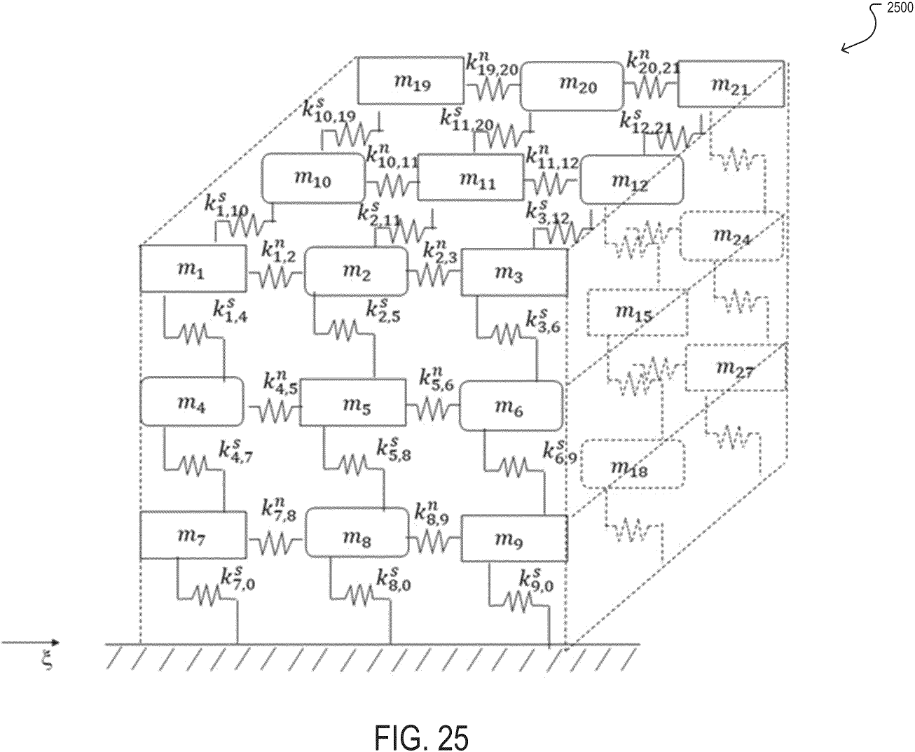

As an example, there may be twenty-seven masses forming a mesh whose basic elements are cubes as depicted in FIG. 25.

FIG. 25 shows an example of a three-dimensional lattice model with twenty-seven masses connected through cube elements 2500 according to an example of the instant disclosure.

Every mass with an even index can be connected to a mass with an odd index and vice versa. Thus, two groups of matrices can be built such as

$$A = {A}_{1} + {A}_{2} + {A}_{3} + ⋯ + {A}_{27} = {\sum }_{j = 1}^{27} {A}_{j} = {\sum }_{j e v e n}^{27} {A}_{j} + {\sum }_{j o d d}^{27} {A}_{j}$$

And also that:

$$\begin{matrix}∃ \text{i} ∈ e v e n , j ∈ o d d s u c h a s \left[{A}_{i} , {A}_{j}\right] \neq 0 \\ ∀ \text{i} ∈ e v e n , j ∈ e v e n \left[{A}_{i} , {A}_{j}\right] = 0 \\ ∀ \text{i} ∈ o d d , j ∈ o d d \left[{A}_{i} , {A}_{j}\right] = 0\end{matrix}$$

Noting that m₁ is connected to m₄, m₂ and m₁₀:

$$\left[{A}_{1} , {A}_{2}\right] \neq 0 , \left[{A}_{1} , {A}_{3}\right] = 0 , \left[{A}_{1} , {A}_{4}\right] \neq 0 , \left[{A}_{1} , {A}_{5}\right] = 0 , … \left[{A}_{1} , {A}_{10}\right] \neq 0 , …$$

The two non-commuting sets Ξ₁ and Ξ₂ are made of the elements characterised by even and odd indexes, respectively. Therefore:

$${\text{Ξ}}_{1} ≡ \left\{{A}_{1} , {A}_{3} , {A}_{5} , {A}_{7} , {A}_{9} , {A}_{11} , {A}_{13} , {A}_{15} , {A}_{17} , {A}_{19} , {A}_{21} , {A}_{23} , {A}_{25} , {A}_{27}\right\} ,$$

$${\text{Ξ}}_{2} ≡ \left\{{A}_{2} , {A}_{4} , {A}_{6} , {A}_{8} , {A}_{10} , {A}_{12} , {A}_{14} , {A}_{16} , {A}_{18} , {A}_{20} , {A}_{22} , {A}_{24} , {A}_{26}\right\} .$$

Other basic shapes can be considered as connecting elements of the masses: e.g., when tetrahedrons are considered, at least three non-commuting sets Ξ₁, Ξ₂, Ξ₃ can be considered.

As an example, a system can be expressed in a state space representation:

$$\begin{matrix}\frac{d x \left(t\right)}{d t} = A x \left(t\right) + B u \left(t\right) \\ y \left(t\right) = C x \left(t\right) + D u \left(t\right)\end{matrix} \qquad \text{(7)}$$

The system can have a response to different canonical input signals, such as impulse, step, sine, and cosine. As an example, thanks to the system linearity, the system has single-input and single-output. The system response to any input signal, can be decomposed through Taylor or Fourier series expansions.

The response of the LTI system (7) to an impulse u(t) = cδ(t) of a given amplitude c is:

$$x \left(t\right) = {\int }_{0}^{t} {e}^{A \left(t - τ\right)} B c \text{δ} \left(τ\right) d τ = \left({\int }_{0}^{t} {e}^{A \left(t - τ\right)} \text{δ} \left(τ\right) d τ\right) B c = {e}^{A t} B c , ∀ t \geq 0.$$

Supposing that Bc is equal to x₀, the impulse response can be regarded as a free evolution with initial conditions Bc. The results also hold in case of real impulsive inputs, e.g., finite time duration signals, provided that this duration is sufficiently shorter than the dominant time constant of the recipient dynamic system.

The response of the system to a step input u(t) = u₀1(t) (as shown in Figure) and from an initial condition x₀, is given by:

$$x \left(t\right) = {e}^{A t} \left({x}_{0} - {A}^{- 1} B {u}_{0}\right) - {A}^{- 1} B {u}_{0} , ∀ t \geq 0.$$

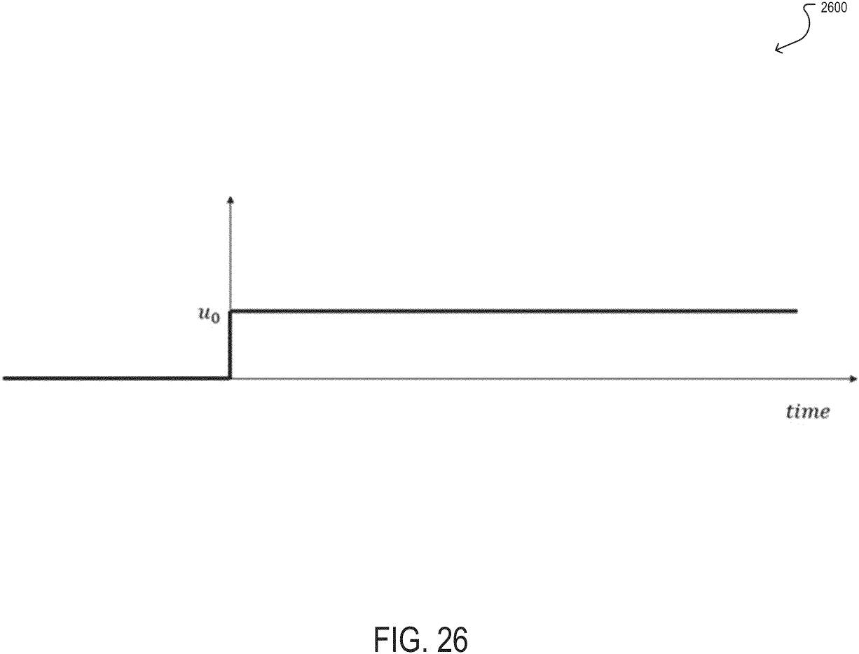

FIG. 26 shows a step force 2600 according to an example of the instant disclosure.

The expression can also be written as the sum of three different addends:

$$x \left(t\right) = {x}_{f} \left(t\right) + {x}_{s} \left(t\right) + {x}_{c} = {e}^{A t} {x}_{0} + {e}^{A t} {A}^{- 1} B {u}_{0} - {A}^{- 1} B {u}_{0} , ∀ t \geq 0.$$

Where:
x_{f}(t) = e^{At}x₀ is the free evolution of the system response starting from the initial condition x₀;
xₛ(t) = e^{At}A⁻¹Bu₀ is the transient time evolution of the system response for the step of amplitude u₀;
x_{c} = -A⁻¹Bu₀ is a constant steady-state term that the system will asymptotically reach in case the system is stable.

The disclosure provides an example of determining the free evolution term e^{Atx}₀. The other two terms, instead, need a remark. They contain the inverse of A and if this matrix is large this calculation may become a burdensome task. Nevertheless, there are parallel algorithms that can efficiently perform this kind of computation and some of them also use GPUs.

Furthermore, the inversion of A can be evaluated only once and it can be done a priori so that this onerous computation is not involved in the time evolution iteration cycles. As a conclusion, matrix A inversion can be easily implemented and does not have a great impact on the overall code computational performance.

The results of many trials can be provided in one computational run, and it can be easily implemented. To do so, the vectors x₀ and B are to be substituted by matrices X(0) and Buₒ because their columns’ vectors are the initial conditions and the step amplitude of the trials. It follows that this equation is to be solved:

$$X \left(t\right) = {e}^{A t} X \left(0\right) + {e}^{A t} {A}^{- 1} B {u}_{0} - {A}^{- 1} B {u}_{0}$$

However, recalling system linearity, all possible combinations of initial conditions and step inputs can be calculated by solving a model in which X(0) and Buₒ are identity matrices. Once this calculation has been formed all the possible combinations can be recast by considering the linear combinations of the free evolution and forced step input solutions.

$$X \left(0\right) = = {\left[\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix}\right]}_{n x n} B {u}_{0} = = {\left[\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix}\right]}_{n x n}$$

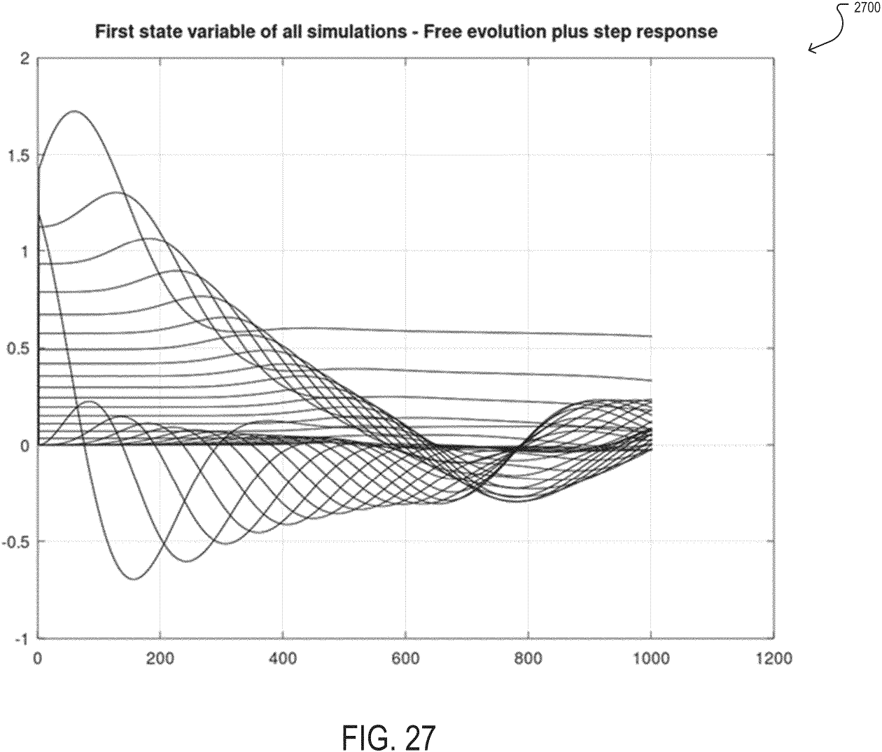

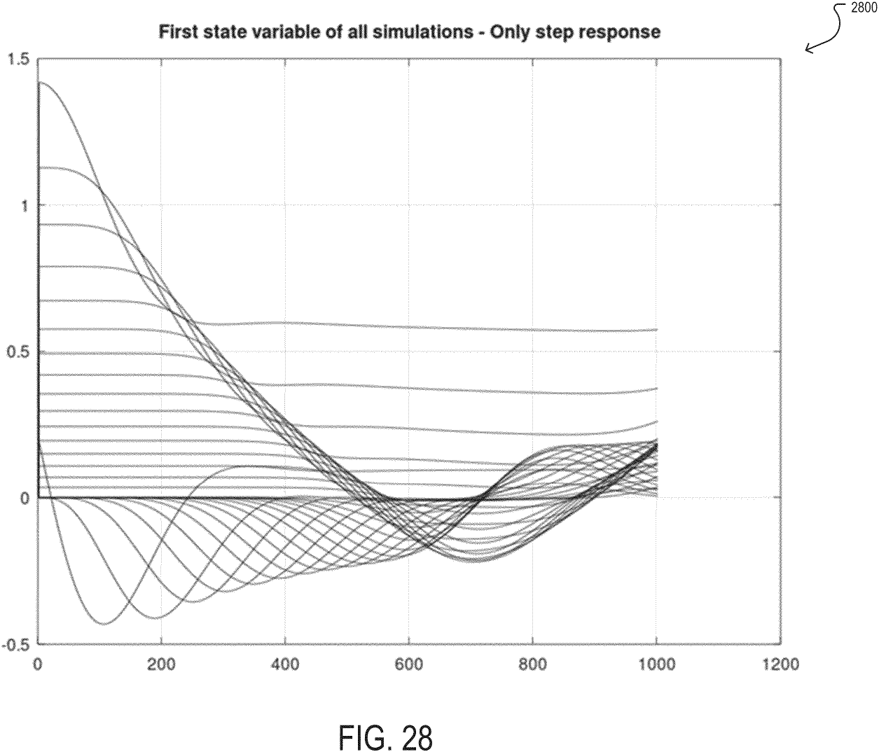

FIG. 27 and FIG. 28 depict the results of the simulation of the one-dimensional mass-spring-damper model with A being a band matrix. FIG. 27 shows system free evolution on which has been added the step response. FIG. 28 depicts only the system’s step response.

FIG. 27 shows free evolution plus step response of the first state variable including all the simulations 2700 according to an example of the instant disclosure.

FIG. 28 shows step response of the first state variable including all the simulations 2800 according to an example of the instant disclosure.

### Exponential Input

Let the input signal be u(t) = e^{µt}1(t) and assume that µ ≠ λᵢ(A), i = 1, ...,n, where λᵢ(A) is the i-th eigenvalue of the matrix A. The complete (free and forced) state response of the LTI system is given by

$$\begin{matrix}x \left(t\right) = {e}^{A t} x \left(0\right) + {\int }_{0}^{t} {e}^{A \left(t - τ\right)} B {e}^{μ \text{} τ} d τ = \\ {e}^{A t} x \left(0\right) + {e}^{A t} {\int }_{0}^{t} {e}^{\left(μ I - A\right) τ} B d τ =\end{matrix}$$

$$= {e}^{A t} x \left(0\right) + {e}^{A t} {\left(μ \text{} I - A\right)}^{- 1} \left({e}^{\left(μ I - A\right) τ} - I\right) B =$$

$$= {e}^{A t} \left(x \left(0\right) - {\left(μ \text{} I - A\right)}^{- 1} B\right) + {\left(μ \text{} I - A\right)}^{- 1} B {e}^{μ \text{} t}$$

Note that, in case of asymptotically stable systems, the state response is composed of a transient term, which resembles a free evolution term, and a steady-state term, which is proportional to the exponential input (pure exponential response).

The response of the LTI system (7) to a sine input signal u(t) = Usin(ωt + α) starting from the initial state x(0) = x₀ is given by:

$$x \left(t\right) = {e}^{A t} \left({x}_{0} - {x}_{\text{ss}} \left(0\right)\right) + {x}_{\text{ss}} \left(t\right) , ∀ t \geq 0 ,$$

With

$${x}_{\text{ss}} \left(t\right) = M \left(ω\right) U s i n \left(ω t + α + φ \left(ω\right)\right)$$

$$M \left(ω\right) = \left|{\left(j ω I - A\right)}^{- 1} B\right|$$

$$φ \left(ω\right) = ∠ {\left(j ω I - A\right)}^{- 1} B$$

Considering a set of initial conditions X(0), the expression becomes:

$$x \left(t\right) = {e}^{A t} \left(X \left(0\right) - {x}_{s s} \left(0\right)\right) + {x}_{s s} \left(t\right) , ∀ t \geq 0.$$

When setting X(0) and B to be the identity matrices:

$$X \left(0\right) = {\left[\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix}\right]}_{n x n} , B = {\left[\begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix}\right]}_{n x n}$$

it is possible to compute all the possible states in one single run.

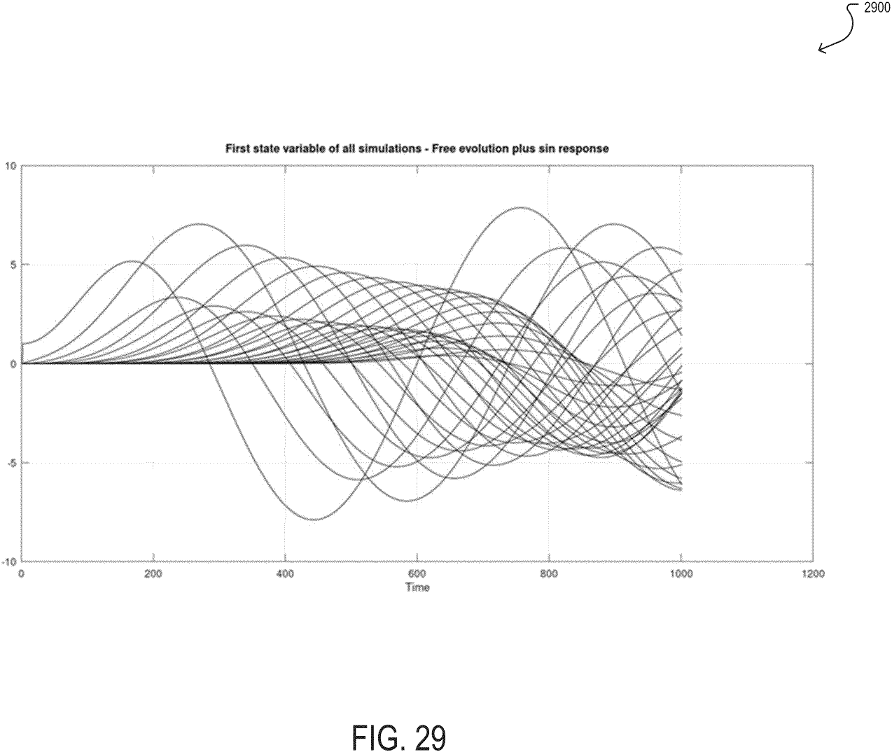

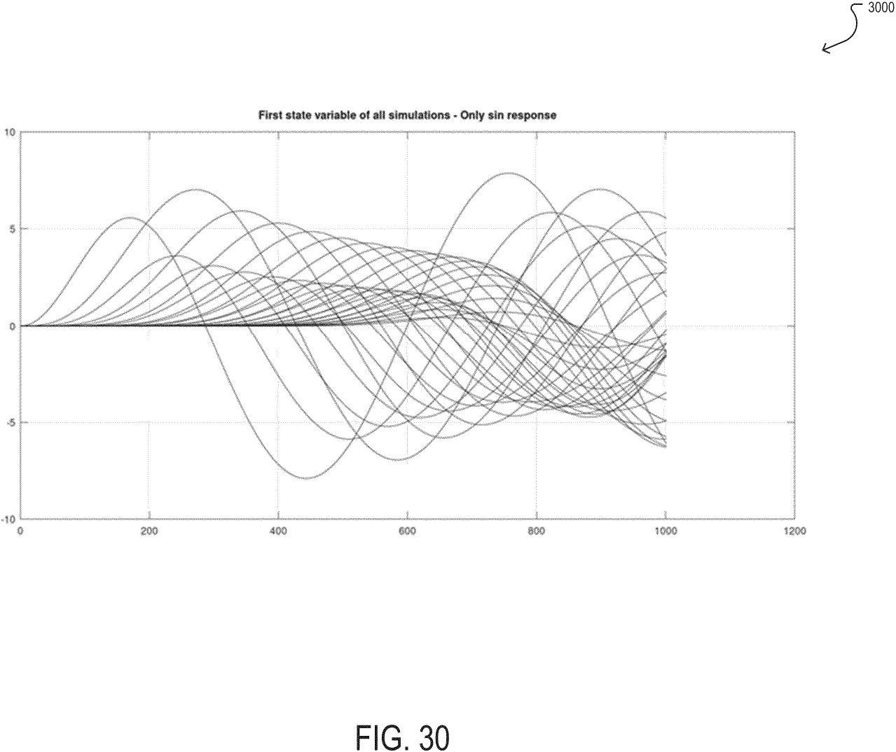

FIG. 29 and FIG. 30 show the results of the simulation of the one-dimensional mass-spring-damper model with A being a band matrix. FIG. 29 shows system free evolution and an added a sine force, and FIG. 30 depicts the system’s sine response.

FIG. 29 shows free evolution plus sine response of the first state variable including all the simulations for ω = 1 2900 according to an example of the instant disclosure.

FIG. 30 shows a sine response of the first state variable including all the simulations for ω = 1 3000 according to an example of the instant disclosure.

As an example, the system is considering linear systems and thus, the superposition principle holds. As a result, it is possible to decompose any input signal u(t) as a sum of basic signals u(t) = u₁(t) + u₂(t) + ⋯ uₙ(t) + ⋯ whose system’s response is rather easy to evaluate. The total system’s response will be therefore the sum of the system’s solution to each basic signal:

$$x \left(t , {u}_{1} \left(t\right)\right) = {x}_{1} \left(t\right)$$

$$x \left(t , {u}_{2} \left(t\right)\right) = {x}_{2} \left(t\right)$$

$$x \left(t , {u}_{1} \left(t\right) + {u}_{2} \left(t\right)\right) = {x}_{1} \left(t\right) + {x}_{2} \left(t\right)$$

Although it is possible to consider signal decomposition in any basis, as an example, the system can decompose the input signal by using the Taylor or Fourier series.

The Taylor series of a signal u(t) with an error of order o(tⁿ⁺¹) is given by:

$$\begin{matrix}u \left(t\right) = u \left({t}_{0}\right) + \frac{{{u}^{′}}^{\left({t}_{0}\right)}}{1 !} \left(t - {t}_{0}\right) + \frac{{{u}^{″}}^{\left({t}_{0}\right)}}{2 !} {\left(t - {t}_{0}\right)}^{2} + ⋯ \frac{{u}^{\left(n\right)} \left({t}_{0}\right)}{2 !} {\left(t - {t}_{0}\right)}^{n} \\ + o \left({t}^{n + 1}\right)\end{matrix}$$

The system response can be computed by summing the system’s response to each single addend of the Taylor series:

$$x \left(t\right) = {\int }_{0}^{t} {e}^{A \left(t - τ\right)} u \left(τ\right) d τ =$$

$$\begin{matrix}= {\int }_{0}^{t} {e}^{A \left(t - \text{τ}\right)} \left(u \left({\text{τ}}_{0}\right) + \frac{{u}^{′} \left({\text{τ}}_{0}\right)}{1 !} \left(\text{τ−} {\text{τ}}_{0}\right) + \frac{{u}^{″} \left({\text{τ}}_{0}\right)}{2 !} {\left(\text{τ−} {\text{τ}}_{0}\right)}^{2} +\right) \\ ⋯ \frac{{u}^{\left(n\right)} \left({\text{τ}}_{0}\right)}{n !} {\left(\text{τ−} {\text{τ}}_{0}\right)}^{n} +\end{matrix}$$

$$\left(o \left({\text{τ}}^{n + 1}\right)\right) d τ =$$

$$\begin{matrix}= {\int }_{0}^{t} {e}^{A \left(t - \text{τ}\right)} u \left({\text{τ}}_{0}\right) + d \text{τ+} {\int }_{0}^{t} {e}^{A \left(t - \text{τ}\right)} \frac{{u}^{′} \left({\text{τ}}_{0}\right)}{1 !} \left(\text{τ−} {\text{τ}}_{0}\right) d \text{τ} + ⋯ {\int }_{0}^{t} {e}^{A \left(t - \text{τ}\right)} \\ \frac{{u}^{\left(n\right)} \left({\text{τ}}_{0}\right)}{n !} \text{τ−}\end{matrix}$$

$${\left({\text{τ}}_{0}\right)}^{n} d \text{τ+} ε$$

The total system response can be therefore decomposed as the sum of the step, ramp, ... etc ... responses.

Almost any periodical signal u(t) can be decomposed by a Fourier series

$$u \left(t\right) = \frac{{a}_{0}}{2} + {\sum }_{n = 1}^{∞} \left({a}_{n} cos \left(n t\right) + {b}_{n} sin \left(n t\right)\right)$$

The system’s response is therefore given by:

$$x \left(t\right) {\int }_{0}^{t} {e}^{A \left(t - \text{τ}\right)} \left(\frac{{a}_{0}}{2} + {\sum }_{n = 1}^{∞} \left({a}_{n} cos \left(n \text{τ}\right) + {b}_{n} sin \left(n \text{τ}\right)\right)\right) d \text{τ=}$$

$$\begin{matrix}= {\int }_{0}^{t} {e}^{A \left(t - \text{τ}\right)} \frac{{a}_{0}}{2} d \text{τ+} {\int }_{0}^{t} {e}^{A \left(t - \text{τ}\right)} {a}_{1} cos \left(\text{τ}\right) d τ + {\int }_{0}^{t} {e}^{A \left(t - \text{τ}\right)} {b}_{1} sin \left(\text{τ}\right) d τ + \\ ⋯\end{matrix}$$

$$⋯ + {\int }_{0}^{t} {e}^{A \left(t - \text{τ}\right)} {a}_{n} cos \left(n \text{τ}\right) d \text{τ} + {\int }_{0}^{t} {e}^{A \left(t - \text{τ}\right)} {b}_{n} sin \left(n \text{τ}\right) d \text{τ} + \text{ε}$$

The system’s response to a periodical signal is the sum of different sine and cosine signals at different (multiple) frequencies. The error ε is given by:

$$\begin{matrix}\text{ε} = {\int }_{0}^{t} {e}^{A \left(t - \text{τ}\right)} {a}_{n + 1} cos \left(\left(n + 1\right) \text{τ}\right) d \text{τ} + {\int }_{0}^{t} {e}^{A \left(t - \text{τ}\right)} {b}_{n + 1} sin \left(\left(n \text{+1}\right) \text{τ}\right) d \text{τ} \\ + ⋯\end{matrix}$$

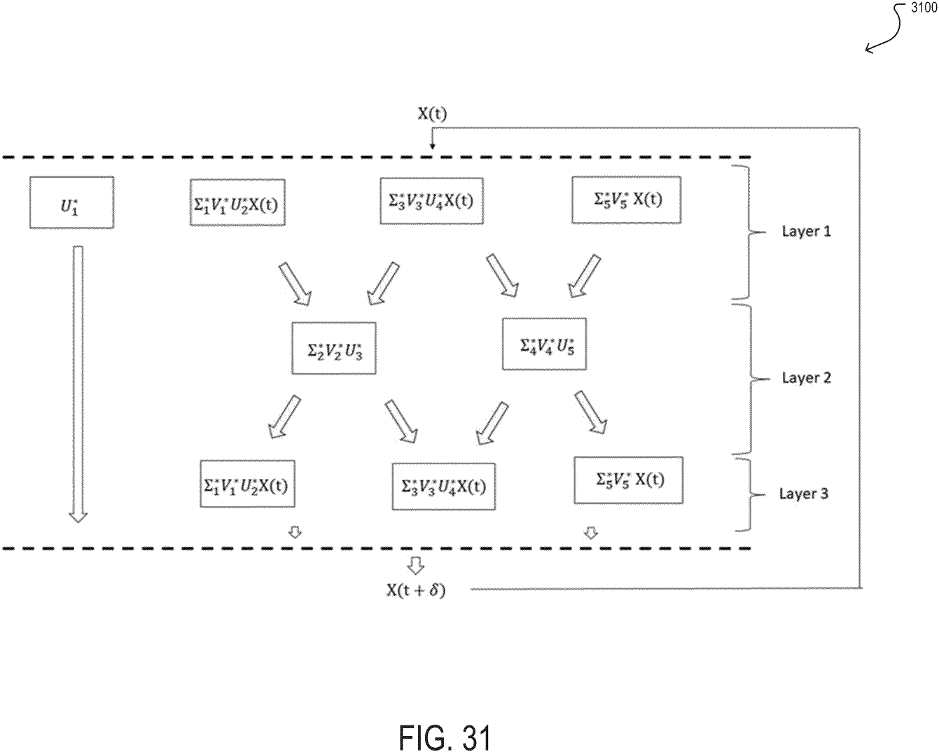

As an example, a finite element method (FEM) having a cantilever beam is modelled as shown in FIG. 31. Let ρ, E and I be the density, Young elasticity module and the moment of inertia of the bar respectively.

The system can provide parallel implementation for a general matrix. As an example, the system may perform parallel implementation with a matrix partitioned into four parts.

The following provides a description of implementation on a parallel manner the matrix exponential for any matrix exploiting the Suzuki Trotter decomposition.

It is possible to consider a matrix Γ partitioned by the following four submatrices A, B, C and D

$$Γ = \left[\begin{matrix}A & B \\ C & D\end{matrix}\right]$$

Without loss of generality matrix Γ can be considered as formed by the following matrices such as

$$Γ = {\sum }_{i = 1}^{3} {A}_{i}$$

$${A}_{1} = \left[\begin{matrix}A & 0 \\ 0 & D\end{matrix}\right] , {A}_{2} = \left[\begin{matrix}0 & B \\ 0 & 0\end{matrix}\right] , {A}_{3} = \left[\begin{matrix}0 & 0 \\ C & 0\end{matrix}\right]$$

It is possible to consider the second order Suzuki Trotter decomposition

$${e}^{x Γ} = {e}^{\frac{x}{2} {A}_{3}} {e}^{\frac{x}{2} {A}_{2}} {e}^{x {A}_{1}} {e}^{\frac{x}{2} {A}_{2}} {e}^{\frac{x}{2} {A}_{3}} + o \left({x}^{3}\right) ≅ {e}^{\frac{x}{2} {A}_{3}} {e}^{\frac{x}{2} {A}_{2}} {e}^{x {A}_{1}} {e}^{\frac{x}{2} {A}_{2}} {e}^{\frac{x}{2} {A}_{3}} =$$

$$= \left[\begin{matrix}I & 0 \\ \frac{x}{2} C & I\end{matrix}\right] \left[\begin{matrix}I & \frac{x}{2} B \\ 0 & I\end{matrix}\right] \left[\begin{matrix}{e}^{x A} & 0 \\ 0 & {e}^{x D}\end{matrix}\right] \left[\begin{matrix}I & \frac{x}{2} B \\ 0 & I\end{matrix}\right] \left[\begin{matrix}I & 0 \\ \frac{x}{2} C & I\end{matrix}\right] =$$

$$= \left[\begin{matrix}I & 0 \\ \frac{x}{2} C & I\end{matrix}\right] \left[\begin{matrix}I & \frac{x}{2} B \\ 0 & I\end{matrix}\right] \left[\begin{matrix}{e}^{x A} & 0 \\ 0 & {e}^{x D}\end{matrix}\right] \left[\begin{matrix}I + \frac{x}{2} B \frac{x}{2} C & \frac{x}{2} B \\ \frac{x}{2} C & I\end{matrix}\right] =$$

$$= \left[\begin{matrix}I & 0 \\ \frac{x}{2} C & I\end{matrix}\right] \left[\begin{matrix}I & \frac{x}{2} B \\ 0 & I\end{matrix}\right] \left[\begin{matrix}{e}^{x A} \left(I + \frac{x}{2} B \frac{x}{2} C\right) & {e}^{x A} \frac{x}{2} B \\ {e}^{x D} \frac{x}{2} C & {e}^{x D}\end{matrix}\right] =$$

$$= \left[\begin{matrix}I & 0 \\ \frac{x}{2} C & I\end{matrix}\right] \left[\begin{matrix}{e}^{x A} \left(I + \frac{x}{2} B \frac{x}{2} C\right) + \frac{x}{2} B {e}^{x D} \frac{x}{2} C & {e}^{x A} \frac{x}{2} B + \frac{x}{2} B {e}^{x D} \\ {e}^{x D} \frac{x}{2} C & {e}^{x D}\end{matrix}\right] =$$

$$\begin{matrix}= \\ \begin{matrix}{e}^{x A} \left(I + \frac{x}{2} B \frac{x}{2} C\right) + \frac{x}{2} B {e}^{x D} \frac{x}{2} C & {e}^{x A} \frac{x}{2} B + \frac{x}{2} B {e}^{x D} \\ \frac{x}{2} C {e}^{x A} \left(I + \frac{x}{2} B \frac{x}{2} C\right) + \frac{x}{2} C \frac{x}{2} B {e}^{x D} \frac{x}{2} C + {e}^{x D} \frac{x}{2} C & \frac{x}{2} C \left({e}^{x A} \frac{x}{2} B + \frac{x}{2} B {e}^{x D}\right) + {e}^{x D}\end{matrix}\end{matrix}$$

The following jobs are allocated to the four threads

$$t h r e a {d}_{1} = {e}^{x A} \left(I + \frac{x}{2} B \frac{x}{2} C\right) + \frac{x}{2} B {e}^{x D} \frac{x}{2} C$$

$$t h r e a {d}_{2} = {e}^{x A} \frac{x}{2} B + \frac{x}{2} B {e}^{x D}$$

$$t h r e a {d}_{3} = \frac{x}{2} C {e}^{x A} \left(I + \frac{x}{2} B \frac{x}{2} C\right) + \frac{x}{2} C \frac{x}{2} B {e}^{x D} \frac{x}{2} C + {e}^{x D} \frac{x}{2} C$$

$$t h r e a {d}_{4} = \frac{x}{2} C \left({e}^{x A} \frac{x}{2} B + \frac{x}{2} B {e}^{x D}\right) + {e}^{x D}$$

The following implementation can be applied to reduce the number of matrices product

$$t h r e a {d}_{1} = {e}^{x A} \left(I + \frac{x}{2} B \frac{x}{2} C\right) + \frac{x}{2} B {e}^{x D} \frac{x}{2} C$$

$$t h r e a {d}_{2} = {e}^{x A} \frac{x}{2} B + {e}^{x A} \frac{x}{2} B {e}^{x D}$$

$$t h r e a {d}_{3} = \frac{x}{2} C \left(t h r e a {d}_{1}\right) + {e}^{x D} \frac{x}{2} C$$

$$t h r e a {d}_{4} = \frac{x}{2} C \left(t h r e a {d}_{2}\right) + {e}^{x D}$$

The matrix exponential is transformed in matrices products, GPUs are therefore a viable hardware solution since they are very powerful to perform this operation.

### Cascade Parallel Implementation

In this implementation, the terms e^{xA} and e^{xD} are approximated by a Suzuki Trotter expansion creating a cascade solution. By denoting

$$\begin{matrix}A = \left[\begin{matrix}{A}_{11} & {A}_{12} \\ {A}_{21} & {A}_{22}\end{matrix}\right] , B = \left[\begin{matrix}{B}_{11} & {B}_{12} \\ {B}_{21} & {B}_{22}\end{matrix}\right] , C = \left[\begin{matrix}{C}_{11} & {C}_{12} \\ {C}_{21} & {C}_{22}\end{matrix}\right] , \\ D = \left[\begin{matrix}{D}_{11} & {D}_{12} \\ {D}_{21} & {D}_{22}\end{matrix}\right]\end{matrix}$$

The matrix Γ is partitioned as follows:

$$Γ = \left[\begin{matrix}A & B \\ C & D\end{matrix}\right] = \left[\begin{matrix}{A}_{11} & {A}_{12} & {B}_{11} & {B}_{12} \\ {A}_{21} & {A}_{22} & {B}_{21} & {B}_{22} \\ {C}_{11} & {C}_{12} & {D}_{11} & {D}_{12} \\ {C}_{21} & {C}_{22} & {D}_{21} & {D}_{22}\end{matrix}\right]$$

$$t h r e a {d}_{1} = {e}^{x A} \left(I + \frac{x}{2} B \frac{x}{2} C\right) + \frac{x}{2} B {e}^{x D} \frac{x}{2} C$$

$$t h r e a {d}_{2} = {e}^{x A} \frac{x}{2} B + {e}^{x A} \frac{x}{2} B {e}^{x D}$$

$$t h r e a {d}_{3} = \frac{x}{2} C \left(t h r e a {d}_{1}\right) + {e}^{x D} \frac{x}{2} C$$

$$t h r e a {d}_{4} = \frac{x}{2} C \left(t h r e a {d}_{2}\right) + {e}^{x D}$$

Denoting by:

$${e}^{x A} = \left[\begin{matrix}{\text{Λ}}_{11} & {\text{Λ}}_{12} \\ {\text{Λ}}_{21} & {\text{Λ}}_{22}\end{matrix}\right]$$

The term e^{xA} can be approximated by using Suzuki Trotter decomposition and therefore:

$${e}^{x A} =$$

$$\left[\begin{matrix}{e}^{x {A}_{11}} \left(I + \frac{x}{2} {A}_{12} \frac{x}{2} {A}_{21}\right) + \frac{x}{2} {A}_{12} {e}^{x {A}_{22}} \frac{x}{2} {A}_{21} & {e}^{x {A}_{11}} \frac{x}{2} {A}_{12} + \frac{x}{2} {A}_{12} {e}^{x {A}_{22}} \\ \frac{x}{2} {A}_{21} {e}^{x {A}_{11}} \left(I + \frac{x}{2} {A}_{12} \frac{x}{2} {A}_{21}\right) + \frac{x}{2} {A}_{21} \frac{x}{2} {A}_{12} {e}^{x {A}_{22}} \frac{x}{2} {A}_{21} + {e}^{x {A}_{22}} \frac{x}{2} {A}_{21} & \frac{x}{2} {A}_{21} \left({e}^{x {A}_{11}} \frac{x}{2} {A}_{12} + \frac{x}{2} {A}_{12} {e}^{x {A}_{22}}\right) + {e}^{x {A}_{22}}\end{matrix}\right]$$

Four threads can be for instance be employed to perform the following computation:

$$t h r e a {d}_{11} = {\text{Λ}}_{11} = {e}^{x {A}_{11}} \left(I + \frac{x}{2} {A}_{12} \frac{x}{2} {A}_{21}\right) + \frac{x}{2} {A}_{12} {e}^{x {A}_{22}} \frac{x}{2} {A}_{21}$$

$$t h r e a {d}_{12} = {\text{Λ}}_{12} = {e}^{x {A}_{11}} \frac{x}{2} {A}_{12} + \frac{x}{2} {A}_{12} {e}^{x {A}_{22}}$$

$$t h r e a {d}_{21} = {\text{Λ}}_{21} =$$

$$= \frac{x}{2} {A}_{21} {e}^{x {A}_{11}} \left(I + \frac{x}{2} {A}_{12} \frac{x}{2} {A}_{21}\right) + \frac{x}{2} {A}_{21} \frac{x}{2} {A}_{12} {e}^{x {A}_{22}} \frac{x}{2} {A}_{21} + {e}^{x {A}_{22}} \frac{x}{2} {A}_{21}$$

$$t h r e a {d}_{22} = {\text{Λ}}_{22} =$$

$$\frac{x}{2} {A}_{21} \left({e}^{x {A}_{11}} \frac{x}{2} {A}_{12} + \frac{x}{2} {A}_{12} {e}^{x {A}_{22}}\right) + {e}^{x {A}_{22}}$$

The calculation can be recast in two computational layers, firstly thread₁₁ and thread₁₂ will be computed and secondly the thread₂₁ and thread₂₂ which will use the result previously calculated. In this way only two threads can be in total employed.

$$t h r e a {d}_{11} = {e}^{x {A}_{11}} \left(I + \frac{x}{2} {A}_{12} \frac{x}{2} {A}_{21}\right) + \frac{x}{2} {A}_{12} {e}^{x {A}_{22}} \frac{x}{2} {A}_{21}$$

$$t h r e a {d}_{12} = {e}^{x {A}_{11}} \frac{x}{2} {A}_{12} + \frac{x}{2} {A}_{12} {e}^{x {A}_{22}}$$

$$t h r e a {d}_{21} = \frac{x}{2} {A}_{21} \left(t h r e a {d}_{11}\right) + {e}^{x {A}_{22}} \frac{x}{2} {A}_{21}$$

$$t h r e a {d}_{22} = \frac{x}{2} {A}_{21} \left(t h r e a {d}_{12}\right) + {e}^{x {A}_{22}}$$

Following the same logic:

$${e}^{x D} =$$

$$\left[\begin{matrix}{e}^{x {D}_{11}} \left(I + \frac{x}{2} {D}_{12} \frac{x}{2} {D}_{21}\right) + \frac{x}{2} {D}_{12} {e}^{x {A}_{22}} \frac{x}{2} {D}_{21} & {e}^{x {D}_{11}} \frac{x}{2} {D}_{12} + \frac{x}{2} {D}_{12} {e}^{x {D}_{22}} \\ \frac{x}{2} {D}_{21} {e}^{x {D}_{11}} \left(I + \frac{x}{2} {D}_{12} \frac{x}{2} {D}_{21}\right) + \frac{x}{2} {D}_{21} \frac{x}{2} {D}_{12} {e}^{x {D}_{22}} \frac{x}{2} {D}_{21} + {e}^{x {D}_{22}} \frac{x}{2} {D}_{21} & \frac{x}{2} {D}_{21} \left({e}^{x {D}_{11}} \frac{x}{2} {D}_{12} + \frac{x}{2} {D}_{12} {e}^{x {D}_{22}}\right) + {e}^{x {D}_{22}}\end{matrix}\right]$$

$$t h r e a {d}_{41} = {e}^{x {D}_{11}} \left(I + \frac{x}{2} {D}_{12} \frac{x}{2} {D}_{21}\right) + \frac{x}{2} {D}_{12} {e}^{x {D}_{22}} \frac{x}{2} {D}_{21}$$

$$t h r e a {d}_{42} = {e}^{x {D}_{11}} \frac{x}{2} {D}_{12} + \frac{x}{2} {D}_{12} {e}^{x {D}_{22}}$$

$$t h r e a {d}_{43} = \frac{x}{2} {D}_{21} \left(t h r e a {d}_{41}\right) + {e}^{x {D}_{22}} \frac{x}{2} {D}_{21}$$

$$t h r e a {d}_{44} = \frac{x}{2} {D}_{21} \left(t h r e a {d}_{42}\right) + {e}^{x {D}_{22}}$$

Applying again Suzuki Trotter decomposition to the terms e^{xA}¹¹, e^{xA}²², e^{xD}¹¹, and e^{xD}²² the procedure can be iteratively repeated until reaching the desired size.

Parallel implementation for a FEM system with mass matrix formed by blocks is discussed below.

### State System Representation

Let M, K and C be the mass, spring, and dump matrices with the following block structure:

$$M = \left[\begin{matrix}{M}_{11} & 0 & 0 & 0 & 0 \\ 0 & {M}_{22} & 0 & 0 & 0 \\ 0 & 0 & {M}_{33} & 0 & 0 \\ 0 & 0 & 0 & {M}_{44} & 0 \\ 0 & 0 & 0 & 0 & {M}_{55}\end{matrix}\right]$$

$$K = \left[\begin{matrix}{K}_{11} & {K}_{12} & 0 & 0 & 0 \\ {K}_{21} & {K}_{22} & {K}_{23} & 0 & 0 \\ 0 & {K}_{32} & {K}_{33} & {K}_{34} & 0 \\ 0 & 0 & {K}_{43} & {K}_{44} & {K}_{45} \\ 0 & 0 & 0 & {K}_{54} & {K}_{55}\end{matrix}\right]$$

$$C = \left[\begin{matrix}{C}_{11} & {C}_{12} & 0 & 0 & 0 \\ {C}_{21} & {C}_{22} & {C}_{23} & 0 & 0 \\ 0 & {C}_{32} & {C}_{33} & {C}_{34} & 0 \\ 0 & 0 & {C}_{43} & {C}_{44} & {C}_{45} \\ 0 & 0 & 0 & {C}_{54} & {C}_{55}\end{matrix}\right]$$

The state space representation is given by:

$$\dot{x} = \left[\begin{matrix}0 & I \\ - {M}^{- 1} K & - {M}^{- 1} C\end{matrix}\right] x + \left[\begin{matrix}0 \\ {M}^{- 1} B\end{matrix}\right] u$$

Noting that

$${M}^{- 1} = \left[\begin{matrix}{\left({M}_{11}\right)}^{- 1} & 0 & 0 & 0 & 0 \\ 0 & {\left({M}_{22}\right)}^{- 1} & 0 & 0 & 0 \\ 0 & 0 & {\left({M}_{33}\right)}^{- 1} & 0 & 0 \\ 0 & 0 & 0 & {\left({M}_{44}\right)}^{- 1} & 0 \\ 0 & 0 & 0 & 0 & {\left({M}_{55}\right)}^{- 1}\end{matrix}\right]$$

Without losing generality, suppose B=0, C=0, the state space representation is given by:

$$\dot{x} =$$

$$\left[\begin{matrix}0 & 0 & 0 & 0 & 0 & 1 & 0 & 0 & 0 & 0 \\ 0 & 0 & 0 & 0 & 0 & 0 & 1 & 0 & 0 & 0 \\ 0 & 0 & 0 & 0 & 0 & 0 & 0 & 1 & 0 & 0 \\ 0 & 0 & 0 & 0 & 0 & 0 & 0 & 0 & 1 & 0 \\ 0 & 0 & 0 & 0 & 0 & 0 & 0 & 0 & 0 & 1 \\ {\left({M}_{11}\right)}^{- 1} {K}_{11} & {\left({M}_{11}\right)}^{- 1} {K}_{12} & 0 & 0 & 0 & 0 & 0 & 0 & 0 & 0 \\ {\left({M}_{22}\right)}^{- 1} {K}_{21} & {\left({M}_{22}\right)}^{- 1} {K}_{22} & {\left({M}_{22}\right)}^{- 1} {K}_{23} & 0 & 0 & 0 & 0 & 0 & 0 & 0 \\ ⋮ & ⋮ & ⋮ & ⋮ & ⋮ & 0 & 0 & 0 & 0 & 0 \\ 0 & 0 & 0 & {\left({M}_{55}\right)}^{- 1} {K}_{54} & {\left({M}_{55}\right)}^{- 1} {K}_{55} & 0 & 0 & 0 & 0 & 0\end{matrix}\right] x$$

Reordering rows and columns:

$$\dot{x} =$$

$$\left[\begin{matrix}0 & 1 & 0 & 0 & 1 & ⋯ & 0 & 0 & 0 \\ {\left({M}_{11}\right)}^{- 1} {K}_{11} & 0 & {\left({M}_{11}\right)}^{- 1} {K}_{12} & 0 & 0 & ⋯ & 0 & 0 & 0 \\ 0 & 0 & 0 & 1 & 0 & ⋯ & 0 & 0 & 0 \\ {\left({M}_{22}\right)}^{- 1} {K}_{21} & 0 & {\left({M}_{22}\right)}^{- 1} {K}_{22} & 0 & {\left({M}_{22}\right)}^{- 1} {K}_{23} & ⋯ & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 1 & 0 \\ 0 & 0 & 0 & 0 & 0 & ⋯ & {\left({M}_{55}\right)}^{- 1} {K}_{54} & 0 & {\left({M}_{55}\right)}^{- 1} {K}_{55}\end{matrix}\right] x$$

The representation obtained can be therefore reconducted to the previous cases in which lumped masses are substituted with block masses. No mass band matrices, bi-dimensional (e.g., plates) and three-dimensional cases (e.g., solids) can also be solved.

### Time Evolution

The partition of the dynamic matrix is described below although the same method can be implemented in also other cases (e.g., heat transfer, Black Scholes equation, FEM, etc...)

$${A}_{1} = \left[\begin{matrix}0 & 1 & 0 & 0 & 1 & ⋯ & 0 & 0 & 0 \\ {\left({M}_{11}\right)}^{- 1} {K}_{11} & 0 & {\left({M}_{11}\right)}^{- 1} {K}_{12} & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0\end{matrix}\right]$$

$$\begin{matrix}{A}_{2} = \\ \left[\begin{matrix}0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 1 & 0 & ⋯ & 0 & 0 & 0 \\ {\left({M}_{22}\right)}^{- 1} {K}_{21} & 0 & {\left({M}_{22}\right)}^{- 1} {K}_{22} & 0 & {\left({M}_{22}\right)}^{- 1} {K}_{23} & ⋯ & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0\end{matrix}\right]\end{matrix}$$

$${A}_{5} = \left[\begin{matrix}0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 0 & 0 \\ ⋮ & ⋮ & ⋮ & ⋮ & ⋮ & ⋱ & ⋮ & ⋮ & ⋮ \\ 0 & 0 & 0 & 0 & 0 & ⋯ & 0 & 0 & 0 \\ 0 & 0 & 0 & 0 & 0 & ⋯ & 0 & 0 & 0 \\ 0 & 0 & 0 & 0 & 0 & ⋯ & 0 & 1 & 0 \\ 0 & 0 & 0 & 0 & 0 & ⋯ & {\left({M}_{55}\right)}^{- 1} {K}_{54} & 0 & {\left({M}_{55}\right)}^{- 1} {K}_{55}\end{matrix}\right] x$$

Two sets of non-commuting terms can be identified:

$${Φ}_{1} = \left\{{A}_{1} , {A}_{3} , {A}_{5}\right\}$$

$${Φ}_{2} = \left\{{A}_{2} , {A}_{4}\right\}$$

Without loss of generality and for sake of simplicity a Suzuki Trotter decomposition 2^{nd} order approximant is considered:

$${S}_{2} \left(δ\right) = {e}^{A δ} = {e}^{\frac{δ}{2} {A}_{o d d}} {e}^{\frac{δ}{2} {A}_{e v e n}} {e}^{\frac{δ}{2} {A}_{o d d}} ,$$

$${S}_{2} \left(δ\right) = {e}^{\frac{δ}{2} {A}_{1}} {e}^{\frac{δ}{2} {A}_{3}} {e}^{\frac{δ}{2} {A}_{5}} {e}^{\frac{δ}{2} {A}_{2}} {e}^{\frac{δ}{2} {A}_{4}} {e}^{\frac{δ}{2} {A}_{4}} {e}^{\frac{δ}{2} {A}_{2}} {e}^{\frac{δ}{2} {A}_{5}} {e}^{\frac{δ}{2} {A}_{3}} {e}^{\frac{δ}{2} {A}_{1}} =$$

$$= {e}^{\frac{δ}{2} {A}_{1}} {e}^{\frac{δ}{2} {A}_{3}} {e}^{\frac{δ}{2} {A}_{5}} {e}^{\frac{δ}{2} {A}_{2}} {e}^{δ {A}_{4}} {e}^{\frac{δ}{2} {A}_{2}} {e}^{\frac{δ}{2} {A}_{5}} {e}^{\frac{δ}{2} {A}_{3}} {e}^{\frac{δ}{2} {A}_{1}}$$

Let X(0) be a matrix whose columns are vectors of different initial conditions

$$X \left(0\right) = \left[{x}_{1} \left(0\right) , {x}_{2} \left(0\right) , … {x}_{n} \left(0\right)\right]$$

Time evolution at instant time t = δ is given by:

$$X \left(δ\right) = {S}_{2} \left(δ\right) X \left(0\right) =$$

$$= {e}^{\frac{δ}{2} {A}_{1}} {e}^{\frac{δ}{2} {A}_{3}} {e}^{\frac{δ}{2} {A}_{5}} {e}^{\frac{δ}{2} {A}_{2}} {e}^{δ {A}_{4}} {e}^{\frac{δ}{2} {A}_{2}} {e}^{\frac{δ}{2} {A}_{5}} {e}^{\frac{δ}{2} {A}_{3}} {e}^{\frac{δ}{2} {A}_{1}} X \left(0\right)$$

It is possible to perform the Singular Value Decomposition (SVD) on each term of the product and neglect the singular values lower than a given threshold. As an example, considering the first matrix exponential

$$\begin{matrix}{e}^{\frac{δ}{2} {A}_{1}} = {U}_{1} {\sum }_{1} {V}_{1} ≅ \left[\begin{matrix}{u}_{1} & {u}_{2} & … & {u}_{m}\end{matrix}\right] \left[\begin{matrix}{σ}_{1} & 0 & ⋯ & 0 \\ 0 & {σ}_{2} & ⋯ & 0 \\ ⋮ & ⋮ & ⋱ & 0 \\ 0 & 0 & 0 & {σ}_{m}\end{matrix}\right] \left[\begin{matrix}{v}_{1} \\ {v}_{2} \\ ⋮ \\ {v}_{m}\end{matrix}\right] ≅ \\ {U}_{1}^{∗} {Σ}_{1}^{∗} {V}_{1}^{∗}\end{matrix}$$

where the matrix ∑₁ is diagonal for SVD construction, with the (ordered) singular values σ₁ ≥ σ₂ ≥ ⋯ ≥ σₙ σₙ on its diagonal. The singular values below a given threshold, say σ̅, can be discarded to reduce the system size, e.g., if σ̅ ≥ σₘ₊₁ ≥ σₙ σ̅ₘ₊₂ ≥ σₙ ⋯ ≥ σₙ, then obtaining a lower order diagonal matrix

$${Σ}_{1}^{∗}$$

and hence a low order approximation of the matrix exponential.

Analogously for the other terms we have

$$\begin{matrix}{e}^{\frac{δ}{2} {A}_{2}} = {U}_{2} {Σ}_{2} {V}_{2} ≅ {U}_{1}^{∗} {Σ}_{1}^{∗} {V}_{1}^{∗} \\ ⋮\end{matrix}$$

$${e}^{δ 4} = {U}_{4} {Σ}_{4} {V}_{4} ≅ {U}_{4}^{∗} {Σ}_{4}^{∗} {V}_{4}^{∗}$$

$${e}^{\frac{δ}{2} {A}_{5}} = {U}_{5} {Σ}_{5} {V}_{5} ≅ {U}_{5}^{∗} {Σ}_{5}^{∗} {V}_{5}^{∗}$$

System response at the instant time t = δ is given by:

$$X \left(δ\right) = {U}_{1} {Σ}_{1} {V}_{1} {U}_{3} {Σ}_{3} {V}_{3} … {U}_{4} {Σ}_{4} {V}_{4} … {U}_{3} {Σ}_{3} {V}_{3} {U}_{1} {Σ}_{1} {V}_{1} X \left(0\right) =$$

$$= {U}_{1}^{∗} \left({Σ}_{1}^{∗} {V}_{1}^{∗} {U}_{3}^{∗} {Σ}_{3}^{∗} {V}_{3}^{∗} … {U}_{4}^{∗} {Σ}_{4}^{∗} {V}_{4}^{∗} … {U}_{1}^{∗} {Σ}_{1}^{∗} {V}_{1}^{∗} X \left(0\right)\right) =$$

$$= {\left[{U}_{1}^{∗}\right]}_{n x m} {\left[{Σ}_{1}^{∗} {V}_{1}^{∗} {U}_{3}^{∗} {Σ}_{3}^{∗} {V}_{3}^{∗} … {U}_{4}^{∗} {Σ}_{4}^{∗} {V}_{4}^{∗} … {Σ}_{3}^{∗} {V}_{3}^{∗} {U}_{1}^{∗} {Σ}_{1}^{∗} {V}_{1}^{∗} X \left(0\right)\right]}_{m x n}$$

$$X \left(2 δ\right) = {U}_{1}^{∗} \left({Σ}_{1}^{∗} {V}_{1}^{∗} {U}_{3}^{∗} {Σ}_{3}^{∗} {V}_{3}^{∗} … {U}_{4}^{∗} {Σ}_{4}^{∗} {V}_{4}^{∗} … {U}_{1}^{∗} {Σ}_{1}^{∗} {V}_{1}^{∗} X \left(δ\right)\right) =$$

$$\begin{matrix}= {\left[{U}_{1}^{∗}\right]}_{n x m} {\left[{Σ}_{1}^{∗} {V}_{1}^{∗} {U}_{3}^{∗} {Σ}_{3}^{∗} {V}_{3}^{∗} … {U}_{4}^{∗} {Σ}_{4}^{∗} {V}_{4}^{∗} … {Σ}_{3}^{∗} {V}_{3}^{∗} {U}_{1}^{∗} {Σ}_{1}^{∗} {V}_{1}^{∗} X \left(0\right)\right]}_{m x n} \\ ⋮\end{matrix}$$

$$X \left(n δ\right) = {U}_{1}^{∗} \left({Σ}_{1}^{∗} {V}_{1}^{∗} {U}_{3}^{∗} {Σ}_{3}^{∗} {V}_{3}^{∗} … {U}_{4}^{∗} {Σ}_{4}^{∗} {V}_{4}^{∗} … {U}_{1}^{∗} {Σ}_{1}^{∗} {V}_{1}^{∗} X \left(\left(n - 1\right) δ\right)\right) =$$

$$\begin{matrix}= {\left[{U}_{1}^{∗}\right]}_{n x m} \left[{Σ}_{1}^{∗} {V}_{1}^{∗} {U}_{3}^{∗} {Σ}_{3}^{∗} {V}_{3}^{∗} … {U}_{4}^{∗} {Σ}_{4}^{∗} {V}_{4}^{∗} …\right) \\ {\left({Σ}_{3}^{∗} {V}_{3}^{∗} {U}_{1}^{∗} {Σ}_{1}^{∗} {V}_{1}^{∗} X \left(\left(n - 1\right) δ\right)\right]}_{m x n}\end{matrix}$$

When considering a multi-cores and multi-threads platform, the following solution can be implemented in three computational layers using three threads as shown in FIG. 31.

At the instant time t = kδ, layer 1 will solve

$$t h r e a {d}_{1} = {Σ}_{1}^{∗} {V}_{1}^{∗} {U}_{2}^{∗} X \left(t\right)$$

$$t h r e a {d}_{2} = {Σ}_{3}^{∗} {V}_{3}^{∗} {U}_{4}^{∗} X \left(t\right)$$

$$t h r e a {d}_{3} = {Σ}_{5}^{∗} {V}_{5}^{∗} X \left(t\right)$$

layer 2

$$t h r e a {d}_{1} = {Σ}_{2}^{∗} {V}_{2}^{∗} {U}_{3}^{∗} X \left(t\right)$$

$$t h r e a {d}_{2} = {Σ}_{4}^{∗} {V}_{4}^{∗} {U}_{5}^{∗} X \left(t\right)$$

layer 3

$$t h r e a {d}_{1} = {U}_{1}^{∗} {Σ}_{1}^{∗} {V}_{1}^{∗} {U}_{2}^{∗} X \left(t\right)$$

$$t h r e a {d}_{2} = {Σ}_{3}^{∗} {V}_{3}^{∗} {U}_{4}^{∗} X \left(t\right)$$

$$t h r e a {d}_{3} = {Σ}_{5}^{∗} {V}_{5}^{∗} X \left(t\right)$$

Such a job assignment holds the property that each thread will deal with a reduced order matrix of mxn size saving memory but also reducing computational effort since the matrix product will be performed also between reduced matrices. Only at the end of the step, the product will be multiplied for the matrix

$${U}_{1}^{∗}$$

returning to the original space dimension.

FIG. 31 shows parallel implementation using three different computational layers for the second order Suzuki Trotter decomposition 3100 according to an example of the instant disclosure.

A cantilever beam is a basic example in FEM. The proper connection of many of these elements allows users to model also very complex structures. A very intuitive application is the bridge modelling that can be, indeed, considered as numerous connected beams. However, in FEM there are many basic elements. Two-dimensional elements are for instance modelled through triangle, square, etc ... while three-dimensional elements are modelled through tetrahedra, cubes, etc. All these basic elements when properly connected constitute the fundamentals to model all the structures such as buildings, autos, aircraft etc. For instance, a building, indeed, can be regarded as a connection of pillars and walls that are modelled as beams and planes. The numerical simulation can help designers to properly calculate stress and strain conditions avoiding dangerous events that could lead for instance the building or the bridge to collapse. Analogously, automobiles and aircraft can be modelled through rods, triangle and tetrahedra which are the one-, two- and three-dimensional elements, respectively.

Without loss of generality and for sake of simplicity, it is possible to divide the bar in four elements of equal length L.

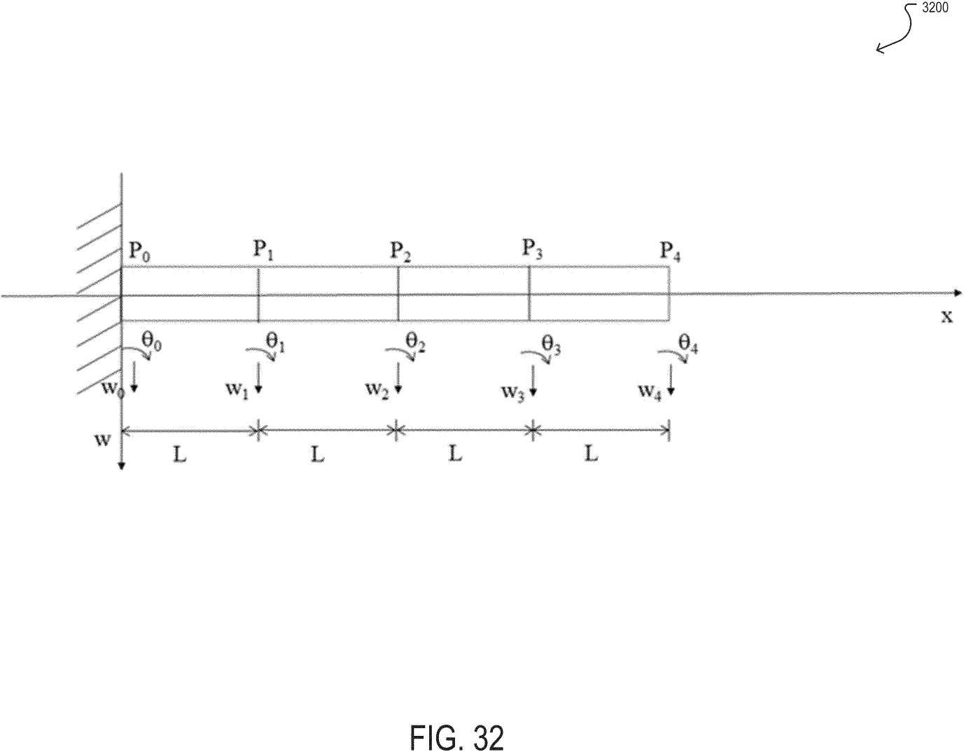

FIG. 32 shows a cantilever beam 3200 according to an example of the instant disclosure.

Supposing that there is no damping, the differential equation governing the motion of any element of the beam is given by:

$$\frac{{\partial }^{2} w \left(x , t\right)}{\partial {t}^{2}} + E I \frac{{\partial }^{4} w \left(z , t\right)}{\partial {x}^{4}} = u \left(w , t\right)$$

The equation of motion of the element iε{1,2,3,4} is:

$$m \ddot{q} + k q = B u \left(w , t\right)$$

Where q^{T} = [wᵢ₋₁, θᵢ₋₁, wᵢ, θᵢ] is the vector that contains displacement and rotation of the element iε{1,2,3,4} and the input matrix B depends on where the input force is applied to the beam.

The mass matrix mⁱ of the element iε{1,2,3,4} is given by:

$${m}^{i} = ρ \left[\begin{matrix}\frac{13 L}{35} & \frac{11 {L}^{2}}{210} & \frac{9 L}{70} & - \frac{13 {L}^{2}}{420} \\ \frac{11 {L}^{2}}{210} & \frac{{L}^{3}}{105} & \frac{13 {L}^{2}}{420} & - \frac{{L}^{2}}{140} \\ \frac{9 L}{70} & \frac{13 {L}^{2}}{420} & \frac{13 L}{35} & - \frac{11 {L}^{2}}{210} \\ - \frac{13 {L}^{2}}{420} & - \frac{{L}^{2}}{140} & - \frac{11 {L}^{2}}{210} & \frac{{L}^{3}}{105}\end{matrix}\right] = \left[\begin{matrix}{m}_{11}^{i} & {m}_{12}^{i} \\ {m}_{21}^{i} & {m}_{22}^{i}\end{matrix}\right] ,$$

where:

$${m}_{11}^{i} = ρ \left[\begin{matrix}\frac{13 L}{35} & \frac{11 {L}^{2}}{210} \\ \frac{11 {L}^{2}}{210} & \frac{{L}^{3}}{105}\end{matrix}\right] , {m}_{12}^{i} = ρ \left[\begin{matrix}\frac{9 L}{70} & - \frac{13 {L}^{2}}{420} \\ \frac{13 {L}^{2}}{420} & - \frac{{L}^{2}}{140}\end{matrix}\right] ,$$

$${m}_{21}^{i} = ρ \left[\begin{matrix}\frac{9 L}{70} & \frac{13 {L}^{2}}{420} \\ - \frac{13 {L}^{2}}{420} & - \frac{{L}^{2}}{140}\end{matrix}\right] , {m}_{22}^{i} = ρ \left[\begin{matrix}\frac{13 L}{35} & - \frac{11 {L}^{2}}{210} \\ - \frac{11 {L}^{2}}{210} & \frac{{L}^{3}}{105}\end{matrix}\right]$$

while the stiffness matrix is:

$${k}^{i} = E I \left[\begin{matrix}\frac{12}{{L}^{3}} & \frac{6}{{L}^{2}} & - \frac{12}{{L}^{3}} & \frac{6}{{L}^{2}} \\ \frac{6}{{L}^{2}} & \frac{4}{L} & - \frac{6}{{L}^{2}} & \frac{2}{L} \\ - \frac{12}{{L}^{3}} & - \frac{6}{{L}^{2}} & \frac{12}{{L}^{2}} & - \frac{6}{{L}^{2}} \\ \frac{6}{{L}^{2}} & \frac{2}{L} & - \frac{6}{{L}^{2}} & \frac{4}{L}\end{matrix}\right] = \left[\begin{matrix}{k}_{11}^{i} & {k}_{12}^{i} \\ {k}_{21}^{i} & {k}_{22}^{i}\end{matrix}\right] .$$

The global mass matrix M is given by:

$$M = \left[\begin{matrix}{m}_{11}^{1} & {m}_{12}^{1} & 0 & 0 & 0 \\ {m}_{21}^{1} & {m}_{22}^{1} + {m}_{11}^{2} & {m}_{12}^{2} & 0 & 0 \\ 0 & {m}_{21}^{2} & {m}_{22}^{2} + {m}_{11}^{3} & {m}_{12}^{3} & 0 \\ 0 & 0 & {m}_{21}^{3} & {m}_{22}^{3} + {m}_{11}^{4} & {m}_{12}^{4} \\ 0 & 0 & 0 & {m}_{21}^{4} & {m}_{22}^{4}\end{matrix}\right]$$

The global stiffness matrix is:

$$K = \left[\begin{matrix}{k}_{11}^{1} & {k}_{12}^{1} & 0 & 0 & 0 \\ {k}_{21}^{1} & {k}_{22}^{1} + {k}_{11}^{2} & {k}_{12}^{2} & 0 & 0 \\ 0 & {k}_{21}^{2} & {k}_{22}^{2} + {k}_{11}^{3} & {k}_{12}^{3} & 0 \\ 0 & 0 & {k}_{21}^{3} & {k}_{22}^{3} + {k}_{11}^{4} & {k}_{12}^{4} \\ 0 & 0 & 0 & {k}_{21}^{4} & {k}_{22}^{4}\end{matrix}\right]$$

The global vector containing displacement and rotation of all elements is

$$\begin{matrix}{q}^{T} = \\ \left[{w}_{0} , {θ}_{0} , {w}_{1} , {θ}_{1} , {w}_{2} , {θ}_{2} , {w}_{3} , {θ}_{3} , {w}_{4} , {θ}_{4} , {\dot{w}}_{0} , {\dot{θ}}_{0} , {\dot{w}}_{1} , {\dot{θ}}_{1} , {\dot{w}}_{2} , {\dot{θ}}_{2} , {\dot{w}}_{3} , {\dot{θ}}_{3} , {\dot{w}}_{4} , {\dot{θ}}_{4}\right]\end{matrix}$$

Considering the constraint, it becomes:

$$\begin{matrix}{q}^{T} = \\ \left[0 , 0 , {w}_{1} , {θ}_{1} , {w}_{2} , {θ}_{2} , {w}_{3} , {θ}_{3} , {w}_{4} , {θ}_{4} , 0 , 0 , {\dot{w}}_{1} , {\dot{θ}}_{1} , {\dot{w}}_{2} , {\dot{θ}}_{2} , {\dot{w}}_{3} , {\dot{θ}}_{3} , {\dot{w}}_{4} , {\dot{θ}}_{4}\right]\end{matrix}$$

The damping matrix C and the state space representation is:

$$\dot{x} = \left[\begin{matrix}0 & I \\ - {M}^{- 1} K & - {M}^{- 1} C\end{matrix}\right] x + \left[\begin{matrix}0 \\ {M}^{- 1} B\end{matrix}\right] u$$

In this case the inverse of the mass matrix M⁻¹ is a full matrix and therefore the matrix A is, in general, almost a full matrix.

It is possible to divide the state matrix

$$A = \left[\begin{matrix}0 & I \\ - {M}^{- 1} K & - {M}^{- 1} C\end{matrix}\right]$$

in an arbitrary number of non commuting terms A₁, A₂, A₃, ... A_{I} such that they are small enough to be handled by a processing unit.

As shown in the previous section, for instance, a second order approximant for a general number of sets of non commuting matrices A₁, A₂, A₃, ... A_{I} it is possible to obtain

$${S}_{2} \left(x\right) = {e}^{\frac{x}{2} {A}_{1}} {e}^{\frac{x}{2} {A}_{2}} {e}^{\frac{x}{2} {A}_{3}} … {e}^{\frac{x}{2} {A}_{I}} {e}^{\frac{x}{2} {A}_{I}} … {e}^{\frac{x}{2} {A}_{3}} {e}^{\frac{x}{2} {A}_{2}} {e}^{\frac{x}{2} {A}_{1}} =$$

$$= {e}^{\frac{x}{2} {A}_{1}} {e}^{\frac{x}{2} {A}_{2}} {e}^{\frac{x}{2} {A}_{3}} … {e}^{x {A}_{I}} … {e}^{\frac{x}{2} {A}_{3}} {e}^{\frac{x}{2} {A}_{2}} {e}^{\frac{x}{2} {A}_{1}} .$$

As an example, it is possible to consider the following three matrices decomposition:

$${A}_{1} = \left[\begin{matrix}0 & I \\ 0 & 0\end{matrix}\right] ,$$

$${A}_{2} = \left[\begin{matrix}0 & 0 \\ - {M}^{- 1} K & 0\end{matrix}\right] ,$$

$${A}_{3} = \left[\begin{matrix}0 & 0 \\ 0 & - {M}^{- 1} C\end{matrix}\right] ,$$

It is possible to obtain the following three sets

$${\text{Ξ}}_{1} = \left\{{\text{Π}}_{1}\right\} ⇒ {\text{Φ}}_{1} = \left\{{A}_{1}\right\}$$

$${\text{Ξ}}_{2} = \left\{{\text{Π}}_{2}\right\} ⇒ {\text{Φ}}_{2} = \left\{{A}_{2}\right\} ,$$

$${\text{Ξ}}_{3} = \left\{{\text{Π}}_{3}\right\} ⇒ {\text{Φ}}_{3} = \left\{{A}_{3}\right\} ,$$

As previously shown, the expression for the second order approximant S₂(x) for three sets is given by:

$${S}_{2} \left(x\right) = {e}^{\frac{x}{2} {A}_{1}} {e}^{\frac{x}{2} {A}_{2}} {e}^{x {A}_{3}} {e}^{\frac{x}{2} {A}_{2}} {e}^{\frac{x}{2} {A}_{1}} =$$

$$= \left(I + \frac{x}{2} {A}_{1}\right) \left(I + \frac{x}{2} {A}_{2}\right) {e}^{x {A}_{3}} \left(I + \frac{x}{2} {A}_{2}\right) \left(I + \frac{x}{2} {A}_{1}\right)$$

since

$${e}^{\frac{x}{2} {A}_{1}} = \left(I + \frac{x}{2} {A}_{1}\right) ,$$

$${e}^{\frac{x}{2} {A}_{2}} = \left(I + \frac{x}{2} {A}_{2}\right)$$

where I is the identity matrix.

The free evolution of the system can be evaluated as extensively shown in the disclosure herein.

Considering a constant concentrated force of amplitude u₀ applied at the node P₄, the matrix B becomes:

$$B = \left[\begin{matrix}0 \\ 0 \\ 0 \\ {u}_{0}\end{matrix}\right]$$

Thus, there is a step input having the solution as previously discussed.

A numerical example of a cantilever beam with two nodes is provided below.

It is possible to consider an aluminium cylindric rod of L_{T}=4 four meters length and divide it in two elements of equal length of

$$L = \frac{{L}_{T}}{2} = 2$$

meters.

The state vector in this case becomes:

$${x}^{T} = \left[{w}_{0} , {θ}_{0} , {w}_{1} , {θ}_{1} , {w}_{2} , {θ}_{2} , {\dot{w}}_{0} , {\dot{θ}}_{0} , {\dot{w}}_{1} , {\dot{θ}}_{1} , {\dot{w}}_{2} , {\dot{θ}}_{2}\right]$$

The physical parameters concerning an element of the rod are:

| | |
|---|---|
| Material | Aluminium |
| Length | L=2 m |
| Section circle radius | R = 0.01 m |
| Section area | A= ΠR² = 3.1416 10⁻⁴ m² |
| Aluminium density | $ρ = 2.7 g / c {m}^{3} = 2700 \frac{K g}{{m}^{3}}$ |
| Second moment of area for a circle | $I = \frac{π {\text{R}}^{4}}{4} = {7.854010}^{- 9} {m}^{4}$ |
| Young elasticity module | E = 69 G Pa = 69 10⁹ Pascal |

The mass matrix M becomes:

$$M = \left[\begin{matrix}{m}_{11}^{1} & {m}_{12}^{1} & 0 \\ {m}_{21}^{1} & {m}_{22}^{1} + {m}_{11}^{2} & {m}_{12}^{2} \\ 0 & {m}_{21}^{2} & {m}_{22}^{2}\end{matrix}\right]$$

$${m}_{11}^{i} = \text{ρ} \left[\begin{matrix}\frac{13 L}{35} & \frac{11 {L}^{2}}{210} \\ \frac{11 {L}^{2}}{210} & \frac{{L}^{3}}{105}\end{matrix}\right] = \left[\begin{matrix}2005.71 & 565.71 \\ 565.71 & 205.71\end{matrix}\right]$$

$${m}_{12}^{i} = \text{ρ} \left[\begin{matrix}\frac{9 L}{70} & - \frac{13 {L}^{2}}{420} \\ \frac{13 {L}^{2}}{420} & - \frac{{L}^{2}}{140}\end{matrix}\right] = \left[\begin{matrix}694.286 & - 334.286 \\ 334.286 & - 77.143\end{matrix}\right]$$

$${m}_{21}^{i} = {m}_{21}^{i} = \text{ρ} \left[\begin{matrix}\frac{9 L}{70} & \frac{13 {L}^{2}}{420} \\ - \frac{13 {L}^{2}}{420} & - \frac{{L}^{2}}{140}\end{matrix}\right] = \left[\begin{matrix}694.286 & 334.286 \\ - 334.286 & - 77.143\end{matrix}\right]$$

$${m}_{22}^{i} = \text{ρ} \left[\begin{matrix}\frac{13 L}{35} & - \frac{11 {L}^{2}}{210} \\ - \frac{11 {L}^{2}}{210} & - \frac{11 {L}^{2}}{210}\end{matrix}\right] = \left[\begin{matrix}2005.71 & - 565.71 \\ - 565.71 & 205.71\end{matrix}\right]$$

$$M =$$

$$\left[\begin{matrix}2.0057 \text{e} + 03 & 5.6571 \text{e} + 02 & 6.9429 \text{e+02} & - 3.3429 \text{e} + 02 & 0 & 0 \\ 5.6571 \text{e} + 02 & 2.0571 \text{e} + 02 & 3.3429 \text{e} + 02 & - 7.7143 \text{e} + 01 & 0 & 0 \\ 6.9429 \text{e} + 02 & 3.3429 \text{e} + 02 & 4.0114 \text{e} + 03 & 0 & 6.9429 \text{e} + 02 & - 3.3429 \text{e} + 02 \\ - 3.3429 \text{e} + 02 & - 7.7143 \text{e} + 01 & 0 & 4.1143 \text{e} + 02 & 3.3429 \text{e} + 02 & - 7.7143 \text{e} + 01 \\ 0 & 0 & 6.9429 \text{e} + 02 & 3.3429 \text{e} + 02 & 2.0057 \text{e} + 03 & - 5.6571 \text{e} + 02 \\ 0 & 0 & - 3.3429 \text{e} + 02 & - 7.7143 \text{e} + 01 & - 5.6571 \text{e} + 02 & 2.0571 \text{e} + 02\end{matrix}\right]$$

The stiffness matrix is:

$$K =$$

$$\left[\begin{matrix}8.1289 e + 03 & 8.1289 e + 03 & - 8.1289 e + 03 & 8.1289 e + 03 & 0 & 0 \\ 8.1289 e + 03 & 1.0839 e + 04 & - 8.1289 e + 03 & 5.4193 e + 03 & 0 & 0 \\ - 8.1289 e + 03 & 8.1289 e + 03 & 2.4387 e + 04 & 0 & - 8.1289 e + 03 & 8.1289 e + 03 \\ - 8.1289 e + 03 & 5.4193 e + 03 & 0 & 2.1677 e + 04 & - 8.1289 e + 03 & 5.4193 e + 03 \\ 0 & 0 & - 8.1289 e + 03 & 8.1289 e + 03 & 1.6258 e + 04 & - 8.1289 e + 03 \\ 0 & 0 & - 8.1289 e + 03 & 5.4193 e + 03 & - 8.1289 e + 03 & 1.0839 e + 04\end{matrix}\right]$$

Under the hypothesis of absence of dumping C=0, the state matrix A is:

$$A = \left[\begin{matrix}0 & I \\ - {M}^{- 1} K & 0\end{matrix}\right] =$$

$$=$$

$$\left[\begin{matrix}0 & 0 & 0 & 0 & 0 & 0 & 1 & 0 & 0 & 0 & 0 & 0 \\ 0 & 0 & 0 & 0 & 0 & 0 & 0 & 1 & 0 & 0 & 0 & 0 \\ 0 & 0 & 0 & 0 & 0 & 0 & 0 & 0 & 1 & 0 & 0 & 0 \\ 0 & 0 & 0 & 0 & 0 & 0 & 0 & 0 & 0 & 1 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1 \\ - 45.3299 & - 48.5331 & 40.3287 & 3.1300 & - 13.5135 & 10.1755 & 0 & 0 & 0 & 0 & 0 & 0 \\ 169.6233 & 203.0836 & - 152.3214 & 35.8858 & 39.4086 & - 45.2991 & 0 & 0 & 0 & 0 & 0 & 0 \\ - 10.5374 & - 7.5267 & 6.0214 & 3.0107 & - 9.0321 & 13.5482 & 0 & 0 & 0 & 0 & 0 & 0 \\ - 31.1272 & 12.5318 & 21.0210 & 61.4460 & - 33.1485 & 12.5317 & 0 & 0 & 0 & 0 & 0 & 0 \\ 3.1801 & - 7.1649 & - 70.4358 & 36.0091 & - 9.0668 & 51.5438 & 0 & 0 & 0 & 0 & 0 & 0 \\ - 20.0508 & - 27.2349 & - 215.5461 & 153.3032 & - 91.5569 & 221.1479 & 0 & 0 & 0 & 0 & 0 & 0\end{matrix}\right]$$

Imposing the constraints on the first node, w₀ = θ₀ = ẇ₀ = θ̇̇̇₀ = 0

$${x}^{T} = \left[0 , 0 , {w}_{1} , {θ}_{1} , {w}_{2} , {θ}_{2} , 0 , 0 , {\dot{w}}_{1} , {\dot{θ}}_{1} , {\dot{w}}_{2} , {\dot{θ}}_{2}\right]$$

the state variable becomes:

$${x}^{T} = \left[{w}_{1} , {θ}_{1} , {w}_{2} , {θ}_{2} , {\dot{w}}_{1} , {\dot{θ}}_{1} , {\dot{w}}_{2} , {\dot{θ}}_{2}\right]$$

The matrix A simplifies to:

$$A = \left[\begin{matrix}0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1 \\ 6.0214 & 3.0107 & - 9.0321 & 13.5482 & 0 & 0 & 0 & 0 \\ 21.0210 & 61.4460 & - 33.1485 & 12.5317 & 0 & 0 & 0 & 0 \\ - 70.4358 & 36.0091 & - 9.0668 & 51.5438 & 0 & 0 & 0 & 0 \\ - 215.5461 & 153.3032 & - 91.5569 & 221.1479 & 0 & 0 & 0 & 0\end{matrix}\right]$$

By posing

$${A}_{1} = \left[\begin{matrix}0 & I \\ 0 & 0\end{matrix}\right] =$$

$$= \left[\begin{matrix}0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}\right]$$

$${A}_{2} = \left[\begin{matrix}0 & 0 \\ - {M}^{- 1} K & 0\end{matrix}\right] =$$

$$= \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 6.0214 & 3.0107 & - 9.0321 & 13.5482 & 0 & 0 & 0 & 0 \\ 21.0210 & 61.4460 & - 33.1485 & 12.5317 & 0 & 0 & 0 & 0 \\ - 70.4358 & 36.0091 & - 9.0668 & 51.5438 & 0 & 0 & 0 & 0 \\ - 215.5461 & 153.3032 & - 91.5569 & 221.1479 & 0 & 0 & 0 & 0\end{matrix}\right]$$

The following two non-commuting sets are identified:

$${Ξ}_{1} = \left\{{Π}_{1}\right\} ⇒ {Φ}_{1} = \left\{{A}_{1}\right\}$$

$${Ξ}_{2} = \left\{{Π}_{2}\right\} ⇒ {Φ}_{2} = \left\{{A}_{2}\right\}$$

The Suzuki Trotter second order approximant for two non-commuting sets concerning a time interval x = δ = 10⁻³ is given by

$${S}_{2} \left(.1\right) = {e}^{\frac{{10}^{- 3}}{2} {A}_{1}} {e}^{{10}^{- 3} {A}_{2}} {e}^{\frac{{10}^{- 3}}{2} {A}_{1}} =$$

$$= \left(I + \frac{{10}^{- 3}}{2} {A}_{1}\right) \left(I + {10}^{- 3} {A}_{2}\right) \left(I + \frac{{10}^{- 3}}{2} {A}_{1}\right) =$$

$$= \left(I + \frac{{10}^{- 3}}{2} {A}_{1}\right) \left(I + {10}^{- 3} {A}_{2}\right) \left(I + \frac{{10}^{- 3}}{2} {A}_{1}\right) =$$

$$\left(I + \frac{{10}^{- 3}}{2} \left[\begin{matrix}0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}\right]\right)$$

$$\left(I + {10}^{- 3} \left[\begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 6.0214 & 3.0107 & - 9.0321 & 13.5482 & 0 & 0 & 0 & 0 \\ 21.0210 & 61.4460 & - 33.1485 & 12.5317 & 0 & 0 & 0 & 0 \\ - 70.4358 & 36.0091 & - 9.0668 & 51.5438 & 0 & 0 & 0 & 0 \\ - 215.5461 & 153.3032 & - 91.5569 & 221.1479 & 0 & 0 & 0 & 0\end{matrix}\right]\right)$$

$$\left(I + \frac{{10}^{- 3}}{2} \left[\begin{matrix}0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix}\right]\right) =$$

$$= \left[\begin{matrix}1 & 0 & 0 & 0 & \frac{{10}^{- 3}}{2} & 0 & 0 & 0 \\ 0 & 1 & 0 & 0 & 0 & \frac{{10}^{- 3}}{2} & 0 & 0 \\ 0 & 0 & 1 & 0 & 0 & 0 & \frac{{10}^{- 3}}{2} & 0 \\ 0 & 0 & 0 & 1 & 0 & 0 & 0 & \frac{{10}^{- 3}}{2} \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix}\right]$$

$$\left[\begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0.0060 & 0.0030 & - 0.0090 & 0.0135 & 1 & 0 & 0 & 0 \\ 0.0210 & 0.0614 & - 0.0331 & 0.0125 & 0 & 1 & 0 & 0 \\ - 0.0704 & 0.0360 & - 0.0091 & 0.0515 & 0 & 0 & 1 & 0 \\ - 0.2155 & 0.1533 & - 0.0916 & 0.2211 & 0 & 0 & 0 & 1\end{matrix}\right]$$

$$\left[\begin{matrix}1 & 0 & 0 & 0 & \frac{{10}^{- 3}}{2} & 0 & 0 & 0 \\ 0 & 1 & 0 & 0 & 0 & \frac{{10}^{- 3}}{2} & 0 & 0 \\ 0 & 0 & 1 & 0 & 0 & 0 & \frac{{10}^{- 3}}{2} & 0 \\ 0 & 0 & 0 & 1 & 0 & 0 & 0 & \frac{{10}^{- 3}}{2} \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix}\right] =$$

$$\begin{matrix}\\ \vert = \\ \left[\begin{matrix}1 & 1.5054 e - 06 & - 4.5160 e - 06 & 6.7741 e - 06 & 1.0000 e - 03 & 7.5268 e - 10 & - 2.2580 e - 09 & 3.3870 e - 09 \\ 1.0510 e - 05 & 1 & - 1.6574 e - 05 & 6.2659 e - 06 & 5.2552 e - 09 & 1.0000 e - 03 & - 8.2871 e - 09 & 3.1329 e - 09 \\ - 3.5218 e - 05 & 1.8005 e - 05 & 1 & 2.5772 e - 05 & - 1.7609 e - 08 & 9.0023 e - 09 & 1.0000 e - 03 & 1.2886 e - 08 \\ - 1.0777 e - 04 & 7.6652 e - 05 & - 4.5778 e - 05 & 1.0001 e + 00 & - 5.3887 e - 08 & 3.8326 e - 08 & - 2.2889 e - 08 & 1.0001 e - 03 \\ 6.0214 e - 03 & 3.0107 e - 03 & - 9.0321 e - 03 & 1.3548 e - 02 & 1 & 1.5054 e - 06 & - 4.5160 e - 06 & 6.7741 e - 06 \\ 2.1021 e - 02 & 6.1446 e - 02 & - 3.3148 e - 02 & 1.2532 e - 02 & 1.0510 e - 05 & 1 & - 1.6574 e - 05 & 6.2659 e - 06 \\ - 7.0436 e - 02 & 3.6009 e - 02 & - 9.0668 e - 03 & 5.1544 e - 02 & - 3.5218 e - 05 & 1.8005 e - 05 & 1 & 2.5772 e - 05 \\ - 2.1555 e - 01 & 1.5330 e - 01 & - 9.1557 e - 02 & 2.2115 e - 01 & - 1.0777 e - 04 & 7.6652 e - 05 & - 4.5778 e - 05 & 1.0001 e + 00\end{matrix}\right]\end{matrix}$$

The one-dimensional diffusion partial differential equation (PDE) describes many physical phenomena including heat transfer.

$$\frac{\partial x \left(z , t\right)}{\partial t} = α \frac{{\partial }^{2} x \left(z , t\right)}{\partial {z}^{2}}$$

As an example, a wall with two faces at prescribed temperature T₁, T₂ is considered.

In numerical simulation, a wall with two faces at prescribed temperature T₁, T₂ is an example model to show how heat is transferred through materials. This example can be extended to model any physical and engineering problem in which heat transfer is involved such as automobiles and aircraft engines but also solar panels and even kitchen pots. The wall example can be extended and applied to other very complex fields which also include aerodynamics, gas dynamics, and more in general thermo-fluid dynamics. For instance, in some applications the aim could be to simulate conditions in which the fluid due to the heat exchange modifies its density and pressure triggering a change in the lift of an aircraft wing. This condition may put at risk the safety of the flight possibly causing a crash or flight problem for the aircraft.

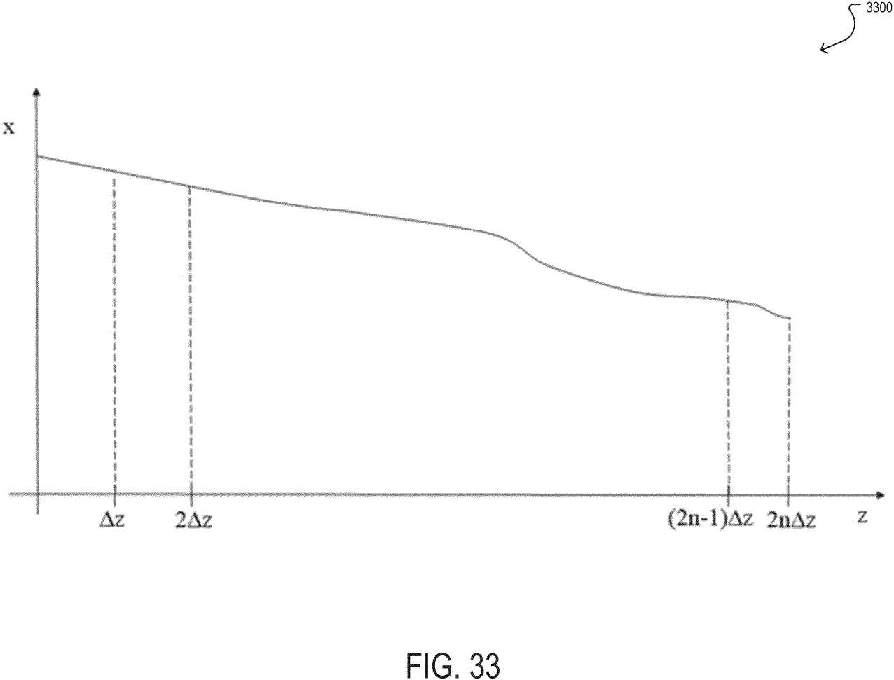

The semi-discretization method is shown in FIG. 33. In this example, it is discretized with respect to the spatial variable only.

FIG. 33 shows a heat conductor 3300 according to an example of the instant disclosure.

The PDE can be recast as a system of linear ordinary differential equations (ODEs) by using the method of the lines. In state space representation,

$$\dot{x} = A x \left(t\right) + B u \left(t\right)$$

by posing:

$$A = \frac{α}{Δ {z}^{2}} \left[\begin{matrix}- 2 & 1 & 0 & 0 & ⋯ & 0 & 0 & 0 \\ 1 & - 2 & 1 & 0 & ⋯ & 0 & 0 & 0 \\ 0 & 1 & - 2 & 1 & ⋯ & 0 & 0 & 0 \\ ⋮ & ⋮ & ⋮ & ⋮ & ⋱ & ⋮ & ⋮ & ⋮ \\ 0 & 0 & 0 & 0 & ⋯ & 1 & - 2 & 1 \\ 0 & 0 & 0 & 0 & ⋯ & 0 & 1 & - 2\end{matrix}\right]$$

Thus, it is possible to consider a one-dimensional lattice model with one neighboring site interaction and it is possible to reconduct the problem based on the model as shown in FIG. 2.

$${A}_{1} = \frac{α}{Δ {z}^{2}} \left[\begin{matrix}- 2 & 1 & 0 & 0 & 0 & 0 & 0 & ⋯ & 0 \\ 1 & - 2 & 1 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ ⋮ & ⋮ & ⋮ & ⋮ & ⋮ & ⋮ & ⋮ & ⋱ & ⋮ \\ 0 & 0 & 0 & 0 & 0 & 0 & 0 & ⋯ & 0 \\ 0 & 0 & 0 & 0 & 0 & 0 & 0 & ⋯ & 0\end{matrix}\right] ,$$

$${A}_{2} = \frac{α}{Δ {z}^{2}} \left[\begin{matrix}0 & 0 & 0 & 0 & 0 & 0 & 0 & ⋯ & 0 \\ 0 & 0 & 0 & 0 & 0 & 0 & 0 & ⋯ & 0 \\ 0 & 1 & - 2 & 1 & 0 & 0 & 0 & ⋯ & 0 \\ 0 & 0 & 1 & - 2 & 1 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ ⋮ & ⋮ & ⋮ & ⋮ & ⋮ & ⋮ & ⋮ & ⋱ & ⋮ \\ 0 & 0 & 0 & 0 & 0 & 0 & 0 & ⋯ & 0 \\ 0 & 0 & 0 & 0 & 0 & 0 & 0 & ⋯ & 0\end{matrix}\right] ,$$

$${A}_{3} = \frac{α}{Δ {z}^{2}} \left[\begin{matrix}0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 0 & 0 & 0 & 0 & ⋯ & 0 \\ 0 & 0 & 0 & 1 & - 2 & 1 & 0 & ⋯ & 0 \\ 0 & 0 & 0 & 0 & 1 & - 2 & 1 & ⋯ & 0 \\ 0 & 0 & 0 & 0 & 0 & 0 & 0 & ⋯ & 0 \\ ⋮ & ⋮ & ⋮ & ⋮ & ⋮ & ⋮ & ⋮ & ⋱ & ⋮ \\ 0 & 0 & 0 & 0 & 0 & 0 & 0 & ⋯ & 0 \\ 0 & 0 & 0 & 0 & 0 & 0 & 0 & ⋯ & 0\end{matrix}\right] ,$$

As an example, it is possible to identify the following sets Ξ₁ and Ξ₂, ϕ₁, and ϕ₂

$${Ξ}_{1} = \left\{{Π}_{1} , {Π}_{3} , {Π}_{5}\right\} ⇒ {Φ}_{1} = \left\{{A}_{1} , {A}_{3} , {A}_{5} , … {A}_{j} , … {A}_{2 n - 1}\right\} j o d d$$

$${Ξ}_{2} = \left\{{Π}_{2} , {Π}_{4} , {Π}_{6}\right\} ⇒ {Φ}_{2} = \left\{{A}_{2} , {A}_{4} , {A}_{6} , … {A}_{j} , … {A}_{2 n}\right\} j e v e n$$

The system input matrix B is given by:

$$B = \frac{α}{Δ {z}^{2}} \left[\begin{matrix}1 & 0 \\ 0 & 0 \\ 0 & 0 \\ ⋮ & ⋮ \\ 0 & 0 \\ 0 & 1\end{matrix}\right]$$

Two step inputs of amplitude T₁ and T₂ are applied to the first and last state variable, respectively. The solution of the system under a step input has been extensively previously discussed.

One-dimensional heat equation numerical example using the method of the lines is provided below.

As an example, five nodes N + 1 = 5, N = 4, α = 0.5 and L = 1.

$$Δ z = \frac{1}{N + 1} = 4.$$

The state matrix A is therefore:

$$A = \frac{α}{Δ {z}^{2}} \left[\begin{matrix}- 2 & 1 & 0 & 0 \\ 1 & - 2 & 1 & 0 \\ 0 & 1 & - 2 & 1 \\ 0 & 0 & 1 & - 2\end{matrix}\right] = \frac{0.5}{16} \left[\begin{matrix}- 2 & 1 & 0 & 0 \\ 1 & - 2 & 1 & 0 \\ 0 & 1 & - 2 & 1 \\ 0 & 0 & 1 & - 2\end{matrix}\right]$$

The following matrices can be considered:

$${A}_{1} = 32 \left[\begin{matrix}- 2 & 1 & 0 & 0 \\ 1 & - 2 & 1 & 0 \\ 0 & 0 & 0 & 0 \\ 0 & 0 & 0 & 0\end{matrix}\right] = \left[\begin{matrix}- 64 & 32 & 0 & 0 \\ 32 & - 64 & 32 & 0 \\ 0 & 0 & 0 & 0 \\ 0 & 0 & 0 & 0\end{matrix}\right]$$

$${A}_{2} = 32 \left[\begin{matrix}0 & 0 & 0 & 0 \\ 0 & 0 & 0 & 0 \\ 0 & 1 & - 2 & 1 \\ 0 & 0 & 1 & - 2\end{matrix}\right] = \left[\begin{matrix}0 & 0 & 0 & 0 \\ 0 & 0 & 0 & 0 \\ 0 & 32 & - 64 & 32 \\ 0 & 0 & 32 & - 64\end{matrix}\right]$$

The following two non-commuting sets are identified:

$${Ξ}_{1} = \left\{{Π}_{1}\right\} ⇒ {Φ}_{1} = \left\{{A}_{1}\right\}$$

$${Ξ}_{2} = \left\{{Π}_{2}\right\} ⇒ {Φ}_{2} = \left\{{A}_{2}\right\}$$

A second order Suzuki Trotter decomposition with δ = .01 can be applied:

$${e}^{A δ} = {e}^{\frac{δ}{2} {A}_{1}} {e}^{δ {Α}_{2}} {e}^{\frac{δ}{2} {A}_{1}} + o \left({δ}^{3}\right)$$

$${e}^{.01 A} ≅ {e}^{\frac{.01}{2} {A}_{1}} {e}^{.01 {A}_{2}} {e}^{\frac{.01}{2} {A}_{1}} =$$

$$= \left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right]$$

Boundary conditions can be given through the initial time t=0 and Dirichlet conditions.

In this example boundary conditions are given through the initial condition x₀ and Dirichlet conditions as:

$$f \left(x , 0\right) = {x}_{0} = s i n \left(π x\right)$$

$$f \left(0 , t\right) = 0$$

$$f \left(1 , t\right) = 0$$

As a result:

$$f \left(x , 0\right) = s i n \left(π x\right) =$$

$${f}_{0} = \left[\begin{matrix}s i n \left(.2 π\right) \\ s i n \left(.4 π\right) \\ s i n \left(.6 π\right) \\ s i n \left(.8 π\right)\end{matrix}\right] = \left[\begin{matrix}0.5878 \\ 0.9511 \\ 0.9511 \\ 0.5878\end{matrix}\right]$$

Matrix B is given by

$$B = \left[\begin{matrix}f \left(0 , t\right) \\ 0 \\ 0 \\ f \left(1 , t\right)\end{matrix}\right] = \left[\begin{matrix}0 \\ 0 \\ 0 \\ 0\end{matrix}\right]$$

$$x \left(0\right) = \left[\begin{matrix}0.5878 \\ 0.9511 \\ 0.9511 \\ 0.5878\end{matrix}\right]$$

The system is

$$x \left(.01\right) =$$

$$\begin{matrix}\left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right] \\ \left[\begin{matrix}0.5878 \\ 0.9511 \\ 0.9511 \\ 0.5878\end{matrix}\right]\end{matrix}$$

$$x \left(.02\right) =$$

$$\begin{matrix}\left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right] \\ x \left(.01\right) =\end{matrix}$$

$$\begin{matrix}{\left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right]}^{2} \\ x \left(0\right)\end{matrix}$$

As an example, boundary conditions can be given through the initial time t=0 and Dirichlet conditions.

In this example boundary conditions are given through the initial condition x₀ and Dirichlet conditions as:

$$f \left(x , 0\right) = {x}_{0} = s i n \left(π x\right)$$

$$f \left(0 , t\right) = 0$$

$$f \left(1 , t\right) = 0$$

Therefore:

$$f \left(x , 0\right) = s i n \left(π x\right) =$$

$${f}_{0} = \left[\begin{matrix}s i n \left(.2 π\right) \\ s i n \left(.4 π\right) \\ s i n \left(.6 π\right) \\ s i n \left(.8 π\right)\end{matrix}\right] = \left[\begin{matrix}0.5878 \\ 0.9511 \\ 0.9511 \\ 0.5878\end{matrix}\right]$$

Matrix B is given by

$$B = \left[\begin{matrix}f \left(0 , t\right) \\ 0 \\ 0 \\ f \left(1 , t\right)\end{matrix}\right] = \left[\begin{matrix}0 \\ 0 \\ 0 \\ 0\end{matrix}\right]$$

$$x \left(0\right) = \left[\begin{matrix}0.5878 \\ 0.9511 \\ 0.9511 \\ 0.5878\end{matrix}\right]$$

The system is

$$x \left(.01\right) =$$

$$\begin{matrix}\left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right] \\ \left[\begin{matrix}0.5878 \\ 0.9511 \\ 0.9511 \\ 0.5878\end{matrix}\right]\end{matrix}$$

$$x \left(.02\right) =$$

$$\begin{matrix}\left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right] \\ x \left(.01\right) =\end{matrix}$$

$$\begin{matrix}{\left[\begin{matrix}5.5481 e - 01 & 1.7346 e - 01 & 2.9787 e - 02 & 1.7836 e - 03 \\ 1.7547 e - 01 & 5.7876 e - 01 & 1.8307 e - 01 & 2.3593 e - 02 \\ 2.7977 e - 02 & 1.7635 e - 01 & 5.8748 e - 01 & 1.7163 e - 01 \\ 3.9758 e - 03 & 2.5060 e - 02 & 1.7631 e - 01 & 5.5452 e - 01\end{matrix}\right]}^{2} \\ x \left(0\right)\end{matrix}$$

Boundary conditions can be given through an instant time t=T and Dirichlet conditions.

In this example, at the time T=1 boundary conditions are the following

$$f \left(x , T\right) = x \left(T\right) = s i n \left(π x\right)$$

$$f \left(0 , t\right) = 0$$

$$f \left(1 , t\right) = 0$$

Matrix B is given by

$$B = \left[\begin{matrix}f \left(0 , t\right) \\ 0 \\ 0 \\ f \left(1 , t\right)\end{matrix}\right] = \left[\begin{matrix}0 \\ 0 \\ 0 \\ 0\end{matrix}\right]$$

$$x \left(1\right) = \left[\begin{matrix}0.5878 \\ 0.9511 \\ 0.9511 \\ 0.5878\end{matrix}\right]$$

Considering that nδ = T and

$$n = \frac{T}{δ} = \frac{1}{.01} = 100$$

$${e}^{n δ Α} x \left(0\right) = {e}^{100 ⋅ \left(0.01\right) A} x \left(0\right) = x \left(1\right)$$

The following equality is derived:

$$x \left(1\right) = {e}^{100 ⋅ \left(0.01\right) A} x \left(0\right)$$

$$x \left(1\right) = {e}^{A} x \left(0\right)$$

Pre multiplying for (e^{A})⁻¹:

$${\left({e}^{A}\right)}^{- 1} x \left(1\right) = x \left(0\right)$$

$$x \left(0\right) = {\left({e}^{A}\right)}^{- 1} x \left(1\right)$$

In this case the inverse of the matrix (e^{.}^{01A})⁻¹⁰⁰ = (e^{A})⁻¹ is to be computed.

Recalling that ((e^{.01A})⁻¹)¹⁰⁰ = (e^{-.01A})¹⁰⁰, the inverse of the matrix exponential can be computed by applying the Suzuki Trotter expansion on the matrix -A.

For instance, a second order Suzuki Trotter decomposition with δ = 0.01 will be:

$${e}^{- .01 A δ} = {e}^{\frac{- .01}{2} {A}_{1}} {e}^{- .01 {A}_{2}} {e}^{\frac{- .01}{2} {A}_{1}} + o \left({δ}^{3}\right)$$

$${e}^{- .01 A} ≅ {e}^{\frac{- .01}{2} {A}_{1}} {e}^{- .01 {A}_{2}} {e}^{\frac{- .01}{2} {A}_{1}}$$

The partial differential equation (PDE) governing the multi-asset Black-Scholes model can be also solved by using tensor network methodology.

The Black-Scholes is a PDE which models the dynamics of financial derivatives. Its numerical solution provides derivative investment instruments with a price. Financial derivatives are important contracts that give to investors the possibility to diversify their portfolio and hedge against inflation and deflation. For instance, an automotive manufacturer company may be interested in purchasing a European call option for the steel commodity to reduce the risk that its price can increase worldwide for unforeseen circumstances. The type of the derivative depends on the boundary conditions assigned to the Black Scholes PDE. A non-comprehensive list of the most common derivatives includes Futures, Forward, Swaps, European, America, Exotic options as well as Covered Warrants. The multiasset Black Scholes allows to also evaluate derivatives whose underlying are more than one asset, for instance, different stocks but also stock indexes, commodities, interest rates, etc.

The Black-Scholes equation to evaluate the price of an option V(S, t) is:

$$\frac{\partial V \left(S , t\right)}{\partial t} + \frac{1}{2} {σ}^{2} {S}^{2} \frac{{\partial }^{2} V \left(S , t\right)}{\partial {S}^{2}} + r S \frac{\partial V \left(S , t\right)}{\partial S} = r V \left(S , t\right)$$

where S is the price of an asset value, r the free-risk rate, t is the time since the option was issued.

By denoting:

$$χ = ln \left(\frac{S}{K}\right) - ∞ < χ < + ∞$$

$$τ = \frac{{σ}^{2}}{2} \left(T - t\right) 0 < τ < \frac{{σ}^{2}}{2} T$$

$${k}_{1} = \frac{2 r}{{σ}^{2}}$$

$$υ \left(χ , τ\right) = \frac{1}{K} V \left(S , t\right) {e}^{\frac{1}{2} \left({k}_{1} - 1\right) χ + \frac{1}{4} {\left({k}_{1} + 1\right)}^{2} τ}$$

The equation can be reduced as a diffusion partial differential equation:

$$\frac{\partial υ \left(χ , τ\right)}{\partial τ} - \frac{{\partial }^{2} υ \left(χ , τ\right)}{\partial {χ}^{2}} = 0$$

Next, consider a multi asset Black-Scholes model. Let Sᵢ be the price processes of the assets i= 1, ..., N and the asset Sᵢ satisfies the dynamic

$$d {S}_{i} = α {S}_{i} + {σ}_{i} {S}_{i} d {W}_{i}$$

Assets Sᵢ and Sⱼ are correlated and let ρ be the correlation matrix of all the price processes of the assets:

$$ρ = {\left[\begin{matrix}1 & {ρ}_{12} & ⋯ & {ρ}_{1 N} \\ {ρ}_{12} & 1 & ⋯ & {ρ}_{2 N} \\ ⋮ & ⋮ & ⋱ & 0 \\ {ρ}_{1 N} & {ρ}_{2 N} & ⋯ & 1\end{matrix}\right]}_{N x N}$$

The matrix ρ is symmetric and therefore ρᵢⱼ = ρⱼᵢ. The differential second order product term of the Wiener processes Wᵢ and Wⱼ is given by:

$$d {W}_{i} d {W}_{j} = {ρ}_{i j} d τ$$

The price processes of the assets verify the following equality:

$$d {S}_{i} d {S}_{j} = {σ}_{i} {σ}_{i} {S}_{i} {S}_{j} {ρ}_{i j} d τ$$

The multi asset Black-Scholes equation becomes for the option V(S₁,S_{2,}...Sₙ, τ) = V (S̅,̅ τ):

$$\begin{matrix}\frac{\partial V \left(\vec{S} , τ\right)}{\partial τ} + \frac{1}{2} {\sum }_{i , j} {σ}_{i} {σ}_{j} {S}_{i} {S}_{j} {ρ}_{i j} \frac{{\partial }^{2} V \left(\vec{S} , τ\right)}{\partial {S}_{i} \partial {S}_{j}} + r S \frac{\partial V \left(\vec{S} , τ\right)}{\partial {S}_{i} \partial {S}_{j}} = \\ r V \left(\vec{S} , τ\right)\end{matrix}$$

The previous equation can be transformed in a N dimensional diffusion equation. Consider a variable xᵢ such as:

$${x}_{i} = ln \left({S}_{i}\right) - \left(r - \frac{1}{2} {σ}_{i}^{2}\right) τ$$

$$\frac{\partial V \left(\vec{x} , τ\right)}{\partial τ} + \frac{1}{2} {\sum }_{i , j} {σ}_{i} {σ}_{j} {ρ}_{i j} \frac{{\partial }^{2} V \left(\vec{x} , τ\right)}{\partial {x}_{i} \partial {x}_{j}} = r V \left(\vec{x} , τ\right)$$

Define:

$$V \left(\vec{x} , τ\right) = {e}^{- r \left(T - τ\right)} ψ \left(\vec{x} , τ\right)$$

Then Ψ(x̅,t) satisfies the equation:

$$\frac{\partial ψ \left(\vec{x} , τ\right)}{\partial τ} + \frac{1}{2} {\sum }_{i , j} {σ}_{i} {σ}_{j} {ρ}_{i j} \frac{{\partial }^{2} ψ \left(\vec{x} , τ\right)}{\partial {x}_{i} \partial {x}_{j}} = 0$$

Defining

$${χ}_{i} = \frac{{x}_{i}}{{σ}_{i}} ,$$

$$\frac{\partial ψ \left(\vec{x} , τ\right)}{\partial τ} + \frac{1}{2} {\sum }_{i , j} {ρ}_{i j} \frac{{\partial }^{2} ψ \left(\vec{x} , τ\right)}{\partial {χ}_{i} \partial {χ}_{j}} = 0$$

By posing t = T - τ,

$$\frac{\partial ψ \left(\vec{x} , τ\right)}{\partial τ} = \frac{1}{2} {\sum }_{i , j} {ρ}_{i j} \frac{{\partial }^{2} ψ \left(\vec{x} , τ\right)}{\partial {χ}_{i} \partial {χ}_{j}}$$

This is a diffusion equation that can be treated and solved as shown herein.

For instance, for a two asset Black Scholes model the equation becomes the following:

$$\frac{\partial ψ \left(\vec{x} , τ\right)}{\partial τ} = \frac{1}{2} \frac{{\partial }^{2} ψ \left(\vec{x} , τ\right)}{\partial {χ}_{1} \partial {χ}_{1}} + \frac{1}{2} \frac{{\partial }^{2} ψ \left(\vec{x} , τ\right)}{\partial {χ}_{1} \partial {χ}_{2}} + \frac{1}{2} \frac{{\partial }^{2} ψ \left(\vec{x} , τ\right)}{\partial {χ}_{2} \partial {χ}_{2}} .$$

The European call option numerical example using the method of the lines is provided below.

As an example, consider a European call option with strike price K = 10€, expiring date T = 10, risk-free rate r = 0.02 and volatility σ² = 0.4 .

Denoting by:

$$χ = ln \left(\frac{S}{K}\right) - ∞ < χ < + ∞$$

$$τ = \frac{{σ}^{2}}{2} \left(T - t\right) 0 < τ < \frac{{σ}^{2}}{2} T$$

$${k}_{1} = \frac{2 r}{{σ}^{2}}$$

$$υ \left(χ , τ\right) = \frac{1}{K} V \left(S , t\right) {e}^{\frac{1}{2} \left({k}_{1} - 1\right) χ + \frac{1}{4} {\left({k}_{1} + 1\right)}^{2} τ}$$

The constant parameter k₁ has the value:

$${k}_{1} = \frac{2 r}{{σ}^{2}} = \frac{2 ⋅ 0.02}{{0.4}^{2}} = 0.25$$

The stock price interval [Sₘᵢₙ, Sₘₐₓ] = [0.4,1000] becomes in the new variable X

$${χ}_{m i n} = ln \left(\frac{{S}_{m i n}}{K}\right) = ln \left(\frac{0.4}{10}\right) = - 3.2189$$

$${χ}_{m a x} = ln \left(\frac{{S}_{m a x}}{K}\right) = ln \left(\frac{1000}{10}\right) = 4.6052$$

Considering along _{X} six points _{X} = [X₀,X₁,X₂,X₃,X₄,X₅] and therefore N=5 equally spaced intervals, it is possible to obtain

$$χ = \left[- 3.2189 , - 1.6541 , - 0.0893 , 1.4756 , 3.0404 , 4.6052\right] ,$$

Recalling that for a European call option, the following equality is derived at the maturity date t = T

$$\begin{matrix}V \left(S , T\right) = m a x \left(S - K , 0\right) ⇒ υ \left(χ , 0\right) = \\ m a x \left({e}^{\frac{1}{2} \left({k}_{1} + 1\right) χ} - {e}^{\frac{1}{2} \left({k}_{1} - 1\right) χ} , 0\right) ∀ χ\end{matrix}$$

the initial conditions for ʋ(_{X}, 0) are given by:

$$\begin{matrix}υ \left(χ , 0\right) = m a x \left({e}^{\frac{1}{2} \left(.25 + 1\right) χ} - {e}^{\frac{1}{2} \left(.25 - 1\right) χ} , 0\right) = \\ m a x \left({e}^{\frac{1}{2} \left(1.25\right) χ} - {e}^{\frac{1}{2} \left(- .75\right) χ} , 0\right)\end{matrix}$$

$$υ \left(- 3.2189 , 0\right) = m a x \left({e}^{\left(0.6250\right) \left(- 3.2189\right)} - {e}^{- 0.3750 \left(- 3.2189\right)} , 0\right) = 0$$

$$υ \left(- 1.6541 , 0\right) = m a x \left({e}^{\left(0.6250\right) \left(- 1.6541\right)} - {e}^{- 0.3750 \left(- 1.6541\right)} , 0\right) = 0$$

$$υ \left(- 0.0893 , 0\right) = m a x \left({e}^{\left(0.6250\right) \left(- 0.0893\right)} - {e}^{- 0.3750 \left(- 0.0893\right)} , 0\right) = 0$$

$$υ \left(1.4756 , 0\right) = m a x \left({e}^{\left(0.6250\right) \left(1.4756\right)} - {e}^{- 0.3750 \left(1.4756\right)} , 0\right) = 1.9398$$

$$υ \left(3.0404 , 0\right) = m a x \left({e}^{\left(0.6250\right) \left(3.0404\right)} - {e}^{\left(- 0.3750\right) \left(3.0404\right)} , 0\right) = 6.3676$$

$$υ \left(4.6052 , 0\right) = m a x \left({e}^{\left(0.6250\right) \left(4.6052\right)} - {e}^{\left(- 0.3750\right) \left(4.6052\right)} , 0\right) = 17.605$$

while the boundary conditions are:

$$V \left(0 , t\right) = 0 ∀ t ⇒ υ \left({χ}_{- ∞} , τ\right) = 0 ∀ τ ⇒ υ \left(- 3.2189 , τ\right) = 0 ∀ τ$$

$$\begin{matrix}V \left(S , t\right) = {S}_{m a x} - K {e}^{- r t} ⇒ υ \left({χ}_{∞} , τ\right) = \left({e}^{\frac{1}{2} \left({k}_{1} + 1\right) {χ}_{∞} ,} -\right) \\ \left({e}^{\frac{1}{2} \left({k}_{1} - 1\right) {χ}_{∞} ,}\right) {e}^{\frac{1}{4} {\left({k}_{1} + 1\right)}^{2} τ} ∀ τ\end{matrix}$$

Considering that

$$d \text{} χ = \frac{{χ}_{m a x} - {χ}_{m i n}}{N} = \frac{7.8241}{5} = 1.5648$$

$$\frac{1}{d \text{} {χ}^{2}} = \frac{1}{{1.5648}^{2}} = 0.4084$$

The state matrix A becomes:

$$A = 0.4084 \left[\begin{matrix}- 2 & 1 & 0 & 0 \\ 1 & - 2 & 1 & 0 \\ 0 & 1 & - 2 & 1 \\ 0 & 0 & 1 & - 2\end{matrix}\right] = 0.4084 \left[\begin{matrix}- 2 & 1 & 0 & 0 \\ 1 & - 2 & 1 & 0 \\ 0 & 1 & - 2 & 1 \\ 0 & 0 & 1 & - 2\end{matrix}\right]$$

The matrix A can be decomposed as following:

$${A}_{1} = 0.4084 \left[\begin{matrix}- 2 & 1 & 0 & 0 \\ 1 & - 2 & 1 & 0 \\ 0 & 0 & 0 & 0 \\ 0 & 0 & 0 & 0\end{matrix}\right]$$

$${A}_{2} = 0.4084 \left[\begin{matrix}0 & 0 & 0 & 0 \\ 0 & 0 & 0 & 0 \\ 0 & 1 & - 2 & 1 \\ 0 & 0 & 1 & - 2\end{matrix}\right]$$

The following two non-commuting sets are identified:

$${Ξ}_{1} = \left\{{Π}_{1}\right\} ⇒ {Φ}_{1} = \left\{{A}_{1}\right\}$$

$${Ξ}_{2} = \left\{{Π}_{2}\right\} ⇒ {Φ}_{2} = \left\{{A}_{2}\right\}$$

A second order Suzuki Trotter decomposition with δ = 0.1 can be applied:

$${e}^{A δ} = {e}^{\frac{δ}{2} {A}_{1}} {e}^{δ \text{} {A}_{2}} {e}^{\frac{δ}{2} {A}_{1}} + o \left({δ}^{3}\right)$$

$${e}^{.1 A} ≅ {e}^{\frac{.1}{2} {A}_{1}} {e}^{.01 {A}_{2}} {e}^{\frac{.1}{2} {A}_{1}} =$$

$$= \left[\begin{matrix}9.2234 e - 01 & 3.7655 e - 02 & 7.7441 e - 04 & 7.6388 e - 06 \\ 3.7663 e - 02 & 9.2309 e - 01 & 3.7689 e - 02 & 7.5332 e - 04 \\ 7.6902 e - 04 & 3.7665 e - 02 & 9.2312 e - 01 & 3.7647 e - 02 \\ 1.5488 e - 05 & 7.5856 e - 04 & 3.7663 e - 02 & 9.2234 e - 01\end{matrix}\right]$$

Recalling that at χ-∞the boundary condition is:

$$υ \left({χ}_{- ∞} , τ\right) = 0 ⇒ {u}_{0} \left(τ\right) = 0 ∀ τ$$

Denoting by

$$m = \left({e}^{\frac{1}{2} \left({k}_{1} + 1\right) {χ}_{∞} ,} - {e}^{\frac{1}{2} \left({k}_{1} - 1\right) {χ}_{∞} ,}\right) = {e}^{0.6250 \left(4.6052\right)} -$$

e^{-0.3750(4.6052)} = 17.605 and

$$μ = \frac{1}{4} {\left({k}_{1} + 1\right)}^{2} = 0.3906 ,$$

it is possible to write the boundary condition at _{X}∞ as:

$$υ \left({χ}_{∞} , τ\right) = m {e}^{μ τ} ⇒ {u}_{5} \left(τ\right) = m {e}^{μ τ} = 17.605 {e}^{0.3906 τ} ∀ \text{} τ$$

The inputs are u₀ = 0 at χ₀ and u₅ = me^{µτ}1(τ) = 17.605e^{0.3906τ}1(τ) at χ₅. Taking into consideration that although two inputs are applied to the system, the first one is a step force of amplitude zero u₀ = 0 and therefore cancels. The matrix B simplifies and becomes:

$$B = \frac{1}{d \text{} {χ}^{2}} \left[\begin{matrix}0 \\ 0 \\ 0 \\ m\end{matrix}\right] = 0.4084 \left[\begin{matrix}0 \\ 0 \\ 0 \\ 17.605\end{matrix}\right] = \left[\begin{matrix}0 \\ 0 \\ 0 \\ 7.189\end{matrix}\right] .$$

As a result, only the exponential input response has to be computed by using the formulas previously discussed. The system response at the first-time step v(δ) = v(0.1) can be calculated as:

$$υ \left(.1\right) = {e}^{A t} \left(x \left(0\right) - {\left(μ \text{} I - A\right)}^{- 1} \text{} B\right) + {\left(μ \text{} I - A\right)}^{- 1} \text{} B {e}^{μ t} =$$

$$= \left[\begin{matrix}9.2234 e - 01 & 3.7655 e - 02 & 7.7441 e - 04 & 7.6388 e - 06 \\ 3.7663 e - 02 & 9.2309 e - 01 & 3.7689 e - 02 & 7.5332 e - 04 \\ 7.6902 e - 04 & 3.7665 e - 02 & 9.2312 e - 01 & 3.7647 e - 02 \\ 1.5488 e - 05 & 7.5856 e - 04 & 3.7663 e - 02 & 9.2234 e - 01\end{matrix}\right] .$$

$$\left(\left[\begin{matrix}0 \\ 0 \\ 1.9398 \\ 6.3676\end{matrix}\right] - \left(0.3906 \left[\begin{matrix}1 & 0 & 0 & 0 \\ 0 & 1 & 0 & 0 \\ 0 & 0 & 1 & 0 \\ 0 & 0 & 0 & 1\end{matrix}\right] -\right)\right)$$

$$\left({\left(0.4084 \left[\begin{matrix}- 2 & 1 & 0 & 0 \\ 1 & - 2 & 1 & 0 \\ 0 & 1 & - 2 & 1 \\ 0 & 0 & 1 & - 2\end{matrix}\right]\right)}^{- 1} \left[\begin{matrix}0 \\ 0 \\ 0 \\ 7.189\end{matrix}\right]\right) +$$

$$+ \left(0.3906 \left[\begin{matrix}1 & 0 & 0 & 0 \\ 0 & 1 & 0 & 0 \\ 0 & 0 & 1 & 0 \\ 0 & 0 & 0 & 1\end{matrix}\right] -\right)$$

$${\left(0.4084 \left[\begin{matrix}- 2 & 1 & 0 & 0 \\ 1 & - 2 & 1 & 0 \\ 0 & 1 & - 2 & 1 \\ 0 & 0 & 1 & - 2\end{matrix}\right]\right)}^{- 1} \left[\begin{matrix}0 \\ 0 \\ 0 \\ 7.189\end{matrix}\right] \left[{e}^{0.3906 ⋅ 0.1}\right]$$

The maximum value

$$υ \left({τ}_{m a x}\right) = υ \left(\frac{{σ}^{2}}{2} T\right) = υ \left(\frac{{0.4}^{2}}{2} 10\right) = υ \left(0.8\right)$$

can be reached by iterating the time evolution. Once the function ʋ(χ, τ) has been computed, the call price function V(S, t) can be evaluated through the inverse variables’ transformation.

The proposed methodology can also resolve non-linear systems in a state space representation that is:

$$\dot{x} = f \left(x , u\right)$$

Non linear systems can be linearised around an equilibrium point or along one of system’s trajectory.

As an example, in the following the case a) with u = 0, or when u ≠ 0 and in case b).

Let x̅ be an equilibrium point for the system ẋ = ƒ(x), i.e., it is ƒ(x̅) = 0. The corresponding linearised system around x̅ is:

$$\dot{ξ} = A \left(\overline{x}\right) ξ$$

where A is the so-called Jacobian matrix and is given by:

$$A \left(\overline{x}\right) = {\left[\begin{matrix}\frac{\partial {f}_{11}}{\partial {x}_{1}} & ⋯ & \frac{\partial {f}_{1 n}}{\partial {x}_{n}} \\ ⋮ & ⋱ & ⋮ \\ \frac{\partial {f}_{n 1}}{\partial {x}_{n}} & ⋯ & \frac{\partial {f}_{n n}}{\partial {x}_{n}}\end{matrix}\right]}_{x = \overline{x}} ,$$

and ξ = x - x̅. From the initial conditions ξ(0) = x(0) - x̅, it is possible to compute the free evolution of the linearised system ξ_{ƒ}(δ) = e^{Aδ}ξ(0) at the time instant δ ≪ 1 using the Suzuki Trotter expansion with parameter δ. Next, it is possible to afterwards compute the free evolution of the non-linear system by using the approximation x_{ƒ}(kδ)≅ξ_{ƒ}(kδ) + x̅. This procedure is iteratively repeated until reaching the final point T= Nδ ⇒ x_{ƒ}(Nδ).

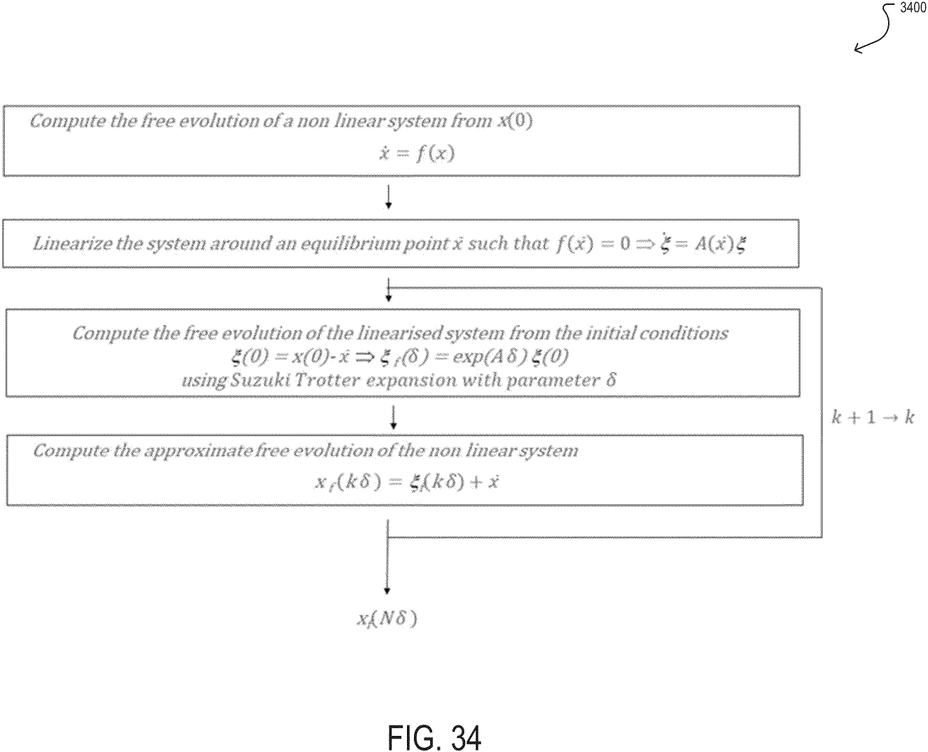

FIG. 34 shows a flowchart of a process 3400 for non-linear systems according to an example of the instant disclosure.

As an example, the system can be used to solve time-variant systems such as linear time-variant systems.

As an example, the state-space representation of a linear time-variant (LTV) system can be:

$$\dot{x} = A \left(t\right) x \left(t\right) + B \left(t\right) u \left(t\right) ,$$

in this case the state and input matrices A(t) and B(t) are time dependent.

Considering a sufficiently small-time interval δ such as the variation of the function A(t) and B(t) is negligible with respect to the state response, the LTV system can be approximated with a LTI system as discussed above.

A non-linear time variant (NTV) system can be written as:

$$\dot{x} = f \left(x , u , t\right)$$

In every sufficiently small-time interval, the NTV systems can be approximated with an NTI system which can be analysed.

A linear discrete time-invariant system can be expressed in a state space representation such as:

$$\begin{matrix}x \left(k + 1\right) = A x \left(k\right) + B u \left(k\right) \\ y \left(k\right) = C x \left(k\right) + D u \left(k\right)\end{matrix}$$

The parallel implementation of a discrete time-invariant system can be achieved in two different approaches (1) by calculating the equivalent continuous system of the discrete representation or (2) by computing the discrete evolution in a direct manner.

Considering that the free evolution of a linear time invariant discrete system is given by the term

$$x \left(k\right) = {A}^{k} x \left(0\right) , ∀ k \geq 0 ,$$

the following equality is known:

$$x \left(k\right) = {A}^{k} x \left(0\right) = {e}^{log \left({A}^{k}\right)} x \left(0\right) = {e}^{k l o g \left(A\right)} x \left(0\right) = {e}^{\hat{A} k} x \left(0\right)$$

As consequence, by posing Â = log (A) the discrete time evolution has been recast as a continuous time evolution that has been extensively described in the previous sections.

Let A be a matrix such as it can be split as a sum of N addends denoted by A₁, A₂, ... A_{N}

$$A = {\sum }_{j = 1}^{N} {A}_{j}$$

the product of the matrices not having two consecutive indices is equal to zero

$$\begin{matrix}{A}_{j} {A}_{j + 1} \neq 0 , {A}_{j - 1} {A}_{j} \neq 0 \\ {A}_{j} {A}_{j - 2} = 0 , {A}_{j} {A}_{j + 2} = 0\end{matrix} j = 1 , 2 … N$$

A band matrix satisfies these properties.

Let threadᵢ(k) be the value of the thread i at the instant time k. At the value k=1, it is possible to obtain

$$t h r e a {d}_{1} \left(1\right) = {A}_{1} X \left(0\right)$$

$$t h r e a {d}_{j} \left(1\right) = {A}_{j} X \left(0\right)$$

$$t h r e a {d}_{N} \left(1\right) = {A}_{N} X \left(0\right)$$

At the instant k=2,

$$t h r e a {d}_{1} \left(2\right) = {A}_{1} t h r e a {d}_{1} \left(1\right) t h r e a {d}_{2} \left(1\right) X \left(1\right)$$

$$t h r e a {d}_{j} \left(2\right) = {A}_{j} t h r e a {d}_{j} \left(1\right) t h r e a {d}_{j - 1} \left(1\right) t h r e a {d}_{j + 1} \left(1\right) X \left(1\right)$$

$$t h r e a {d}_{N} \left(2\right) = {A}_{N} t h r e a {d}_{N} \left(1\right) t h r e a {d}_{N - 1} \left(1\right) X \left(1\right)$$

At a generic instant time k+1

$$t h r e a {d}_{1} \left(k + 1\right) = {A}_{1} t h r e a {d}_{1} \left(k\right) t h r e a {d}_{2} \left(k\right) X \left(k\right)$$

$$t h r e a {d}_{j} \left(k + 1\right) = {A}_{j} t h r e a {d}_{j} \left(k\right) t h r e a {d}_{j - 1} \left(k\right) t h r e a {d}_{j + 1} \left(k\right) X \left(k\right)$$

$$t h r e a {d}_{N} \left(k + 1\right) = {A}_{N} t h r e a {d}_{N} \left(k\right) t h r e a {d}_{N - 1} \left(k\right) X \left(k\right)$$

Analogously to the continuous case, a SVD transformation can be applied to the term

$${A}_{j} t h r e a {d}_{j} \left(k\right) t h r e a {d}_{j - 1} \left(k\right) t h r e a {d}_{j + 1} \left(k\right) X \left(k\right)$$

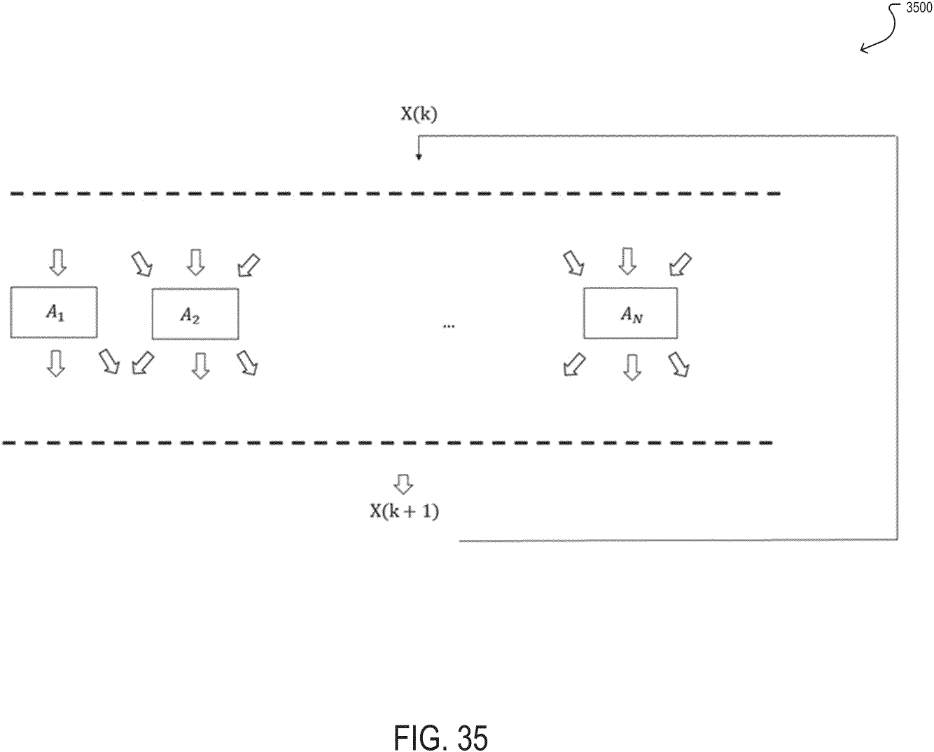

and discard singular values below a given threshold to reduce data transfer through threads. A scheme of the parallel implementation of a discrete time-invariant system for a band matrix A is shown in FIG. 35.

FIG. 35 shows a parallel implementation scheme of a discrete time-invariant system for a band matrix A 3500 according to an example of the instant disclosure.

A does not have to be a band matrix. Let us now suppose the matrix A is such as it can be split as a sum of n addends denoted by A₁, A₂, ... A_{N}

$$A = {\sum }_{j = 1}^{N} {A}_{j}$$

the product of the matrices Aₗ and Aₘ is different than zero with l and m not consecutive indices

$${A}_{l} {A}_{m} \neq 0$$

Apart from the matrices Aₗ and Aₘ, the product of the matrices not having two consecutive indices is equal to zero AⱼAⱼ₊₁ ≠ 0, Aⱼ₋₁Aⱼ ≠ 0, AⱼAⱼ₋₂ = 0,AⱼAⱼ₊₂ = 0

Under this hypothesis, the parallel implementation may have the following modification. Let threadᵢ(k) be the value of the thread i at the instant time k. At the value k=1, the following are obtained

$$t h r e a {d}_{1} \left(1\right) = {A}_{1} X \left(0\right)$$

$$t h r e a {d}_{l} \left(1\right) = {A}_{l} X \left(0\right)$$

$$t h r e a {d}_{m} \left(1\right) = {A}_{m} X \left(0\right)$$

$$t h r e a {d}_{N} \left(1\right) = {A}_{N} X \left(0\right)$$

At the instant k=2,

$$t h r e a {d}_{1} \left(2\right) {A}_{1} t h r e a {d}_{1} \left(1\right) t h r e a {d}_{2} \left(1\right) X \left(1\right)$$

$$t h r e a {d}_{l} \left(2\right) = {A}_{l} t h r e a {d}_{l} \left(1\right) t h r e a {d}_{l - 1} \left(1\right) t h r e a {d}_{l + 1} \left(1\right) t h r e a {d}_{m} \left(1\right) X \left(1\right)$$

$$\begin{matrix}t h r e a {d}_{m} \left(2\right) = \\ {A}_{m} \left(1\right) t h r e a {d}_{m} \left(1\right) t h r e a {d}_{m - 1} \left(1\right) t h r e a {d}_{m + 1} \left(1\right) t h r e a {d}_{l} \left(1\right) X \left(1\right)\end{matrix}$$

$$t h r e a {d}_{N} \left(2\right) = {A}_{N} t h r e a {d}_{N} \left(1\right) t h r e a {d}_{N - 1} \left(1\right) X \left(1\right)$$

At a generic instant time k+1

$$t h r e a {d}_{1} \left(k + 1\right) = {A}_{1} t h r e a {d}_{1} \left(k\right) t h r e a {d}_{2} \left(k\right) X \left(k\right)$$

$$\begin{matrix}t h r e a {d}_{l} \left(k + 1\right) = \\ {A}_{l} t h r e a {d}_{l} \left(k\right) t h r e a {d}_{l - 1} \left(k\right) t h r e a {d}_{l + 1} \left(k\right) t h r e a {d}_{m} \left(k\right) X \left(k\right)\end{matrix}$$

$$\begin{matrix}t h r e a {d}_{m} \left(k + 1\right) = \\ {A}_{m} t h r e a {d}_{m} \left(k\right) t h r e a {d}_{m - 1} \left(k\right) t h r e a {d}_{m + 1} \left(k\right) t h r e a {d}_{l} \left(k\right) X \left(k\right)\end{matrix}$$

$$t h r e a {d}_{N} \left(k + 1\right) = {A}_{N} t h r e a {d}_{N} \left(k\right) t h r e a {d}_{N - 1} \left(k\right) X \left(k\right)$$

Also in this case the terms

$${A}_{l} t h r e a {d}_{l} \left(k\right) t h r e a {d}_{l - 1} \left(k\right) t h r e a {d}_{l + 1} \left(k\right) t h r e a {d}_{m} \left(k\right) X \left(k\right)$$

can be transformed through SVD to diminish the data transfer among cores.

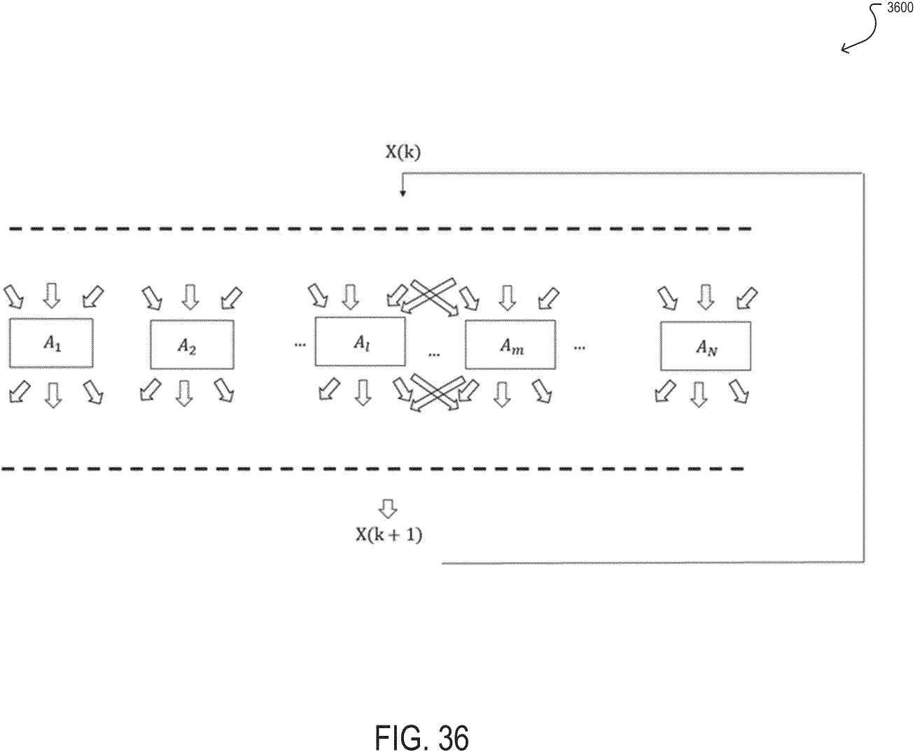

FIG. 36 shows a parallel implementation scheme of a discrete time-invariant system for any matrix A 3600 according to an example of the instant disclosure.

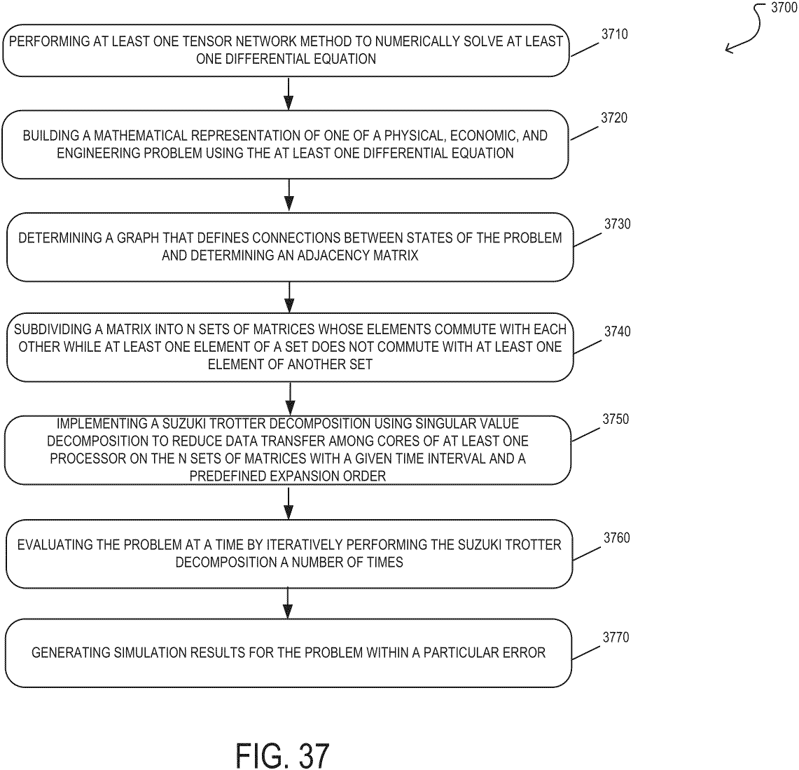

FIG. 37 illustrates an example method 3700 of include building a mathematical representation of one of a physical, economic, and engineering problem using at least one differential equation according to an example of the instant disclosure. Although the example method 3700 depicts a particular sequence of operations, the sequence may be altered without departing from the scope of the present disclosure. For example, some of the operations depicted may be performed in parallel or in a different sequence that does not materially affect the function of the method 3700. In other examples, different components of an example device or system that implements the method 3700 may perform functions at substantially the same time or in a specific sequence.

According to some examples, the method 3700 may include performing at least one tensor network method to numerically solve at least one differential equation at block 3710. The at least one differential equation may be one of a linear differential equation and a non-linear differential equation. Additionally, the at least one differential equation may be one of a linear time variant differential equation and a non-linear time variant differential equation.

As an example, the tensor network method can be a time-evolving block decimation (TEBD) method.

Next, according to some examples, the method 3700 may include building a mathematical representation of one of a physical, economic, and engineering problem using the at least one differential equation at block 3720.

According to some examples, the method 3700 may include determining a graph that defines connections between states of the problem and determining an adjacency matrix at block 3730.

According to some examples, the method 3700 may include subdividing a matrix into n sets of matrices whose elements commute with each other while at least one element of a set does not commute with at least one element of another set at block 3740.

According to some examples, the method 3700 may include implementing a Suzuki Trotter decomposition using singular value decomposition to reduce data transfer among cores of at least one processor on the n sets of matrices with a given time interval δ and a predefined p expansion order at block 3750.

According to some examples, the method 3700 may include evaluating the problem at a time T=Nδ by iteratively performing the Suzuki Trotter decomposition N times at block 3760.

Next, according to some examples, the method 3700 may include generating simulation results for the problem within an error of order of No(δ^{p+1}) at block 3770.

According to some examples, at least some of the method 3700 may be performed by at least one graphical processing unit (GPU).

According to some examples, the method 3700 may include numerically solving the at least one differential equation sequentially.

According to some examples, the method 3700 may include numerically solving the at least one differential equation in parallel.

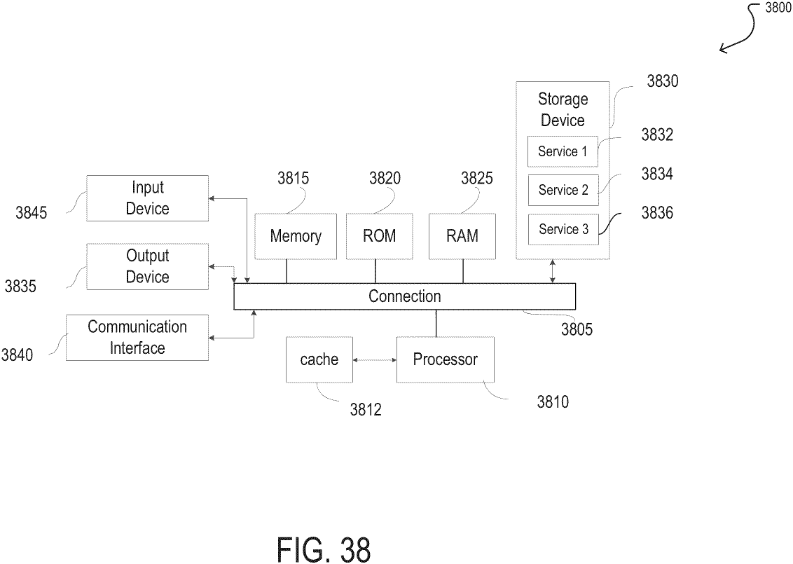

FIG. 38 shows an example of computing system 3800, which can be for example any computing device making up one or more computing devices or computing units such as a distributed computing system, or any component thereof in which the components of the system are in communication with each other using connection 3805. Connection 3805 can be a physical connection via a bus, or a direct connection into processor 3810, such as in a chipset architecture. Connection 3805 can also be a virtual connection, networked connection, or logical connection.

In some embodiments, computing system 3800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 3800 includes at least one processing unit (CPU or processor) 3810 and connection 3805 that couples various system components including system memory 3815, such as read-only memory (ROM) 3820 and random access memory (RAM) 3825 to processor 3810. Computing system 3800 can include a cache of high-speed memory 3812 connected directly with, in close proximity to, or integrated as part of processor 3810.

Processor 3810 can include any general purpose processor and a hardware service or software service, such as services 3832, 3834, and 3836 stored in storage device 3830, configured to control processor 3810 as well as a special-purpose processor where software instructions are incorporated into the actual processor design. Processor 3810 may essentially be a completely self-contained computing system, containing multiple cores or processors, a bus, memory controller, cache, etc. A multi-core processor may be symmetric or asymmetric.

To enable user interaction, computing system 3800 includes an input device 3845, which can represent any number of input mechanisms, such as a microphone for speech, a touch-sensitive screen for gesture or graphical input, keyboard, mouse, motion input, speech, etc.

Computing system 3800 can also include output device 3835, which can be one or more of a number of output mechanisms known to those of skill in the art. In some instances, multimodal systems can enable a user to provide multiple types of input/output to communicate with computing system 3800. Computing system 3800 can include communications interface 3840, which can generally govern and manage the user input and system output. There is no restriction on operating on any particular hardware arrangement, and therefore the basic features here may easily be substituted for improved hardware or firmware arrangements as they are developed.

Storage device 3830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 3830 can include software services, servers, services, etc., that when the code that defines such software is executed by the processor 3810, it causes the system to perform a function. In some embodiments, a hardware service that performs a particular function can include the software component stored in a computer-readable medium in connection with the necessary hardware components, such as processor 3810, connection 3805, output device 3835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A system comprising:
a memory storing computer-readable instructions; and
at least one processor to execute the instructions to:
perform at least one tensor network method to numerically solve at least one differential equation;
build a mathematical representation of one of a physical, economic, and engineering problem using the at least one differential equation;
determine a graph that defines connections between states of the problem and determine an adjacency matrix;
subdivide a matrix into n sets of matrices whose elements commute with each other while at least one element of a set does not commute with at least one element of another set;
implement a Suzuki Trotter decomposition using singular value decomposition to reduce data transfer among cores of the at least one processor on the n sets of matrices with a given time interval δ and a predefined p expansion order;
evaluate the problem at a time T=Nδ by iteratively performing the Suzuki Trotter decomposition N times; and
generate simulation results for the problem within an error of order of No (δ^{p+1}).

2. The system of claim 1, wherein the at least one differential equation comprises one of a linear differential equation and a non-linear differential equation.

3. The system of claim 1, wherein the at least one differential equation comprises one of a linear time variant differential equation and a non-linear time variant differential equation.

4. The system of claim 1, wherein the tensor network method comprises a time-evolving block decimation (TEBD) method.

5. The system of claim 1, further comprising at least one graphical processing unit (GPU) to execute the instructions.

6. The system of claim 1, wherein the at least one processor numerically solves the at least one differential equation sequentially.

7. The system of claim 1, wherein the at least one processor numerically solves the at least one differential equation in parallel.

8. A method, comprising:
performing, by at least one processor, at least one tensor network method to numerically solve at least one differential equation;
building, by the at least one processor, a mathematical representation of one of a physical, economic, and engineering problem using the at least one differential equation;
determining, by the at least one processor, a graph that defines connections between states of the problem and determining an adjacency matrix;
subdividing, by the at least one processor, a matrix into n sets of matrices whose elements commute with each other while at least one element of a set does not commute with at least one element of another set;
implementing, by the at least one processor, a Suzuki Trotter decomposition using singular value decomposition to reduce data transfer among cores of the at least one processor on the n sets of matrices with a given time interval δ and a predefined p expansion order;
evaluating, by the at least one processor, the problem at a time T=Nδ by iteratively performing the Suzuki Trotter decomposition N times; and
generating, by the at least one processor, simulation results for the problem within an error of order of No(δ^{p+1}).

9. The method of claim 8, wherein the at least one differential equation comprises one of a linear differential equation and a non-linear differential equation.

10. The method of claim 8, wherein the at least one differential equation comprises one of a linear time variant differential equation and a non-linear time variant differential equation.

11. The method of claim 8, wherein the tensor network method comprises a time-evolving block decimation (TEBD) method.

12. The method of claim 8, wherein the at least one processor comprises at least one graphical processing unit (GPU).

13. The method of claim 8, further comprising numerically solving the at least one differential equation sequentially.

14. The method of claim 8, further comprising numerically solving the at least one differential equation in parallel.

15. A non-transitory computer-readable storage medium comprising instructions stored thereon that, when executed by a computing device cause the computing device to perform operations, the operations comprising:
performing, at least one tensor network method to numerically solve at least one differential equation;
building a mathematical representation of one of a physical, economic, and engineering problem using the at least one differential equation;
determining a graph that defines connections between states of the problem and determining an adjacency matrix;
subdividing a matrix into n sets of matrices whose elements commute with each other while at least one element of a set does not commute with at least one element of another set;
implementing a Suzuki Trotter decomposition using singular value decomposition to reduce data transfer among cores of the at least one processor on the n sets of matrices with a given time interval δ and a predefined p expansion order;
evaluating the problem at a time T=Nδ by iteratively performing the Suzuki Trotter decomposition N times; and
generating simulation results for the problem within an error of order of No(δ^{p+1}).

16. The non-transitory computer-readable medium of claim 15, wherein the at least one differential equation comprises one of a linear differential equation and a non-linear differential equation.

17. The non-transitory computer-readable medium of claim 15, wherein the at least one differential equation comprises one of a linear time variant differential equation and a non-linear time variant differential equation.

18. The non-transitory computer-readable medium of claim 15, wherein the tensor network method comprises a time-evolving block decimation (TEBD) method.

19. The non-transitory computer-readable medium of claim 15, wherein the at least one computing device comprises at least one graphical processing unit (GPU).

20. The non-transitory computer-readable medium of claim 15, the operations further comprising numerically solving the at least one differential equation sequentially.

21. The non-transitory computer-readable medium of claim 15, the operations further comprising numerically solving the at least one differential equation in parallel.
